(19) United States
(12) Patent Application Publication
(10) Pub. No.: US 2015/0070607 A1
(43) Pub. Date: Mar. 12, 2015

(54) STEREOSCOPIC DISPLAY APPARATUS

(71) Applicant: Sharp Kabushiki Kaisha, Osaka-shi, Osaka (JP)

(72) Inventors: Naru Usukura, Osaka-shi (JP); Hiromi Katoh, Osaka-shi (JP); Yuuichi Kanbayashi, Osaka-shi (JP); Nathan Smith, Oxford (GB); Alexander Zawadzki, Oxford (GB); Benjamin Broughton, Oxford (GB)

(21) Appl. No.: 14/389,939

(22) PCT Filed: Apr. 5, 2013
(86) PCT No.: PCT/JP2013/060508

§ 371 Date: Oct. 1, 2014

(30) Foreign Application Priority Data
Apr. 6, 2012 (JP) 2012-087579
Apr. 6, 2012 (JP) 2012-087600
Jun. 9, 2012 (JP) 2012-088704

(51) Int. Cl. G02B 27/22; G02F 1/133; G02F 1/1333; G02F 1/1343; G02F 1/1335

(52) U.S. Cl. CPC G02B 27/22; G02F 1/134309; G02F 1/133528; G02F 1/133345; G02F 1/13306
USPC 349/15

(57) ABSTRACT

A three-dimensional display apparatus includes a display device capable of displaying an image, and a liquid crystal lens disposed so as to overlap the display device. The liquid crystal lens includes an insulating substrate, a first electrode formed extending in a first direction, a second electrode formed substantially parallel to the first electrode, a high resistance portion electrically connecting the first electrode and the second electrode, an opposing substrate, a common electrode, a liquid crystal layer, and a controller. The sheet resistance of the high resistance portion is in 100 GΩ/sq or less. The controller controls, in one of the modes, the first electrode and the second electrode to be at different potentials.

### TECHNICAL FIELD

The present invention relates to a stereoscopic display apparatus. More particularly, the present invention relates to a stereoscopic display apparatus including a liquid crystal lens.

Priority is claimed on Japanese Patent Applications No. 2012-087600 filed Apr. 6, 2012, No. 2012-087579 filed Apr. 6, 2012, and No. 2012-088704 filed Apr. 9, 2012, the content of which are incorporated herein by reference.

### BACKGROUND ART

Multiview stereoscopic display apparatuses regularly arrange and display images captured from multiple directions. For this reason, a resolution decreases as the number of points of view increases. Accordingly, a preferable configuration is such that a two-dimensional display mode and a three-dimensional display mode are switchable, and a resolution can be maintained in the two-dimensional display mode.

As such a stereoscopic display apparatus, stereoscopic display apparatuses using liquid crystal lenses are known. Regarding liquid crystal lenses, orientation of the liquid crystal is controlled based on a potential difference between an electrode pattern and a common electrode, thus forming a refractive index distribution.

Japanese Unexamined Patent Application, First Publication No. 2010-282090 discloses a stereoscopic display apparatus including a variable lens array element. The stereoscopic display apparatus includes a display panel and a variable lens array element. The variable lens array element includes a first electrode and a second electrode opposing the first electrode. The second electrode is formed smaller in width than a sub-pixel of the display panel. The second electrode is provided at least at the position of each of sub-pixels arranged in the horizontal direction. Regarding the variable lens array element, the voltages to be applied to a plurality of second electrodes are independently controlled, thus changing, for each sub-pixel, at least the horizontal position and the shape of the cylindrical lens.

### DISCLOSURE OF THE INVENTION

### Problems to be Solved by the Invention

In the liquid crystal lens, however, in a case where the distance between the electrode patterns is larger than the distance between the electrode pattern and the common electrode, there is a problem that an electric field is not applied to a central portion between the electrode patterns. In this case, a potential gradient is not formed in the central portion. Accordingly, an effective refractive index distribution cannot be obtained, and thus a function as the lens cannot be obtained.

Regarding a variable lens array element disclosed in Japanese Unexamined Patent Application, First Publication No. 2010-282090, an electrode pattern is formed for each sub-pixel, and the voltage to be applied to each electrode pattern is independently controlled. Thus, the horizontal position and the shape of the cylindrical lens are changed for each sub-pixel. However, in order to form an electrode pattern for each sub-pixel and independently control the voltage to be applied to the electrode pattern, a complex manufacturing process is required. Additionally, a signal generating circuit for generating various types of voltages is required.

An object of the present invention is to provide a stereoscopic display apparatus including a liquid crystal lens that can achieve an effective refractive index distribution even in a case where the distance between the electrode patterns is larger than the distance between the electrode pattern and the common electrode.

A three-dimensional display apparatus disclosed here includes a display device capable of displaying an image, and a liquid crystal lens disposed so as to overlap the display device. The liquid crystal lens includes an insulating substrate, a first electrode formed extending in a first direction, a second electrode formed substantially parallel to the first electrode, a high resistance portion electrically connecting the first electrode and the second electrode, an opposing substrate, a common electrode, a liquid crystal layer, and a controller. The sheet resistance of the high resistance portion is in 100 GΩ/sq or less. The controller controls, in one of the modes, the first electrode and the second electrode to be at different potentials.

According to the stereoscopic display apparatus of the present invention, even in a case where the distance between the electrode patterns is larger than the distance between the electrode pattern and the common electrode, it is possible to achieve an effective refractive index distribution.

### BRIEF DESCRIPTION OF THE DRAWINGS

FIG. 1 is an exploded perspective view showing a schematic configuration of a stereoscopic display apparatus according to one embodiment of the present invention.

FIG. 2 is a cross-sectional view taken along a line II-II shown in FIG. 1 and schematically showing a configuration of a liquid crystal lens according to a first embodiment of the present invention.

FIG. 3 is a perspective view showing, by extracting from the configuration of the liquid crystal lens according to the first embodiment, a part of a pattern substrate.

FIG. 4 is a schematic cross-sectional view showing the liquid crystal lens in one mode according to the first embodiment.

FIG. 5 is a schematic cross-sectional view showing the liquid crystal lens in another mode according to the first embodiment.

FIG. 6 is a schematic cross-sectional view showing a liquid crystal lens according to a hypothetical comparative example.

FIG. 7 is a schematic cross-sectional view illustrating the effects of the liquid crystal lens according to the first embodiment.

FIG. 8 is a schematic sectional view showing a schematic configuration of a liquid crystal lens according to a second embodiment of the present invention.

FIG. 9 is a perspective view showing, by extracting from the configuration of the liquid crystal lens according to the second embodiment, a part of a pattern substrate.

FIG. 10 is a schematic cross-sectional view illustrating the effects of the liquid crystal lens according to the second embodiment.

FIG. 11 is a perspective view showing by extracting from the configuration of a liquid crystal lens according to a third embodiment, a part of a pattern substrate.

FIG. 12 is a plan view showing, by extracting from the configuration of the pattern substrate of the liquid crystal lens according to the third embodiment, a first electrode, a second electrode, an auxiliary electrode, and a high resistance portion.

FIG. 13 is a perspective view showing, by extracting from a configuration of a liquid crystal lens according to a fourth embodiment, a part of the pattern substrate.

FIG. 14 is a perspective view showing, by extracting from a configuration of a liquid crystal lens according to a fifth embodiment, a part of a pattern substrate.

FIG. 15 is a perspective view showing by extracting from a configuration of a liquid crystal lens according to a sixth embodiment, a part of a pattern substrate.

FIG. 16 is a schematic cross-sectional view illustrating a schematic configuration of a liquid crystal lens according to a seventh embodiment of the present invention.

FIG. 17 is a schematic cross-sectional view illustrating operation of the liquid crystal lens according to the seventh embodiment.

FIG. 18 is a schematic sectional view showing a schematic configuration of a liquid crystal lens according to an eighth embodiment of the present invention.

FIG. 19 is a schematic cross-sectional view illustrating operation of the liquid crystal lens according to the eighth embodiment.

FIG. 20 is a diagram showing an arrangement of components in a simulation performed to illustrate the effects of the embodiment.

FIG. 21 is a graph showing a result of the simulation and a theoretical curve in a case where liquid crystal molecules are subject to horizontal orientation when no voltage is applied.

FIG. 22 is a graph showing a result of the simulation and a theoretical curve in a case where liquid crystal molecules are subject to TN orientation when no voltage is applied.

FIG. 23 is a cross-sectional view taken along a line II-II shown in FIG. 1 and schematically showing a configuration of a liquid crystal lens according to a ninth embodiment of the present invention.

FIG. 24 is a perspective view showing, by extracting from the configuration of the liquid crystal lens according to the ninth embodiment, a part of a first substrate and a second substrate.

FIG. 25 is a schematic cross-sectional view showing the liquid crystal lens in one mode according to the ninth embodiment.

FIG. 26 is a schematic cross-sectional view showing the liquid crystal lens in another mode according to the ninth embodiment.

FIG. 27 is a schematic cross-sectional view showing a liquid crystal lens according to a hypothetical comparative example.

FIG. 28 is a schematic cross-sectional view showing a schematic configuration of a liquid crystal lens according to a tenth embodiment of the present invention.

FIG. 29 is a schematic cross-sectional view illustrating the effects of the liquid crystal lens according to the tenth embodiment.

FIG. 30 is a schematic cross-sectional view showing a schematic configuration of a liquid crystal lens according to an eleventh embodiment of the present invention.

FIG. 31 is a schematic cross-sectional view illustrating operation of the liquid crystal lens according to the eleventh embodiment.

FIG. 32 is a schematic sectional view showing a schematic configuration of a liquid crystal lens according to a twelfth embodiment of the present invention.

FIG. 33 is a schematic cross-sectional view illustrating operation of the liquid crystal lens according to the twelfth embodiment.

FIG. 34 is a diagram and chart showing arrangement and potential of each component in a simulation performed to illustrate the effects of the embodiment.

FIG. 35 is a graph showing a result of the simulation and a theoretical curve in the case of the arrangement and potential shown in FIG. 34.

FIG. 36 is a diagram and chart showing arrangement and potential of each component in a simulation performed to illustrate the effects of the embodiment.

FIG. 37 is a graph showing a result of the simulation and a theoretical curve in the case of the arrangement and potential shown in FIG. 36.

FIG. 38 is a diagram and chart showing arrangement and potential of each component in a simulation performed to illustrate the effects of the embodiment.

FIG. 39 is a graph showing a result of the simulation and a theoretical curve in the case of the arrangement and potential shown in FIG. 38.

FIG. 40 is a diagram and chart showing arrangement and potential of each component in a simulation performed to illustrate the effects of the embodiment.

FIG. 41 is a graph illustrating a result of the simulation and a theoretical curve in the case of the arrangement and potential shown in FIG. 40.

FIG. 42 is a graph showing a relationship between the number of potentials on the horizontal axis and a root mean square of the difference from the theoretical curve on the vertical axis.

FIG. 43 is an exploded perspective view showing a schematic configuration of a stereoscopic display apparatus according to a thirteenth embodiment.

FIG. 44 is a diagram showing a cross section of the liquid crystal lens of the thirteenth embodiment, which is taken along II-II shown in FIG. 43.

FIG. 45 is a schematic diagram showing a state of the liquid crystal lens when a voltage is applied in the thirteenth embodiment.

FIG. 46 is a schematic diagram showing a state of the liquid crystal lens when no voltage is applied in the thirteenth embodiment.

FIG. 47 is a diagram showing a relationship between crosstalk and the ratio of the distance between the common electrode and the electrode pattern to the distance between electrode patterns.

FIG. 48 is a diagram showing parameters of a theoretical expression indicating the lens characteristics.

FIG. 49A is a diagram showing conditions of the simulation of the lens characteristics.

FIG. 49B is a diagram showing results of the simulations under the respective conditions shown in FIG. 49A.

FIG. 49C is a diagram showing a difference between the results of the simulations shown in FIG. 49B and theoretical values.

FIG. 50 is a schematic view showing a cross section of a liquid crystal lens according to a fourteenth embodiment.

FIG. 51 is a schematic view showing electrodes of the liquid crystal lens shown in FIG. 50, viewed from a positive direction of a z-axis.

FIG. 52 is a schematic view showing a cross section of the liquid crystal lens according to a fifteenth embodiment.

FIG. 53A is a diagram showing a relationship between the luminance and the presence or absence of a polarizing plate in a modified example (2).

FIG. 53B is a diagram showing a relationship between crosstalk and the presence or absence of the polarizing plate in the modified example (2).

FIG. 54A is a schematic view showing a cross section of a liquid crystal lens according to a modified example (3).

FIG. 54B is a schematic view showing a cross section of the liquid crystal lens according to the modified example (3).

FIG. 55A is a schematic view showing an electrode pattern in a modified example (4).

FIG. 55B is a schematic view showing the electrode pattern in the modified example (4).

FIG. 56 is a schematic view showing a cross section of a liquid crystal lens according to a modified example (5).

### BEST MODE FOR CARRYING OUT THE INVENTION

A three-dimensional display apparatus according to one embodiment of the present invention includes: a display device capable of displaying an image; and a liquid crystal lens disposed so as to overlap the display device. The liquid crystal lens includes: an insulating substrate; a first electrode formed on the substrate and extending in a first direction; a second electrode formed on the substrate and being substantially parallel to the first electrode; a high resistance portion formed on the substrate and electrically connecting the first electrode and the second electrode; an opposing substrate disposed opposing the substrate; a common electrode formed on the opposing substrate; a liquid crystal layer sandwiched between the substrate and the opposing substrate; and a controller configured to control potentials of the first electrode, the second electrode, and the common electrode, and switch two or more modes. The sheet resistance of the high resistance portion is in 100 GΩ/sq or less. The controller is configured to, in one of the modes, control the first electrode and the second electrode to be at different potentials (the first configuration of the three-dimensional display apparatus).

According to the above configuration, in one mode, the first and second electrodes are controlled to be at different potentials. The first and second electrodes are electrically connected by the high resistance portion. By the high resistance portion, the potential of the region between the first electrode and the second electrode continuously changes from the potential of the first electrode to the potential of the second electrode. For this reason, even when the distance between two adjacent first electrodes is long, it is possible to form a potential gradient up to a center portion between two adjacent first electrodes. The liquid crystal molecules of the liquid crystal layer are oriented according to the potential gradient, thus forming a refractive index distribution. It is possible to obtain excellent lens characteristics by forming the potential gradient up to the center portion between the two adjacent first electrodes.

In the above first configuration of the stereoscopic display apparatus, the high resistance portion may be formed to cover a region between the first electrode and the second electrode. In this case, it is preferable that the sheet resistance is 100 kΩ/sq or more (the second configuration of the stereoscopic display apparatus).

In the above first configuration of the stereoscopic display apparatus, the stereoscopic display apparatus may further includes an auxiliary electrode formed substantially parallel to the first electrode and the second electrode, the auxiliary electrode being electrically connected to the high resistance portion (the third configuration of the stereoscopic display device).

According to the above configuration, it is possible to form a potential difference between the auxiliary electrode and the common electrode. Thus, it is possible to form the high resistance portion in, for example, a region not overlapping the display area of the display apparatus.

In the above third configuration of the stereoscopic display apparatus, it is preferable that a resistance per unit length of the high resistance portion is 10⁻⁴ to 2MΩ/μm (the fourth configuration of the stereoscopic display apparatus).

In the above fourth configuration of the stereoscopic display apparatus, it is preferable that the high resistance portion is formed close to one end of the first electrode (the fifth configuration of the stereoscopic display apparatus).

In the above fourth or fifth configuration of the of the stereoscopic display apparatus, it is preferable that the resistance per unit length of the high resistance portion changes along a direction perpendicular to the first direction (the sixth configuration of the stereoscopic display apparatus).

According to the above configuration, it is possible to change a slope of the potential gradient by changing the resistance of the high resistance portion.

In any one of the above first to sixth configurations of the stereoscopic display apparatus, it is preferable that the controller is configured to control two or less types of potentials of electrodes on a side of the substrate (the seventh configuration of the stereoscopic display apparatus).

According to the above configuration, it is possible to simplify a circuit for generating a potential.

In any one of the above first to the seventh configurations of the stereoscopic display apparatus, in a case that no potential difference is generated between the substrate and the opposing substrate, liquid crystal molecules of the liquid crystal layer may be oriented in a direction substantially parallel to the substrate (the eighth configuration of the stereoscopic display apparatus).

In any one of the first to the seventh configurations of the stereoscopic display apparatus, in a case that no potential difference is generated between the substrate and the opposing substrate, liquid crystal molecules of the liquid crystal layer may be oriented in a direction substantially vertical to the substrate (the ninth configuration of the stereoscopic display apparatus).

In the above eighth configuration of the stereoscopic display apparatus, in the case that no potential difference is generated between the substrate and the opposing substrate, an orientation direction of the liquid crystal molecules on a side of the substrate may be substantially perpendicular to an orientation direction of the liquid crystal molecules on a side of the opposing substrate (the tenth configuration of the stereoscopic display apparatus).

In the above tenth configuration of the stereoscopic display apparatus, the orientation direction of the liquid crystal molecules on the side of the substrate and the first direction form an angle of approximately 45 degrees (the eleventh configuration of the stereoscopic display apparatus).

In the above tenth or eleventh configuration of the stereoscopic display apparatus, it is preferable that the stereoscopic display apparatus further includes a polarizer disposed on the side of the substrate and having a polarization axis that is substantially parallel to the orientation direction of the liquid crystal molecules on the side of the substrate (the twelfth configuration of the stereoscopic display apparatus).

In the above tenth or eleventh configuration of the stereoscopic display apparatus, it is preferable that the stereoscopic display apparatus further includes a polarizer disposed on the side of the opposing substrate and having a polarization axis that is substantially parallel to the orientation direction of the liquid crystal molecules on the side of the opposing substrate (the thirteenth configuration of the stereoscopic display apparatus).

According to the above twelfth or thirteenth configuration of the stereoscopic display apparatus, when no potential difference is generated between the substrate and the opposing substrate, the orientation direction of the liquid crystal molecules is rotated by approximately 90° in a plane substantially perpendicular to the substrate. The polarization axis of the light incident on the liquid crystal layer rotates accordingly and passes through the polarizing plate. On the other hand, when the liquid crystal molecules are oriented substantially perpendicular to the substrate by the potential difference between the substrate and the opposing substrate, the polarization axis of the light incident on the liquid crystal layer does not rotate. For this reason, this light cannot pass through the polarizing plate. Thus, it is possible to form a hypothetical parallax barrier (parallax barrier) that blocks light at regular intervals. It is possible to reduce crosstalk by the parallax barrier.

In any one of the above first to thirteenth configuration of the stereoscopic display apparatus, the substrate may be disposed on a side of the display device (the fourteenth configuration of the stereoscopic display apparatus).

In any one of the above first to thirteenth configuration of the stereoscopic display apparatus, the opposing substrate may be disposed on a side of the display device (the fifteenth configuration of the stereoscopic display apparatus).

A liquid crystal lens according to one embodiment of the present invention includes: a first insulating substrate; a first electrode pattern on the first substrate, the first electrode pattern including a conductive portion and a non-conductive portion which are repeated in stripes along a first direction; a second insulating substrate opposing the first substrate; a second electrode pattern on the second substrate, the second electrode pattern including a conductive portion and a non-conductive portion which are repeated in stripes along the first direction; a liquid crystal layer sandwiched between the first substrate and the second substrate; and a controller configured to control potentials of the first electrode pattern and the second electrode pattern to switch between two or more modes (the first configuration of the liquid crystal lens).

According to the above configuration, the first electrode pattern and the second electrode pattern each including the conductive portion and the non-conductive portion which are repeated in stripes are formed on both the first substrate and the second substrate. Thus, it can become easier to apply an electric field to the in-plane direction in comparison with a case where an electrode pattern is formed on any one of the first substrate and the second substrate, and a uniform common electrode is formed on the other one. The liquid crystal molecules of the liquid crystal layer are oriented according to the electric field, thus forming a refractive index distribution. By the electric field being applied to the in-plane direction, a continuous refractive index distribution can be obtained. Thus, excellent lens characteristics can be obtained.

In the above first configuration of the liquid crystal lens, it is preferred that the non-conductive portion of the first electrode pattern and the non-conductive portion of the second electrode pattern are not opposed to each other (the second configuration of the liquid crystal lens).

According to the above configuration, over substantially the entire region on which the first electrode pattern and the second electrode pattern are formed, the conductive portion is formed on at least one of the first electrode pattern and the second electrode pattern. Thus, a potential gradient becomes easily formed in both the non-conductive portion of the first electrode pattern and the non-conductive portion of the second electrode pattern. Thus, it is possible to more effectively apply an electric field to the in-plane direction.

In the above first or second configuration of the liquid crystal lens, a width of the conductive portion of the first electrode pattern in a portion having a large potential difference between the first electrode pattern and the second electrode pattern is formed narrower in comparison with a portion having a small potential difference between the first electrode pattern and the second electrode pattern (the third configuration of the liquid crystal lens).

A refractive index distribution of the ideal GRIN (gradient index lens) lens becomes a quadratic curve. For this reason, a change in refractive index of the end portion of the lens is steeper than a change in refractive index of the center of the lens. Accordingly, in order to obtain lens characteristics close to those of the ideal GRIN lens, it is preferable to make the potential gradient in the end portion of the lens be steeper than the potential gradient at the center of the lens. The width of the first electrode pattern is formed narrower in a portion having a relatively large potential difference between the first electrode pattern and the second electrode pattern, in comparison with a portion having a relatively small potential difference between the first electrode pattern and the second electrode pattern. Thus, it is possible to make the potential gradient in the end portion of the lens be steeper.

In any one of the above first to third configurations of the liquid crystal lens, it is preferable that the controller is configured to control the potentials of the first electrode pattern and the second electrode pattern to be four or more potential levels in total (the fourth configuration of the liquid crystal lens).

In any one of the above first to fourth configurations of the liquid crystal lens, liquid crystal molecules of the liquid crystal layer may be oriented substantially parallel to the first substrate, in a case that no potential difference is generated between the first substrate and the second substrate (the fifth configuration of the liquid crystal lens).

In any one of the above first to fourth configurations of the liquid crystal lens, liquid crystal molecules of the liquid crystal layer may be oriented substantially vertical to the first substrate, in a case that no potential difference is generated between the first substrate and the second substrate (the sixth configuration of the liquid crystal lens).

In the above fifth configuration of the liquid crystal lens, in a case that no potential difference is generated between the first substrate and the second substrate, an orientation direction of the liquid crystal molecules on a side of the first substrate may be substantially perpendicular to an orientation direction of the liquid crystal molecules on a side of the second substrate (the seventh configuration of the liquid crystal lens).

In the above seventh configuration of the liquid crystal lens, an angle formed by the orientation direction of the liquid crystal molecules on the side of the first substrate and the second direction may be approximately 45 degrees (the eighth configuration of the liquid crystal lens).

In the above seventh or eighth configuration of the liquid crystal lens, the liquid crystal lens may further include a polarizer disposed on the first substrate side, the polarizer having a polarization axis substantially parallel to the orientation direction of the liquid crystal molecules on the side of the first substrate (the ninth construction of the liquid crystal lens).

In the above seventh or eighth configuration of the liquid crystal lens, the liquid crystal lens may further includes a polarizer disposed on the second substrate side, the a polarizer having a polarization axis substantially parallel to the orientation direction of the liquid crystal molecules on the side of the second substrate (the tenth construction of the liquid crystal lens).

According to the above ninth or tenth configuration of the liquid crystal lens, when no potential difference is generated between the first substrate and the second substrate, the orientation direction of the liquid crystal molecules is rotated by approximately 90° in a plane substantially perpendicular to the first substrate. The polarization axis of the light incident on the liquid crystal layer rotates accordingly and passes through the polarizing plate. On the other hand, when the liquid crystal molecules are oriented substantially perpendicular to the first substrate by the potential difference between the first substrate and the second substrate, the polarization axis of the light incident on the liquid crystal layer does not rotate. For this reason, this light cannot pass through the polarizing plate. Thus, it is possible to form a hypothetical parallax barrier (parallax barrier) that blocks light at regular intervals. It is possible to reduce crosstalk by the parallax barrier.

A stereoscopic display apparatus according to one embodiment of the present invention includes: a display device configured to display an image; and the liquid crystal lens according to any one of the above first to tenth configurations (the sixteenth construction of the liquid crystal lens).

In the above sixteenth configuration of the stereoscopic display apparatus, the first substrate of the liquid crystal lens may be disposed on a side of the display device (the seventeenth construction of the liquid crystal lens).

In the above sixteenth configuration of the stereoscopic display apparatus, the second substrate of the liquid crystal lens may be disposed on a side of the display device.

### Embodiment

Hereinafter, embodiments of the present invention will be described in detail with reference to the drawings. The same symbols will be appended to the same or corresponding portions in the drawings, and description thereof will not be repeated. In order to simplify the description, in the drawings referenced in the following, the illustrated configuration has been schematically simplified, or a part of components has been omitted. The dimensional ratio between components shown in each drawing does not necessarily indicate the actual dimension ratio.

### [Entire Configuration]

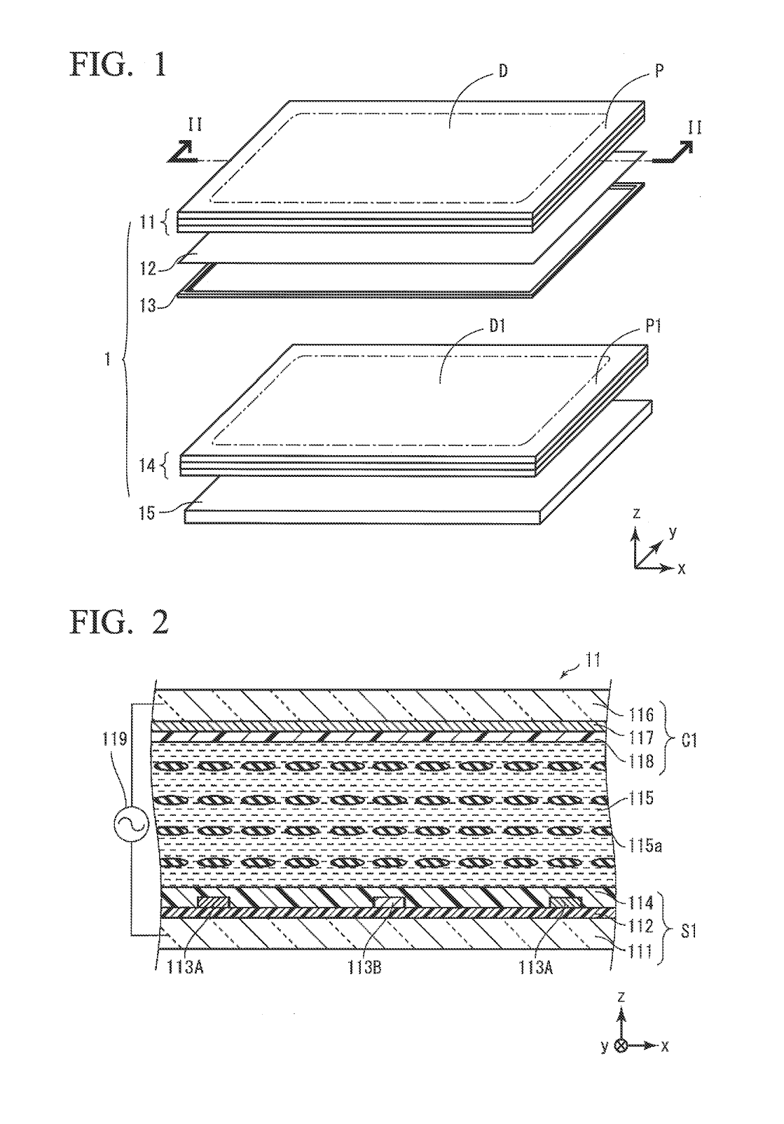

FIG. 1 is an exploded perspective view showing a schematic configuration of a stereoscopic display apparatus 1 according to an embodiment of the present invention. The stereoscopic display apparatus 1 includes a liquid crystal lens 11, a phase difference plate 12, a spacer 13, a liquid crystal display 14, and a backlight 15.

The liquid crystal lens 11 and the liquid crystal display 14 have plate-like shapes which are substantially rectangular in plan view, and are formed such that the sizes of main surfaces (surfaces with the largest area) are substantially equal to each other.

The liquid crystal display 14 has a display region D1 for displaying an image, and a non-display region P1 in which wires and the like are arranged. In FIG. 1, the non-display region P1 is formed in a frame-like shape surrounding the display region D1, but the arrangement of the non-display region P1 is not limited thereto. The liquid crystal lens 11 has a display region D schematically corresponding to the display region D1, and a non-display region P schematically corresponding to the non-display area P1.

Although a detailed configuration of the liquid crystal lens 11 will be described later, the liquid crystal lens 11 includes a pair of substrates and a liquid crystal layer sandwiched therebetween. The liquid crystal lens 11 changes orientation of liquid crystal molecules included in the liquid crystal layer, thereby changing behavior of light passing through the liquid crystal layer.

The phase difference plate 12 is disposed on the back of the liquid crystal lens 11. The phase difference plate 12 adjusts the polarization direction of the light emitted from the liquid crystal display 14. Here, it is not necessary to provide the phase difference plate 12, depending on the polarization direction of the light emitted from the liquid crystal display 14.

The liquid crystal display 14 is disposed on the back of the phase difference plate 12 through the spacer 13. The liquid crystal display 14 includes an active matrix substrate, a color filter substrate disposed opposite thereto, and a liquid crystal layer sandwiched between both the substrates. TFTs (thin film transistors) and pixel electrodes are formed in a matrix on the active matrix substrate. The liquid crystal display 14 controls the TFTs, thereby changing orientation of the liquid crystal molecules included in the liquid crystal layer on any pixel electrode. Thus, the liquid crystal display 14 can display any image.

The backlight 15 is disposed on the back of the liquid crystal display 14. The backlight 15 emits light to the liquid crystal display 14.

The stereoscopic display apparatus 1 conjunctively controls the liquid crystal lens 11 and the liquid crystal display 14, thereby switching between a two-dimensional display mode and a three-dimensional display mode.

In the two-dimensional display mode, the liquid crystal display 14 displays a normal two-dimensional image. At this time, the liquid crystal molecules included in the liquid crystal layer of the liquid crystal lens 11 are oriented uniformly, and most of the light passing through the liquid crystal lens 11 proceeds as it is. As a result, a normal two-dimensional image is displayed on the three-dimensional display device 1.

In the three-dimensional display mode, the liquid crystal display 14 regularly arranges and displays images captured from multiple directions. Correspondingly with this, the liquid crystal lens 11 regularly changes orientation of the liquid crystal molecules included in the liquid crystal layer. Thus, when observing the stereoscopic display apparatus 1 at the optimum position, different images can reach the left and right eyes. In other words, in the three-dimensional display mode, the stereoscopic display apparatus 1 performs a stereoscopic display by a so-called parallax method.

The schematic configuration of the three-dimensional display device 1 has been described above. Here, the stereoscopic display apparatus 1 may include any display device other than the liquid crystal display 14.

### Embodiment 1

Hereinafter, the configuration of the liquid crystal lens 11 will be described in detail. Hereinafter, as shown in FIG. 1, a long-side direction, a short side direction, and a thickness direction of the liquid crystal lens 11 are respectively referred to as an x-direction, a y-direction, and a z-direction.

FIG. 2 is a cross-sectional view taken along a line II-II shown in FIG. 1, and schematically illustrates the configuration of the liquid crystal lens 11. The liquid crystal lens 11 includes a patterned substrate S1, an opposing substrate C1, a liquid crystal layer 115, and a controller 119.

In the present embodiment, as liquid crystal molecules 115a constituting the liquid crystal layer 115, liquid crystal molecules with positive dielectric anisotropy are used. The liquid crystal molecules 115a have birefringence. In other words, a refractive index nₑ with respect to the light vibrating in a direction parallel to the optical axis is different from a refractive index nₒ with respect to light vibrating in a direction perpendicular to the optical axis. Regarding the liquid crystal molecules 115a, the liquid crystal molecules having a large value of Δn=nₑ−nₒ are preferred.

The controller 119 controls the patterned substrate S1 and the opposing substrate C1, and applies an electric field to the liquid crystal layer 115, thus changing the orientation of the liquid crystal molecules 115a. The controller 119 is disposed in, for example, the non-display region P of the patterned substrate S1 or the opposing substrate C1. The controller 119 may be monolithically formed on these substrates by a semiconductor process. Alternatively, the controller 119 may be mounted on these substrates by the COG (chip on glass) technology. The controller 119 may be disposed on a place other than the non-patterned substrate S1 and the opposing substrate C1. In this case, the controller 119 is connected to those substrates via, for example, an FPC (flexible printed circuit).

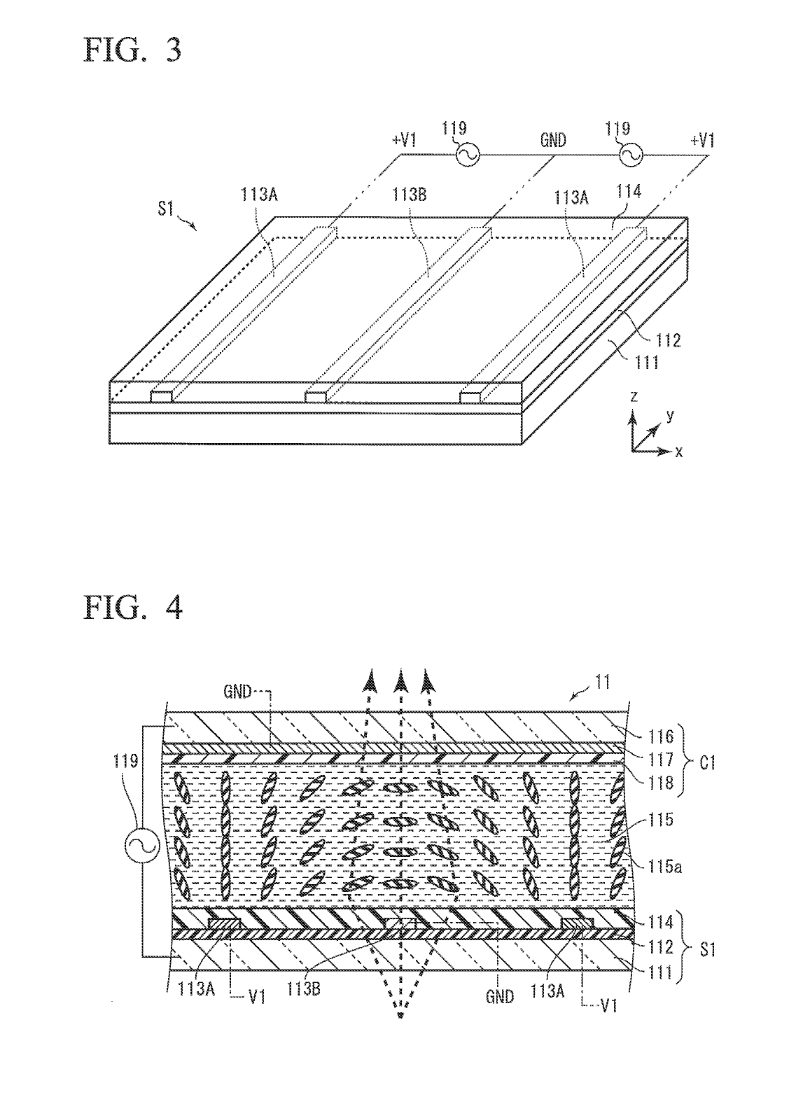

FIG. 3 is a perspective view showing, by extracting from the configuration of the liquid crystal lens 11, a part of the patterned substrate S1. As shown in FIGS. 2 and 3, the patterned substrate S1 includes a substrate 111, a high resistance portion 112, a first electrode 113A, a second electrode 113B, and an alignment film 114.

The substrate 111 has light-transmissive and insulating properties. The sheet resistance of the substrate 111 is higher than 100 GΩ/sq. An example of the substrate 111 is a glass substrate. A surface of the substrate 111 may be coated with a passivation film, or the like.

The high resistance portion 112 is formed of a transparent material as a uniform film on the substrate 111. A sheet resistance of the high resistance portion 112 is a 100 k to 100 GΩ/sq. An example of the high resistance portion 112 is IGZO (indium gallium zinc oxide). The high resistance portion 112 is deposited on the substrate 111 by, for example, a CVD (chemical vapor deposition). In this case, the sheet resistance can be controlled by, for example, varying the amount of impurities.

Preferably, the high resistance portion 112 is formed as a film covering the entire display region D and having a uniform thickness.

The first electrode 113A and the second electrode 113B are formed of a light transmissive material, in contact with the high resistance film 112. As shown in FIGS. 2 and 3, the first electrode 113A and the second electrode 113B are alternately disposed at predetermined intervals along the x-direction. As shown in FIG. 3, each of the first electrode 113A and the second electrode 113B is formed elongated so as to extend in the y-direction.

The sheet resistances of the first electrode 113A and the second electrode 113B are, for example, 20 to 100 Ω/sq, and a lower resistance is preferred. An example of the first electrode 113A and the second electrode 113B is ITO (indium tin oxide) or IZO (indium zinc oxide). The first electrode 113A and the second electrode 113B are deposited by, for example, sputtering or CVD, and are patterned by photolithography.

The first electrode 113A and the second electrode 113B are connected to the controller 119 via wires (not shown). The controller 119 independently controls the potentials of the first electrode 113A and the second electrode 113B. In FIG. 3, as an example of applied voltages, the first electrode 113A and the second electrode 113B are respectively controlled to be at the potential V1 and the ground potential (GND).

The alignment film 114 is formed so as to cover the high resistance portion 112, the first electrode 113A, and the second electrode 113B. An example of the alignment layer 114 is polyimide, which is formed by a printing method.

The opposing substrate C1 includes a substrate 116, a common electrode 117, and an alignment film 118.

Similar to the substrate 111, the substrate 116 has light-transmissive and insulating properties. An example of the substrate 116 is a glass substrate.

The common electrode 117 is uniformly formed of a light-transmissive material on the substrate 111. Similarly to the first electrode 113A and the second electrode 113B, a sheet resistance of the common electrode 117 is, for example, 20 to 100 Ω/sq, and a lower value is preferred. An example of the common electrode 117 is ITO or IZO, and is deposited by sputtering or CVD.

The common electrode 117 is connected to the controller 119 via wires (not shown). The controller 119 controls the potential of the common electrode.

The alignment film 118 is formed so as to cover the common electrode 117. Similar to the alignment film 114, an example of the alignment film 118 is polyimide, and is formed by a printing method.

In the present embodiment, the alignment film 114 and the alignment film 118 have been rubbed (rubbing) in a direction substantially parallel to the x-direction. As a result, when no potential difference is generated between the patterned substrate 51 and the opposing substrate C1, the liquid crystal molecules 115a are oriented in the x-direction.

The liquid crystal lens 11 is manufactured by superimposing the patterned substrate S1 and the opposing substrate C1, sealing a periphery portion, and injecting liquid crystal into the gap.

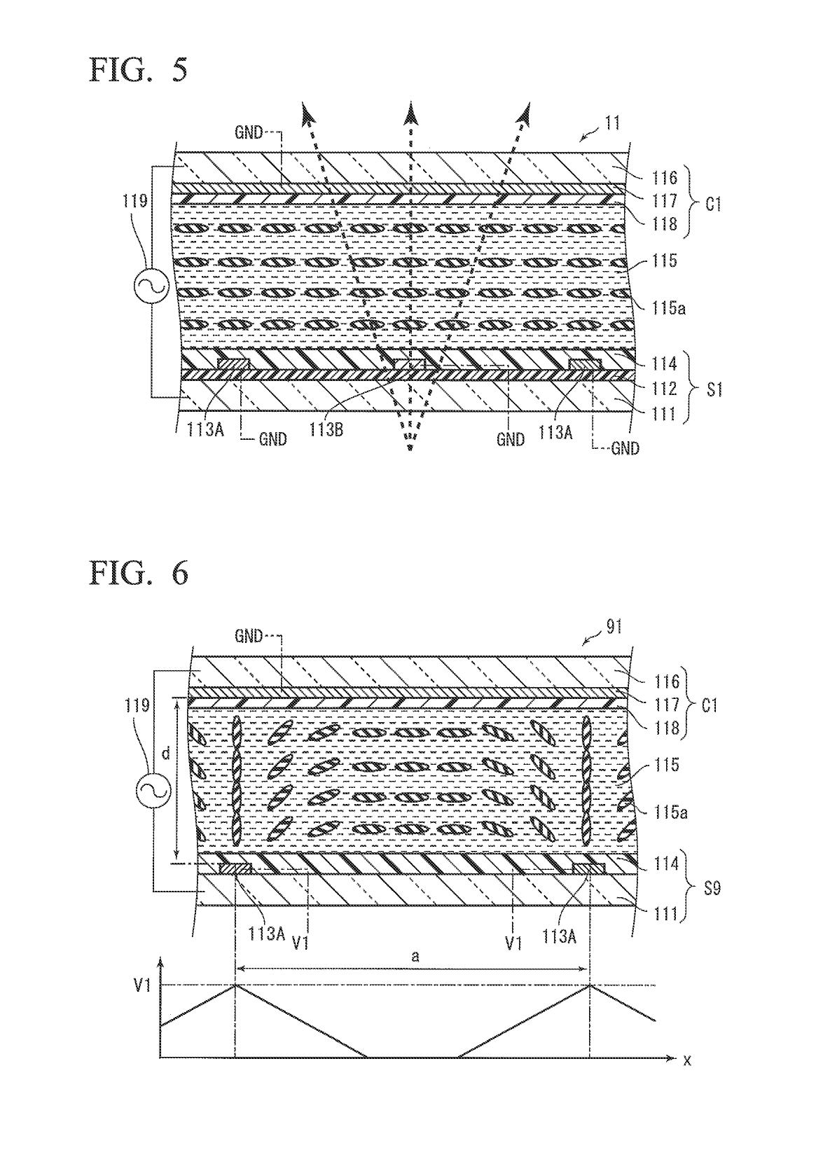

Next, operation of the liquid crystal lens 11 will be described with reference to FIGS. 4 and 5.

FIG. 4 is a schematic cross-sectional view of the liquid crystal lens 11 in one mode. In FIG. 4, the controller 119 controls the potentials of the first electrode 113A, the second electrode 113B, and the common electrode 117 to be the potentials V1, GND, and GND, respectively.

The liquid crystal molecules 115a are oriented so that molecular long axes thereof becomes parallel to the electric field generated by the potential difference between the patterned substrate S1 and the opposing substrate C1. The potential difference V1 is being generated between the first electrode 113A and the common electrode 117. Thus, the molecular long axes of the liquid crystal molecules 115a close to the first electrode 113A are oriented parallel to the z-direction.

In the present embodiment, the high resistance portion 112 is formed so as to cover a region between the first electrode 113A and the second electrode 113B. In other words, the first electrode 113A and the second electrode 113B are electrically connected to each other by the high resistance portion 112. Therefore, the potential of the region between the first electrode 113A and the second electrode 113B is continuously changing from the potential V1 to GND. The potential of the common electrode 117 is constant at GND. For this reason, the potential difference between the patterned substrate S1 and the opposing substrate C1 is continuously changing from V1 to GND along the x-direction. Thus, the orientation direction of the liquid crystal molecules 115a is continuously changing from the z-direction to the x direction.

According to the change in the orientation direction of the liquid crystal molecules 115a, a refractive index of the liquid crystal layer 115 changes. For this reason, the liquid crystal layer 115 has a refractive index distribution in the x-direction. By this refractive index distribution, the liquid crystal layer 115 can condense the light incident on the liquid crystal layer 115, as indicated by dashed arrows shown in FIG. 4. In other words, the liquid crystal lens 11 in this mode functions as a gradient index lens (GRIN lenses).

FIG. 5 is a schematic cross-sectional view of the liquid crystal lens 11 in another mode. In FIG. 5, the controller 119 controls the potentials of the first electrode 113A, the second electrode 113B, and the common electrode to be GND. For this reason, no potential difference is generated between the patterned substrate S1 and the opposing substrate C1. The liquid crystal molecules 115a are oriented by the alignment films 114 and 118 so that the molecular long axes thereof become parallel to the x-direction.

Since the liquid crystal molecules 115a are aligned uniformly, the refractive index of the liquid crystal layer 115 also becomes uniform. As indicated by dashed arrows shown in FIG. 5, most of the light incident on the liquid crystal layer 115 passes as it is. In other words, the liquid crystal lens 11 is not functioning as a GRIN lens in this operation mode.

Thus, the liquid crystal lens 11 can switch the functions of the GRIN lens by the controller 119 controlling the potentials of the first electrode 113A, the second electrode 113B, and the common electrode 117.

### Comparative Example

FIG. 6 is a schematic cross-sectional view of a liquid crystal lens 91 according to a hypothetical comparative example to describe the effects of the present embodiment. The liquid crystal lens 91 includes a patterned substrate S9, in lieu of the patterned substrate S1. The patterned substrate S9 is one obtained by excluding the high resistance portion 112 and the second electrode 113B from the configuration of the patterned substrate S1. FIG. 6 also shows a manner of a change along the x-direction in potential difference between the patterned substrate S9 and the opposing substrate C1.

In FIG. 6, the controller 119 has controlled the potentials of the first electrode 113A and the common electrode 117 to be the potential V1 and GND, respectively. Similar to the liquid crystal lens 11, a potential difference V1 is generated between the first electrode 113A and the common electrode 117. Thus, the molecular long axes of the liquid crystal molecules 115a close to the first electrode 113A are oriented parallel to the z-direction.

However, in the liquid crystal lens 91, a potential gradient is not formed in an intermediate region between two adjacent first electrodes 113A. In this region, the orientation direction of the liquid crystal molecules 115a has not almost changed. For this reason, an effective refractive index distribution cannot be obtained, and therefore excellent lens characteristics cannot be obtained.

Such a problem arises when a value of the interval a between two adjacent first electrodes 113A is larger than the distance d between the first electrode 113A and the common electrode 117. When the ratio a/d is approximately 7 or more, the liquid crystal lens 91 does not function as a GRIN lens.

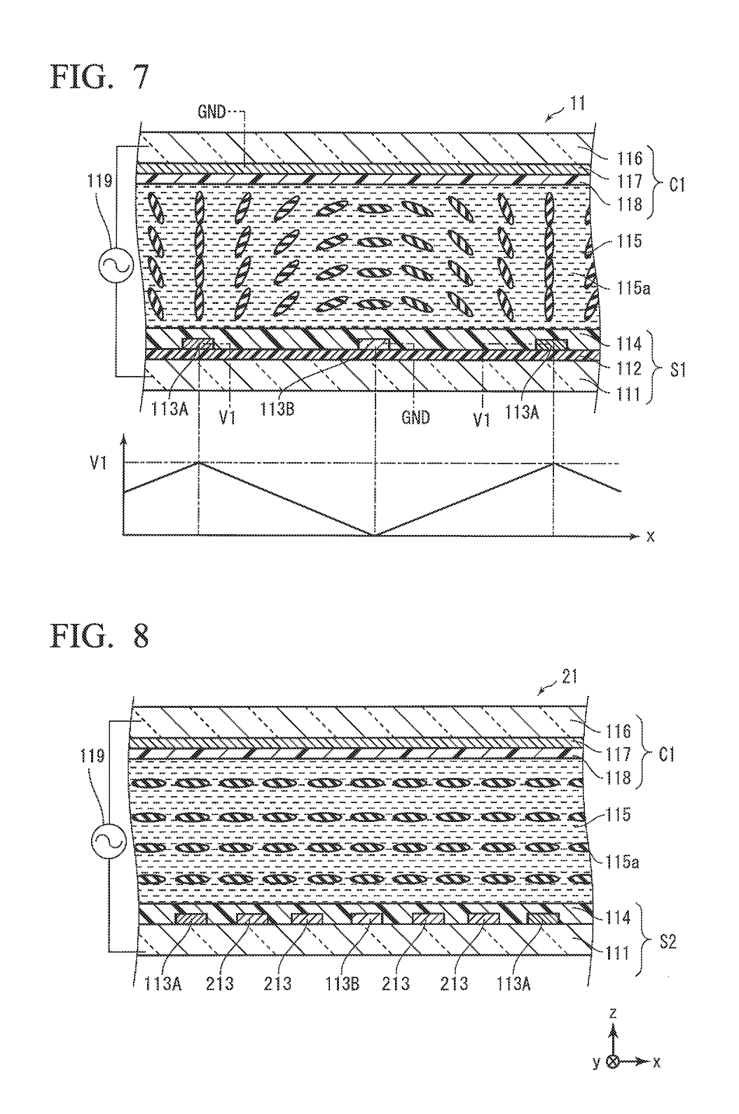

FIG. 7 is a schematic cross-sectional view illustrating the effects of the liquid crystal lens 11 according to the present embodiment. FIG. 7 also shows a manner of a change along the x-direction in potential difference between the patterned substrate S1 and the opposing substrate C1.

In the present embodiment, the high resistance portion 112 electrically connects the first electrode 113A and the second electrode 113B. Thus, the potential difference between the patterned substrate S1 and the opposing substrate C1 is continuously changing from V1 to GND along the x-direction. In other words, a potential gradient is formed also in the intermediate region between two adjacent first electrodes 113A. Thus, the orientation direction of the liquid crystal molecules 115a also changes continuously, and thus excellent lens characteristics can be obtained.

The sheet resistance of the high-resistance film 112 is 100 k to 100 GΩ/sq. This is due to the following reasons.

It is necessary that a potential drop from one end of the first electrode 113A to the other end (the potential drop in the y-direction) be sufficiently small in comparison with a potential drop in the x-direction. Assuming that the sheet resistance of the high resistance portion 112 is ρₛ, it is necessary to satisfy, for example, the relation ρₛ×0.5>>100×400 where the sheet resistance of the first electrode 113A is 100 Ω/sq, the length in the y-direction of the first electrode 113A is 400 mm, and the distance between the first electrode 113A and the second electrode 113B is 0.5 mm. Accordingly, the sheet resistance of the high resistance portion 112 should be 100 kΩ/sq or more. More preferably, the sheet resistance of the high resistance portion 112 is 500 kΩ/sq or more. Much more preferably, the sheet resistance of the high resistance portion 112 is 1 MΩ/sq or more.

On the other hand, a potential gradient cannot be formed when the sheet resistance of the high resistance portion 112 is too high. Accordingly, the sheet resistance of the high resistance portion 112 should be 100 GΩ/sq or less. More preferably, the sheet resistance of the high resistance portion 112 is 1 GΩ/sq or less. Much more preferably, the sheet resistance of the high resistance portion 112 is 100 MΩ/sq or less.

The configurations and effects of the liquid crystal lens 11 according to the first embodiment have been described above. According to the present embodiment, it is possible to obtain excellent lens characteristics even when the ratio a/d is large.

The liquid crystal lens 11 may be configured in the stereoscopic display apparatus 1 (FIG. 1) such that the patterned substrate S1 is disposed on the liquid crystal display 14 side, or the opposing substrate C1 is disposed on the liquid crystal display 14 side.

The alignment films 114 and 118 of the liquid crystal lens 11 have been rubbed in a direction (x-direction) substantially perpendicular to the extending direction (y-direction) of the first electrode 113A and the second electrode 113B. However, the rubbing direction of the alignment films is optional. For example, the alignment films 114 and 118 may be rubbed parallel to the y-direction.

The description has been given above with respect to the example where in one mode of the liquid crystal lens 11, the potentials of the first electrode 113A, the second electrode 113B, and the common electrode 117 are respectively controlled to be V1, GND, and GND. Further, the description has been given above with respect to the example where in the other mode of the liquid crystal lens 11, the potentials of the first electrode 113A, the second electrode 113B, and the common electrode 117 are controlled to be GND. However, values of the potentials are all optional. For example, the potentials of the second electrode 113B and the common electrode 117 need not be the same. Additionally, the potentials of the second electrode 113B and the common electrode 117 may take any value other than GND.

The liquid crystal lens 11 can independently control, using the controller 119, the first electrode 113A and the second electrode 113B. In other words, the liquid crystal lens 11 can simultaneously input two types of potentials to the patterned substrate S1. The liquid crystal lens 11 may be configured to be able to further input multiple types of potentials to the patterned substrate S1. In other words, a configuration may be such that the patterned substrate S1 further includes multiple kinds of electrodes, which are independently controlled by the controller 119.

However, in order to increase the types of potentials, a signal generating circuit therefor is required. Further, if electrodes are densely formed, there is a concern about a reduction in yield. According to the present embodiment, even when the number of types of potentials is small, it is possible to obtain excellent lens characteristics with use of the high resistance portion 112.

### Second Embodiment

The stereoscopic display apparatus 1 may include, in lieu of the liquid crystal lens 11, any one of liquid crystal lenses that will be described below.

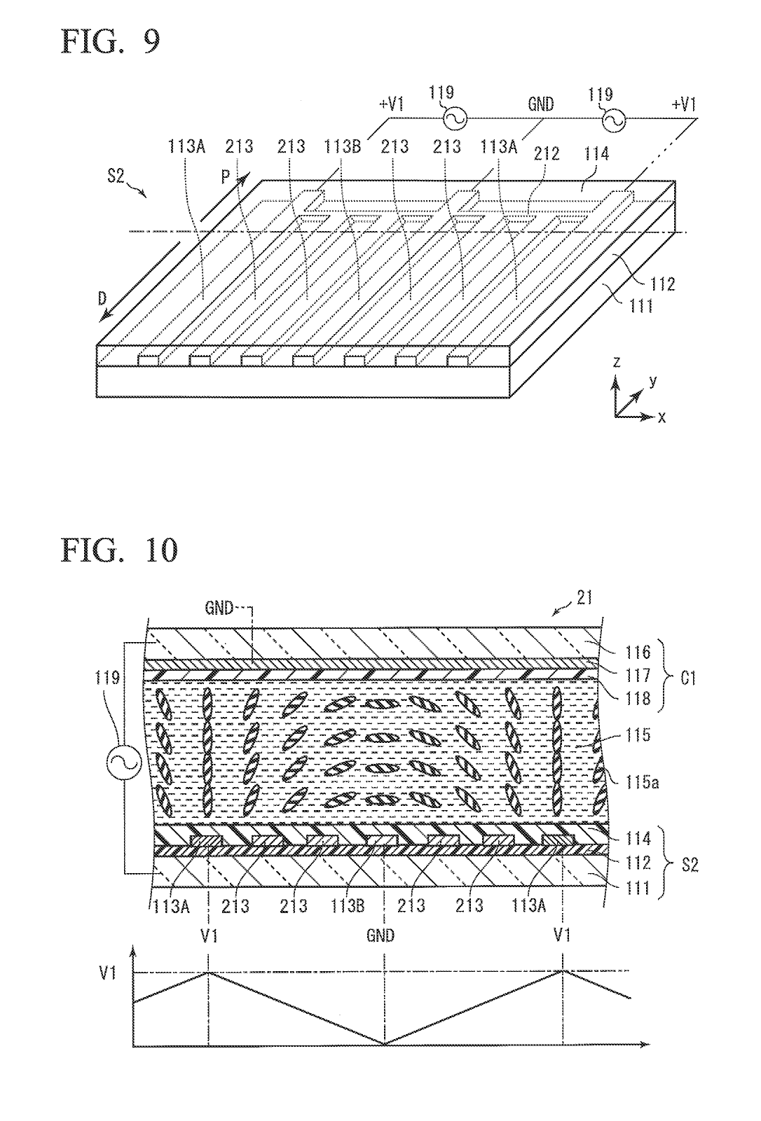

FIG. 8 is a schematic cross-sectional view showing a schematic configuration of a liquid crystal lens 21 according to a second embodiment of the present invention. The liquid crystal lens 21 includes a patterned substrate S2, in lieu of the patterned substrate S1. FIG. 9 is a perspective view showing, by extracting from the configuration of the liquid crystal lens 21, a part of the patterned substrate S2. As shown in FIG. 9, the patterned substrate S2 includes a high resistance portion 212, in lieu of the high resistance portion 112 of the patterned substrate 51. The patterned substrate S2 further includes an auxiliary electrode 213.

The high resistance portion 212 is formed close to one ends of the first electrode 113A and the second electrode 113B. In other words, the high resistance portion 212 is formed close to the one end of the first electrode 113A and the one end of the second electrode 113B adjacent to the first electrode 113A. Thus, the high resistance portion 212 is formed in the non-display region P of the substrate 111. For this reason, the high resistance portion 212 may not have a light-transmissive property. Additionally, in the present embodiment, a signal is input from one ends of the first electrode 113A and the second electrode 113B. For this reason, a voltage drop is less likely to occur in the xy-plane. Accordingly, as the high resistance portion 212, a material having a low resistivity can also be used in comparison with a high resistance portion 112 of the first embodiment.

The high resistance portion 212 is formed in a linear shape that is substantially parallel to the x-direction. The high resistance section 212 connects the first electrode 113A and the second electrode 113B. A resistance per unit length of the high resistance portion 212 is 10⁻⁴ to 2 MΩ/μm. The resistance per unit length of the high resistance portion 212 may be controlled based on a material, a thickness, or a line width.

The auxiliary electrodes 213 are formed of a light-transmissive material on the substrate 111. Each auxiliary electrode 213 is formed between the first electrode 113A and the second electrode 113B. Similar to the first electrode 113A and the second electrode 113B, the auxiliary electrodes 213 are disposed at predetermined intervals along the x-direction, and are formed elongated so as to extend in the y-direction. In other words, the auxiliary electrodes 213 are formed in a strip shape extending in the y-direction. A sheet resistance of the auxiliary electrode 213 is, for example, 20 to 100 Ω/sq, and a lower value is preferred.

The auxiliary electrode 213 is formed in contact with the high resistance portion 212. Thus, the first electrode 113A, the second electrode 113B, and the auxiliary electrode 213 are electrically connected through the high resistance portion 212. Here, the auxiliary electrode 213 is not controlled directly by the controller 119.

Any two or more of the first electrode 113A, the second electrode 113B, the high resistance portion 212, and the auxiliary electrode 213 can be formed of the same material and by the same process. In this case, these elements are, for example, ITO or IZO, which are deposited by CVD or sputtering and patterned by photolithography.

FIG. 10 is a schematic cross-sectional view illustrating the effects of the liquid crystal lens 21. FIG. 10 also shows a manner of a change along the x-direction in potential difference between the patterned substrate S2 and the opposing substrate C1.

In FIG. 10, the controller 119 has controlled potentials of the first electrode 113A, the second electrode 113B, and the common electrode 117 to the potentials V1, GND, and GND, respectively.

In the present embodiment, the first electrode 113A, the second electrode 113B, and the auxiliary electrode 213 are electrically connected through the high resistance portion 212. For this reason, the potential is changing continuously from the first electrode 113A to the auxiliary electrode 213, and from the auxiliary electrode 213 to the second electrode 113B. Thus, the potential difference between the patterned substrate S2 and the opposing substrate C1 is continuously changing from V1 to GND along the x-direction. In other words, a potential gradient is formed even in an intermediate region between two adjacent first electrodes 113A. Thus, the orientation direction of the liquid crystal molecules 115a also changes continuously, and therefore excellent lens characteristics can be obtained.

Considering a voltage drop between the power supplies, when a resistance value of the high resistance portion 212 is too low, it becomes necessary to increase the voltage to be applied. For this reason, a resistance per unit length of the high resistance portion 212 should be 10⁻⁴ Ω/μm or more. More preferably, the resistance per unit length of the high resistance portion 212 is 1 Ω/μm or more. Much more preferably, the high resistance portion 212 is 100 Ω/μm or more.

On the other hand, when the resistance per unit length of the high resistance portion 212 is too high, a potential gradient cannot be formed. Accordingly, the resistance per unit length of the high resistance portion 212 should be 2MΩ/μm or less. More preferably, the resistance per unit length of the high resistance portion 212 is 20 kΩ/μm or less. Much more preferably, the resistance per unit length of the high resistance portion 212 is 2 kΩ/μm or less.

In FIGS. 8 to 10, two auxiliary electrodes 213 are formed between the first electrode 113A and the second electrode 113B, but the number of the auxiliary electrodes 213 is optional. The auxiliary electrode 213 is formed so as to extend from the high resistance portion 212 in the case of FIG. 9. However, the auxiliary electrode 213 and the high resistance portion 212 may be connected in any manner. For example, the auxiliary electrodes 212 may be formed so as to intersect the high resistance portion 212.

Additionally, in FIG. 9, the high resistance portion 212 is formed in a straight line parallel to the x-direction. However, the high resistance portion 212 may not be parallel to the x-direction, nor be straight.

Also in the present embodiment, a configuration may be such that the patterned substrate S2 further includes multiple types of electrodes, and the controller 119 independently controls those electrodes. However, according to the present embodiment, even when the number of types of potentials is small, it is possible to obtain excellent lens characteristics by use of the high resistance portion 212.

### Third Embodiment

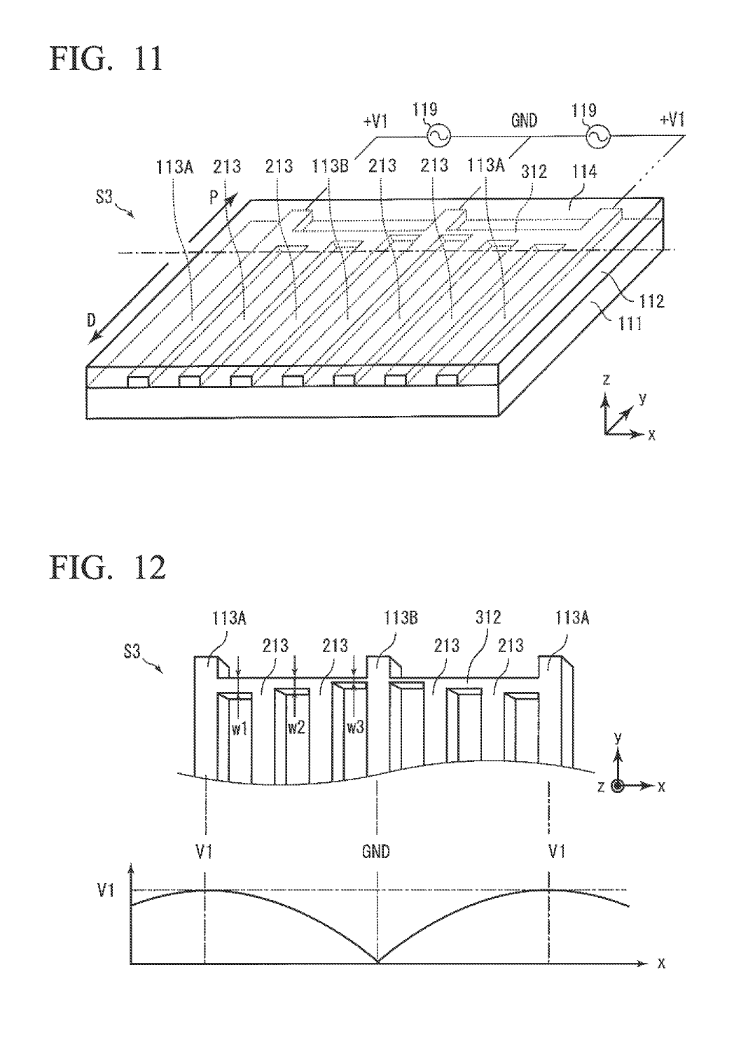

A liquid crystal lens according to a third embodiment of the present invention includes a patterned substrate S3, in lieu of the patterned substrate S2 of the liquid crystal lens 21. FIG. 11 is a perspective view showing, by extracting from the configuration of the liquid crystal lens according to the third embodiment, a part of the patterned substrate S3. The patterned substrate S3 includes a high resistance portion 312, in lieu of the high resistance portion 212 of the patterned substrate S2.

FIG. 12 is a plan view showing, by extracting from the configuration of the patterned substrate S3, the first electrode 113A, the second electrode 113B, the auxiliary electrode 213, and the high resistance portion 312. FIG. 12 also shows a manner of a change along the x-direction in potential difference between the patterned substrate S3 and the common electrode C1.

In FIG. 12, the controller 119 has controlled potentials of the first electrode 113A, the second electrode 113B, and the common electrode 117 to be the potentials V1, GND, and GND, respectively.

The high resistance portion 312 has different line widths w1, w2, and w3. The line width w1 is a width of a portion connecting the first electrode 113A and the auxiliary electrode 213. The line width w2 is a width of a portion connecting two adjacent auxiliary electrodes 213. The line width w3 is a width of a portion connecting the auxiliary electrode 213 and the second electrode 113B. Thus, the resistance of the high resistance portion 312 differs among those electrodes. For this reason, the amounts of potential drops among those electrodes differ from one another. In the examples shown in FIGS. 11 and 12, the high resistance portion 312 is formed such that the line width w1>the line width w2>the line width w3. Thus, the amount of the potential drop between the first electrode 113A and the auxiliary electrode 213 is smaller than the amount of a potential drop between two adjacent auxiliary electrodes 213. Similarly, the amount of a potential drop between the two adjacent auxiliary electrodes 213 is smaller than the amount of a potential drop between the auxiliary electrode 213 and the second electrode 113B.

Thus, it is possible to freely design a potential gradient by varying the resistance per unit length of the high resistance portion 312 along the x-direction.

In the present embodiment, the resistance of the high resistance portion 312 is changed by changing the line width of the high resistance portion 312. However, a material or thickness of the high resistance portion 312 may be changed in order to change the resistance of the high resistance portion 312.

### Fourth Embodiment

A liquid crystal lens according to a fourth embodiment of the present invention includes a patterned substrate S4, in lieu of the patterned substrate S2 of the liquid crystal lens 21. FIG. 13 is a perspective view showing, by extracting from the configuration of the liquid crystal lens according to the fourth embodiment, a part of the patterned substrate S4. The patterned substrate S4 includes high resistance portions 412, in lieu of the high resistance portion 212 of the patterned substrate S2.

The high resistance portions 412 are formed close to both ends of both the first electrode 113A and the second electrode 113B. Thus, the high resistance portions 412 are formed on two opposing non-display regions P of the substrate 111.

Further, in the patterned substrate S4, the controller 119 inputs signals from both sides in the y-direction to the first electrode 113A and the second electrode 113B.

It is possible to increase the redundancy of the signals by inputting signals from both sides in the y-direction. In other words, it is possible to form a strong structure for defects such as breakage. Additionally, by inputting signals from both sides in the y-direction, it is possible to reduce the potential difference between one end and the other end of the first electrode 113A and the second electrode 113B.

### Fifth Embodiment

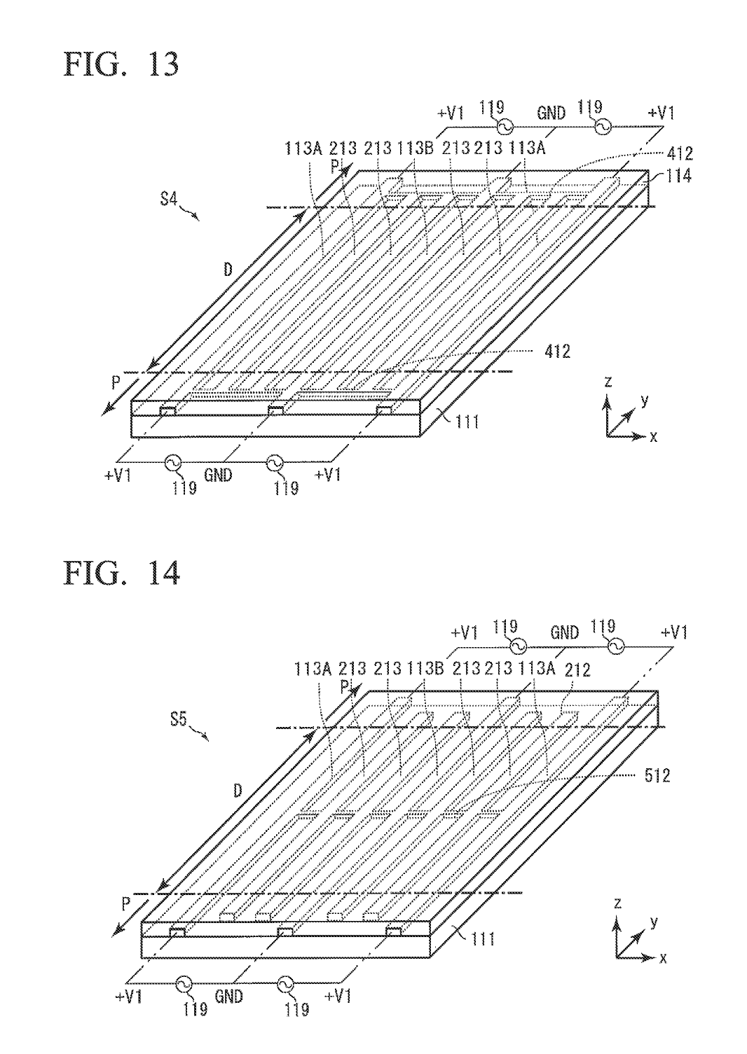

A liquid crystal lens according to a fifth embodiment of the present invention includes a patterned substrate S5, in lieu of the patterned substrate S2 of the liquid crystal lens 21. FIG. 14 is a perspective view showing, by extracting from the configuration of the liquid crystal lens according to the fifth embodiment, a part of the patterned substrate S5. The patterned substrate S5 includes a high resistance portion 512, in lieu of the high resistance portion 212 of the patterned substrate S2.

The high resistance portion 512 is formed in the display region D. For this reason, it is preferable that the high resistance portion 512 be formed of a light-transmissive material or with the sufficiently-thin line width.

Also in patterned substrate 55, the controller 119 inputs signals from both sides of the y-direction to the first electrode 113A and the second electrode 113B.

Also in the present embodiment, similar effects to those in the fourth embodiment can be obtained.

### Sixth Embodiment

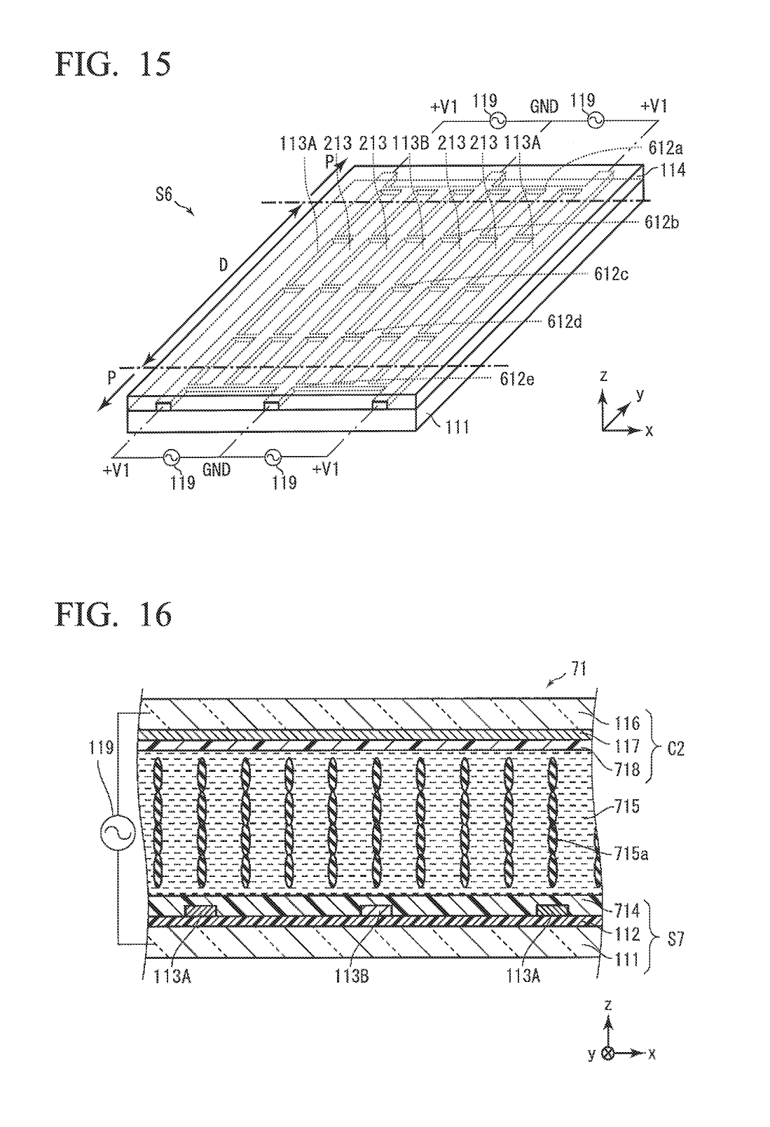

A liquid crystal lens according to a sixth embodiment of the present invention includes a patterned substrate S6, in lieu of the patterned substrate S2 of the liquid crystal lens 21. FIG. 15 is a perspective view showing, by extracting from the configuration of the liquid crystal lens according to the sixth embodiment, a part of the patterned substrate S6. The patterned substrate S6 includes high resistance portions 612a to 612e, in lieu of the high resistance portion 212 of the patterned substrate S2.

The high resistance portions 612a and 612e are formed close to both ends of the first electrode 113A and the second electrode 113B. Thus, the high resistance portions 612a and 612e are formed in the two opposing non-display regions P. On the other hand, the high resistance portions 612b, 612c, and 612d are formed in the display region D. For this reason, it is preferable that the high resistance portions 612b, 612c, and 612d be formed of a light-transmissive material or with sufficiently-thin line widths. The high resistance portions 612a to 612e may have different resistances per unit length and be formed of different materials.

Also in the patterned substrate S6, the controller 119 inputs signals from both sides of the y-direction to the first electrode 113A and the second electrode 113B.

In some cases, the high resistance portions 612a to 612e are formed thin or narrow in order to increase the resistance per unit length. It is possible to increase the redundancy by forming a plurality of high resistance portions. In other words, it is possible to form a strong structure for defects such as breakage.

Additionally, it is possible to control the amount of potential drops in the y-direction by changing the resistance per unit length of each of the high resistance portions 612a to 612e. Thus, it is possible to equalize the potential in the y-direction of the first electrode 113A and the like.

### Seventh Embodiment

FIG. 16 is a schematic cross-sectional view showing a schematic configuration of a liquid crystal lens 71 according to a seventh embodiment of the present invention. The liquid crystal lens 71 includes a patterned substrate S7, an opposing substrate C2, a liquid crystal layer 715, and a controller 119.

In the present embodiment, as liquid crystal molecules 715a constituting the liquid crystal layer 715, liquid crystal molecules with negative dielectric anisotropy are used.

The patterned substrate S7 is one obtained by replacing the alignment film 114 of the patterned substrate S1 with an alignment film 714 for vertical alignment. The opposing substrate C2 is one obtained by replacing the alignment film 118 of the opposing substrate C1 with an alignment film 718 for vertical alignment.

When no potential difference is generated between the patterned substrate S7 and the opposing substrate C2, the liquid crystal molecules 715a are oriented by the alignment films 714 and 718 such that molecular long axes thereof are parallel to the z-axis direction. Since the liquid crystal molecules 715a are aligned uniformly, a refractive index of the liquid crystal layer 715 also becomes uniform. Accordingly, in this case, the liquid crystal lens 71 is not functioning as a GRIN lens.

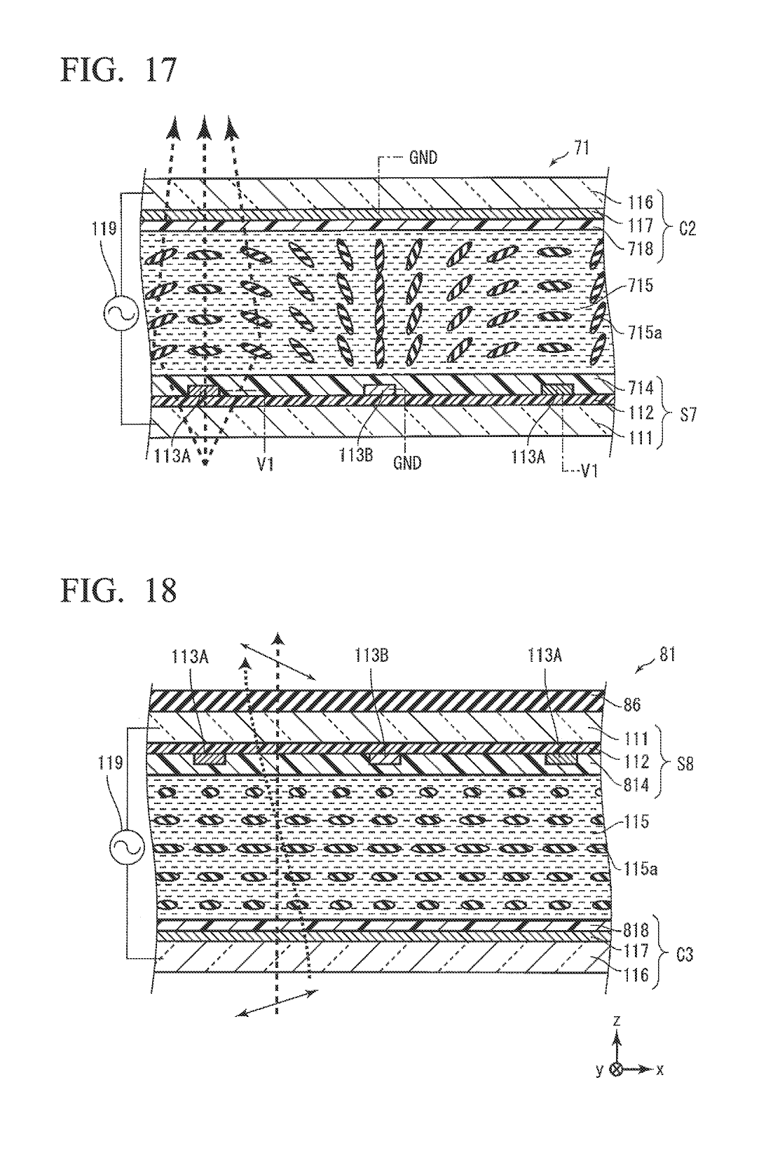

FIG. 17 is a schematic cross-sectional view illustrating operation of the liquid crystal lens 71. In FIG. 17, the controller 119 has controlled potentials of the first electrode 113A, the second electrode 113B, and the common electrode 117 to be the potentials V1, GND, and GND, respectively.

The liquid crystal molecules 715a with the negative dielectric anisotropy are oriented so that the molecular long axes thereof becomes vertical to the electric field generated by the potential difference between the patterned substrate S7 and the opposing substrate C2. A potential difference V1 has been generated between the first electrode 113A and the common electrode 117. Thus, the molecular long axes of the liquid crystal molecules 715a close to the first electrode 113A are oriented perpendicular to the z-direction.

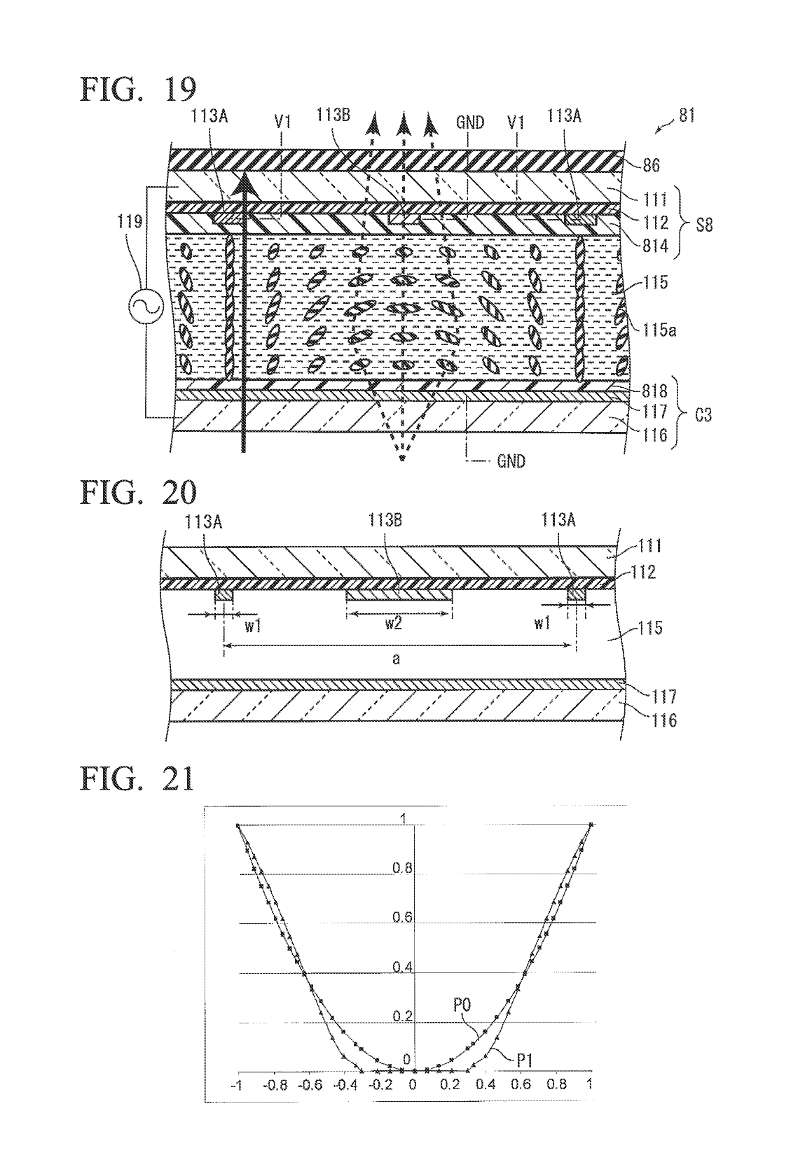

Also in the present embodiment, the high resistance portion 112 electrically connects the first electrode 113A and the second electrode 113B. Accordingly, the potential of the region between the first electrode 113A and the second electrode 113B is changing continuously from the potential V1 to GND. Thus, a potential gradient is formed along the x-direction between the patterned substrate S7 and the opposing substrate C2. According to this potential gradient, the orientation direction of the liquid crystal molecules 715a is also changing. For this reason, the liquid crystal layer 715 has a refractive index distribution in the x-direction. By this refractive index distribution, the liquid crystal layer 715 can condense the light incident on the liquid crystal layer 715, as indicated by dashed arrows shown in FIG. 19. In other words, the liquid crystal lens 71 is functioning as a GRIN lens.

Thus, similarly to the liquid crystal lens 11, the liquid crystal lens 71 can switch the functions of the GRIN lens by the controller 119 controlling the potentials of the first electrode 113A, the second electrode 113B, and the common electrode 117.

Additionally, similarly to the liquid crystal lens 11, it is possible to obtain excellent lens characteristics even when the ratio a/d is large by the presence of the second electrode 113B and the high resistance portion 112.

In the present embodiment, the alignment films 714 and 718 for vertical alignment are used. For this reason, there is no need to perform a rubbing treatment. Thus, it is possible to eliminate the influence of asymmetry due to a rubbing treatment.

### Eighth Embodiment

FIG. 18 is a schematic cross-sectional view showing a schematic configuration of a liquid crystal lens 81 according to an eighth embodiment of the present invention. The liquid crystal lens 81 includes a patterned substrate S8, an opposing substrate C3, a liquid crystal layer 115, a controller 119, and a polarizing plate 86.

The patterned substrate S8 is one obtained by replacing the alignment film 114 of the patterned substrate S1 with an alignment film 814. The direction of the rubbing treatment is different between the alignment film 114 and the alignment film 814. Similarly, the opposing substrate C3 is one obtained by replacing the alignment film 118 of the opposing substrate C1 with an alignment film 818. The direction of the rubbing treatment is different between the alignment film 118 and the alignment film 818.

The alignment film 814 has been rubbed in a direction that forms an angle of approximately 45° with the extending direction of the first electrode 113A (y-direction). The alignment film 818 has been rubbed in a direction substantially perpendicular to the rubbing direction of the alignment film 814.

Thus, when no potential difference is generated between the patterned substrate S8 and the opposing substrate C3, the liquid crystal molecules 115a of the liquid crystal layer 115 are oriented as follows. In other words, the liquid crystal molecules 115a are oriented along the rubbing direction of the alignment layer 814 on the patterned substrate S8 side, and are oriented along the rubbing direction of the alignment layer 818 on the opposing substrate C3 side. Thus, the orientation direction of the liquid crystal molecules 115a is rotated by 90° between the opposing substrate C3 side and the patterned substrate S8 side. In other words, the liquid crystal layer 115 is TN (twisted nematic) liquid crystal.

The liquid crystal lens 71 further includes a polarizing plate 86. The polarizing plate 86 is disposed on a main surface opposite to the liquid crystal layer 115 of the patterned substrate S8. The polarization axis of the polarizing plate 86 is substantially identical to the rubbing direction of the alignment film 814.

Next, operation of the liquid crystal lens 81 will be described. First, by the phase difference plate 12 (FIG. 1), the polarization direction of light emitted from the liquid crystal display 14 is aligned to the rubbing direction of the alignment film 818. Here, it is not necessary to provide the phase difference plate 12, depending on the polarization direction of the light emitted from the liquid crystal display 14.

When no potential difference is generated between the patterned substrate S8 and the opposing substrate C3, the orientation direction of the liquid crystal molecules 115a is rotated as the level in the z-direction increases, as described above. On the other hand, the orientation direction of the liquid crystal molecules 115a is uniform in the xy-plane.

The orientation direction of liquid crystal molecules 115a is uniform in the xy-plane, a refractive index distribution thereof is also uniform in the xy-plane. Accordingly, when no potential difference is generated between the pattern substrate S8 and the opposing substrate C3, the liquid crystal lens 81 is not functioning as a GRIN lens.

As shown in FIG. 18, according to a change in orientation direction of the liquid crystal molecules 115a, the polarization axis of the light incident on the liquid crystal layer 115 changes by 90°. The polarization axis of the polarizing plate 86 is substantially identical to the rubbing direction of the alignment film 814. For this reason, light passing through the liquid crystal layer 115 can pass through the polarizing plate 86.

FIG. 19 is a schematic cross-sectional view illustrating operation of the liquid crystal lens 81. In FIG. 19, the controller 119 has controlled potentials of the first electrode 113A, the second electrode 113B, and the common electrode 117 to be the potentials V1, GND, and GND, respectively.

A potential difference V1 is generated between the first electrode 113A and the common electrode 117. Thus, the molecular long axes of the liquid crystal molecules 115a close to the first electrode 113A are oriented parallel to the z-direction.

Also in the present embodiment, the high resistance portion 112 electrically connects the first electrode 113A and the second electrode 113B. Accordingly, the potential of the region between the first electrode 113A and the second electrode 113B is changing continuously from the potential V1 to GND. Thus, a potential gradient is formed along the x-direction between the patterned substrate S8 and the common electrode C3. According to this potential gradient, the orientation direction of the liquid crystal molecules 115a is also changing. For this reason, the liquid crystal layer 115 has a refractive index distribution in the x-direction. By this refractive index distribution, the liquid crystal layer 115 can condense the light incident on the liquid crystal layer 115, as indicated by dashed arrows shown in FIG. 19. In other words, the liquid crystal lens 81 is functioning as a GRIN lens.

At this time, the light passing through the vicinity of the first electrode 113A passes through the liquid crystal layer 115 without the polarization axis being rotated. For this reason, the light cannot pass through the polarizing plate 86, as indicated by solid arrows shown in FIG. 19. Thus, in the liquid crystal lens 81, a virtual parallax barrier is formed in the boundary region of the virtual lens.

According to the present embodiment, the liquid crystal lens 81 has a function as a parallax barrier, in addition to the function as a GRIN lens. Thus, it is possible to reduce crosstalk in the stereoscopic display.

Thus, the liquid crystal lens 81 can switch between the function as a parallax barrier and the function as a GRIN lens by the controller 119 controlling the potentials of the first electrode 113A, the second electrode 113B, and the common electrode 117.

Similar to the liquid crystal lens 11, it is possible to obtain excellent lens characteristics even when the ratio a/d is large by the presence of the high resistance portion 112 and the second electrode 113B.

In the present embodiment, the polarizing plate 86 is disposed on the patterned substrate S8 side. In this case, in the stereoscopic display apparatus 1 (FIG. 1), the opposing substrate C3 is disposed on the liquid crystal display 14 side. Here, the polarizing plate 86 may be disposed on the opposing substrate C3 side. In this case, in the stereoscopic display apparatus 1, the patterned substrate S8 is disposed on the liquid crystal display 14 side.

The alignment film 814 of the liquid crystal lens 81 has been rubbed in a direction that forms an angle of 45° with the extending direction of the first electrode 113A (y-direction). Additionally, the alignment film 818 has been rubbed in a direction perpendicular to the rubbing direction of the alignment film 814. However, the rubbing directions of the alignment films 814 and 818 are optional as long as those rubbing directions intersect each other.

### [Calculation Example of Lens Characteristics]

A simulation was performed using the configurations of the liquid crystal lens 11 and 81. FIG. 20 is a view showing the arrangement of each component in this simulation. A calculation was performed assuming that an interval a between two adjacent first electrodes 113A is 2.0, the width w1 of the first electrode 113A is 0.1, and the width w2 of the second electrode 113B is 0.6. The calculation was performed assuming that the sheet resistances of the first electrode 113A, the second electrode 113B, and the common electrode 117 are 40 Ω/sq. The calculation was performed assuming that the sheet resistance of the high resistance portion 112 is 40MΩ/sq. The calculation was performed assuming that the refractive index difference Δn of the liquid crystal molecules of the liquid crystal layer 115 is 0.17. The calculation was performed assuming that the potentials of the first electrode 113A, the second electrode 113B, and the common electrode 17 are 2.0V, 0.5V, and 0.0V, respectively.

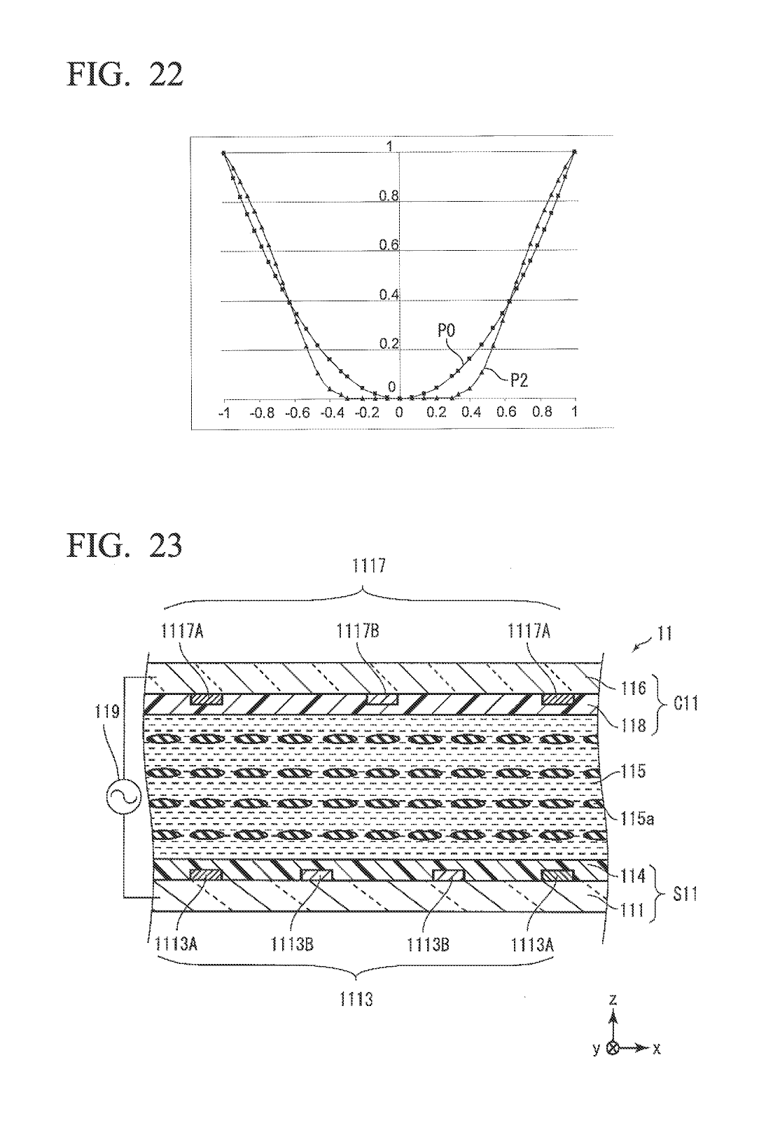

FIGS. 21 and 22 show the results. The horizontal axes shown in FIGS. 21 and 22 represent the distance from the center of the lens. The vertical axes shown in FIGS. 21 and 22 represent a phase difference (normalized value).

FIG. 21 is a graph showing a simulation result P1 and a theoretical curve P0 in the case of the liquid crystal lens 11, that is, in a case where the liquid crystal molecules applied with no voltage were subject to horizontal orientation. A mean square of the difference between the simulation result P1 and the theoretical curve P0 were 0.046.

FIG. 22 is a graph showing a simulation result P2 and a theoretical curve P0 in the case of the liquid crystal lens 81, that is, in a case where the liquid crystal molecules applied with the voltage were subject to TN orientation. A mean square of the difference between the simulation result P2 and the theoretical curve P0 were 0.055.

Thus, the lens characteristics close to the ideal one was obtained by the configuration of the liquid crystal lens 11 or the liquid crystal lens 81.

### Ninth Embodiment

The configuration of the liquid crystal lens 11 will be described in detail. Hereinafter, as shown in FIG. 1, a long-side direction, a short-side direction, and a thickness direction of the liquid crystal lens 11 are referred to as an x-direction, a y-direction, and a z-direction, respectively.

FIG. 23 is a cross-sectional view taken along a line II-II in FIG. 1 and schematically showing the configuration of the liquid crystal lens 11. The liquid crystal lens 11 includes a first substrate S11, a second substrate C11, a liquid crystal layer 115, and a controller 119.

In the present embodiment, as the liquid crystal molecules 115a constituting the liquid crystal layer 115, liquid crystal molecules with positive dielectric anisotropy are used. The liquid crystal molecules 115a have birefringence. In other words, a refractive index nₑ with respect to the light vibrating parallel to the optical axis differs from the refractive index nₒ with respect to light vibrating perpendicular to the optical axis. The liquid crystal molecules 115a having a large value of Δnₙ=nₑ−nₒ is preferred.

As the liquid crystal molecules 115a, a ferroelectric liquid crystal may be used. The ferroelectric liquid crystal has a memory effect. For this reason, once the ferroelectric liquid crystal is oriented by applying an electric field thereto, there is no need to continuously apply the electric field to maintain the orientation. Therefore, it is possible to reduce the power consumption.

The controller 119 controls the first substrate S11 and the second substrate C11, applies the electric field to the liquid crystal layer 115, and thus changes the orientation of the liquid crystal molecules 115a. The controller 119 is disposed in, for example, the non-display region P of the first substrate S11 or the second substrate C11. The controller 119 can be formed monolithically on these substrates by a semiconductor process. Alternatively, the controller 119 can be mounted on these substrates by the COG (chip on glass) technology. The controller 119 may be disposed on a place other than the first substrate S11 and the second substrate C11. In this case, the controller 119 is connected to those substrates via, for example, a FPC (flexible printed circuit).

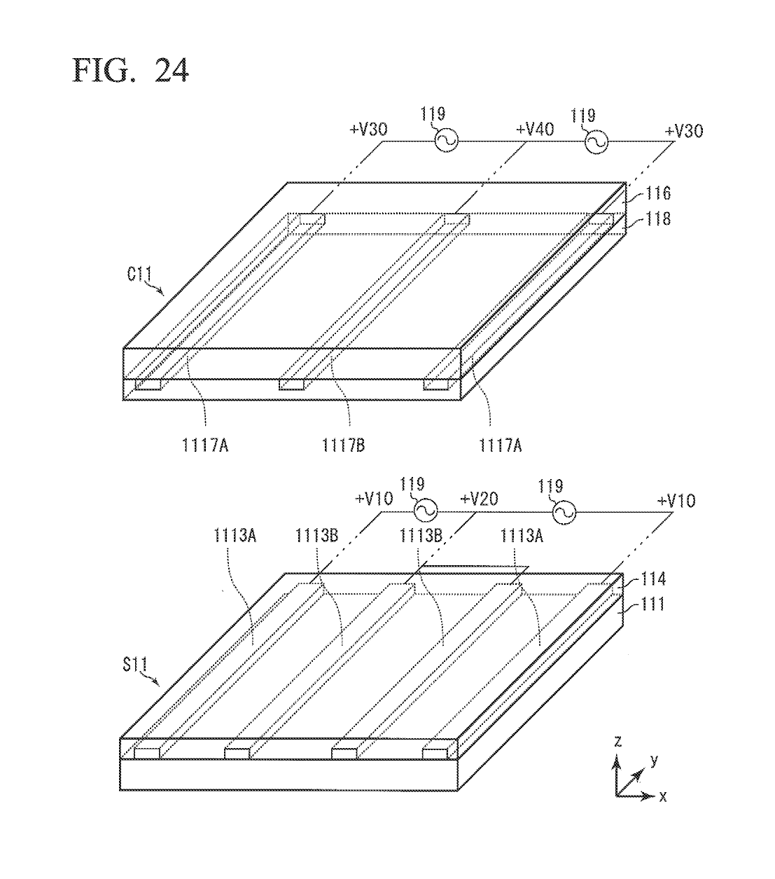

FIG. 24 is a perspective view showing, by extracting from the configuration of the liquid crystal lens 11, a part of the first substrate S11 and the second substrate C11. As shown in FIGS. 23 and 24, the first substrate S11 includes a substrate 111, a first electrode pattern 1113, and an alignment film 114. The second substrate C11 includes a substrate 116, a second electrode pattern 1117, and an alignment film 118.

The substrate 111 and the substrate 116 have light-transmissive and insulating properties. Examples of the substrate 111 and the substrate 116 are glass substrates. Surfaces of the substrate 111 and the substrate 116 may be coated with a passivation film, or the like.

The first electrode pattern 1113 is formed on the substrate 111 so as to include a conductive portion and a non-conductive portion which are repeated in stripes along the x-direction. More specifically, the first electrode pattern 1113 includes electrodes 1113A and electrodes 1113B which are formed at predetermined intervals along the x-direction.

The second electrode pattern 1117 is formed on the substrate 116 so as to include a conductive portion and a non-conductive portion which are repeated in stripes along the x-direction. More specifically, the first electrode pattern 1117 includes electrodes 1117A and electrodes 1117B which are formed at predetermined intervals along the x-direction.

As shown in FIG. 24, each of the electrodes 1113A, 1113B, 1117A, and 1117B is formed elongated so as to extend in the y-direction. The electrodes 1113A, 1113B, 1117A, and 1117B are formed of a light-transmissive conductive material. An example of the electrodes 1113A, 1113B, 1117A, and 1117B is ITO (indium tin oxide) or IZO (indium zinc oxide). The electrodes 1113A, 1113B, 1117A, and 1117B, are deposited by, for example, sputtering or CVD, and are patterned by photolithography.

The electrodes 1113A, 1113B, 1117A, and 1117B are connected to the controller 119 via wires (not shown). The controller 119 independently controls the potentials of the electrodes 1113A, 1113B, 1117A, and 1117B. In FIG. 24, as an example of the applied voltages, the controller 119 has controlled the potentials of the electrodes 1113A, 1113B, 1117A, and 1117B to be the potentials V10, V20, V30, and V40, respectively.

The alignment film 114 is formed so as to cover the substrate 111 and the electrodes 1113A and 1113B. The alignment film 118 is formed so as to cover the substrate 116 and the electrodes 1117A and 1117B. For example, the alignment films 114 and 118 are polyimide, which is formed by a printing method.

In the present embodiment, the alignment films 114 and 118 have been rubbed in a direction substantially parallel with the x-direction (rubbing treatment). As a result, the liquid crystal molecules 115a are oriented in the x-direction when no potential difference is generated between the first substrate S11 and the second substrate C11.

The liquid crystal lens 11 is manufactured by superimposing the first substrate S11 and the second substrate C11, sealing a periphery portion, and injecting liquid crystal into the gap.

In the present embodiment, the electrodes 1113A and 1117A are arranged by aligning the center positions in the x-direction thereof to each other. On the other hand, the electrodes 1113B and 1117B are arranged by shifting the center positions in the x-direction thereof from each other.

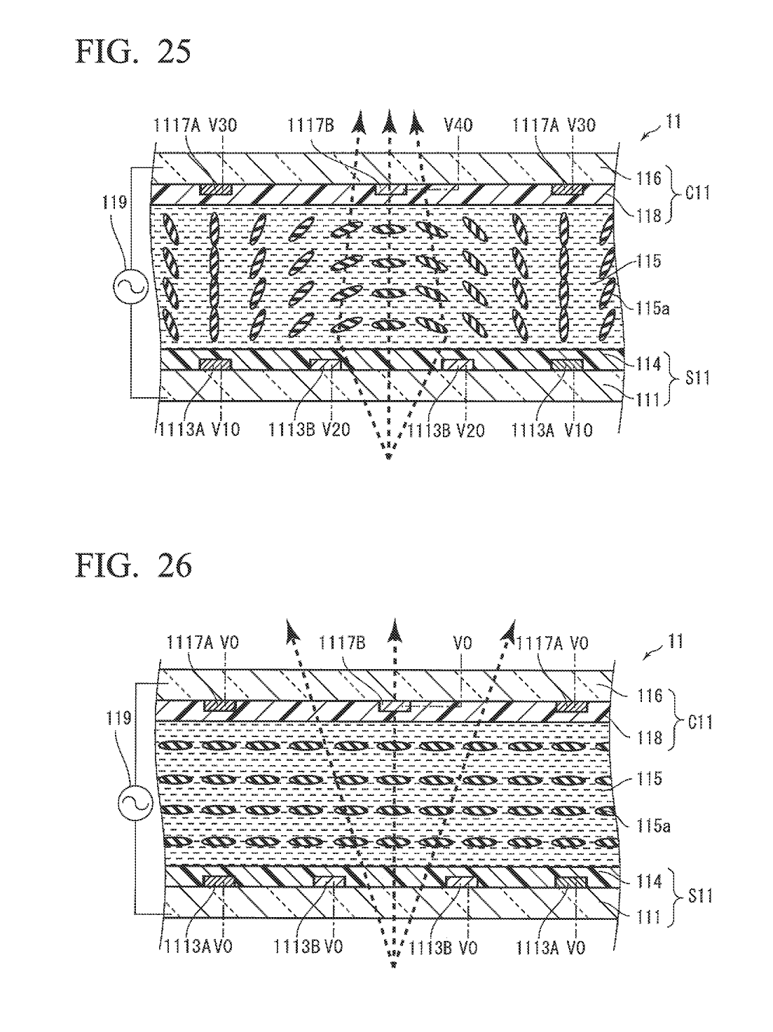

Next, operation of the liquid crystal lens 11 will be described with reference to FIGS. 25 and 26.

FIG. 25 is a schematic cross-sectional view showing the liquid crystal lens 11 in one mode. In FIG. 25, the controller 119 has controlled the potentials of the electrodes 1113A, 1113B, 1117A, and 1117B to be V10, V20, V30, and V40, respectively.

In the present embodiment, the potentials of the electrodes 1113A, 1113B, 1117A, and 1117B are controlled to meet the condition that V10>V20>V40>V30.

The liquid crystal molecules 115a are oriented so that the molecular long axes thereof become parallel to the electric field generated by the potential difference between the first substrate S11 and the second substrate C11. A potential difference (V10-V30) is generated between the electrodes 1113A and 1117A. Thus, the molecular long axes of the liquid crystal molecules 115a close to the first electrode 1113A are oriented parallel to the z-direction.

In the present embodiment, the position and width of the electrodes 1113A, 1113B, 1117A, and 1117B, and the respective potentials V10, V20, V30, and V40 thereof are adjusted so that the potential difference between the first substrate S11 and the second substrate C11 becomes smallest at a middle position between two adjacent electrodes 1113A.

Thus, the orientation direction of the liquid crystal molecules 115a is continuously changing along the x-direction, from the z-direction to the x-direction.

According to a change in orientation direction of the liquid crystal molecules 115a, a refractive index of the liquid crystal layer 115 changes. For this reason, the liquid crystal layer 115 has a refractive index distribution in the x-direction. By this refractive index distribution, the liquid crystal layer 115 can condense the light incident on the liquid crystal layer 115, as indicated by dashed arrows shown in FIG. 25. In other words, the liquid crystal lens 11 in this mode is functioning as a GRIN lens.

FIG. 26 is a schematic cross-sectional view of the liquid crystal lens 11 in another mode. In FIG. 26, the controller 119 has controlled the potentials of the electrode 1113A, 1113B, 1117A, and 1117B to be V0. For this reason, no potential difference is generated between the first substrate S11 and the second substrate C11. The liquid crystal molecules 115a are oriented by the alignment films 114 and 118 so that the molecular long axes thereof become parallel to the x-direction.

Since the liquid crystal molecules 115a are aligned uniformly, a refractive index of the liquid crystal layer 115 has also become uniform. As indicated by the dashed arrows shown in FIG. 26, most of the light incident on the liquid crystal layer 115 passes through as it is. In other words, the liquid crystal lens 11 in this operation mode is not functioning as a GRIN lens.

Thus, the liquid crystal lens 11 can switch the functions of the GRIN lens by the controller 119 controlling the potentials of the electrodes 1113A, 1113B, 1117A, and 1117B using.

### Comparative Example

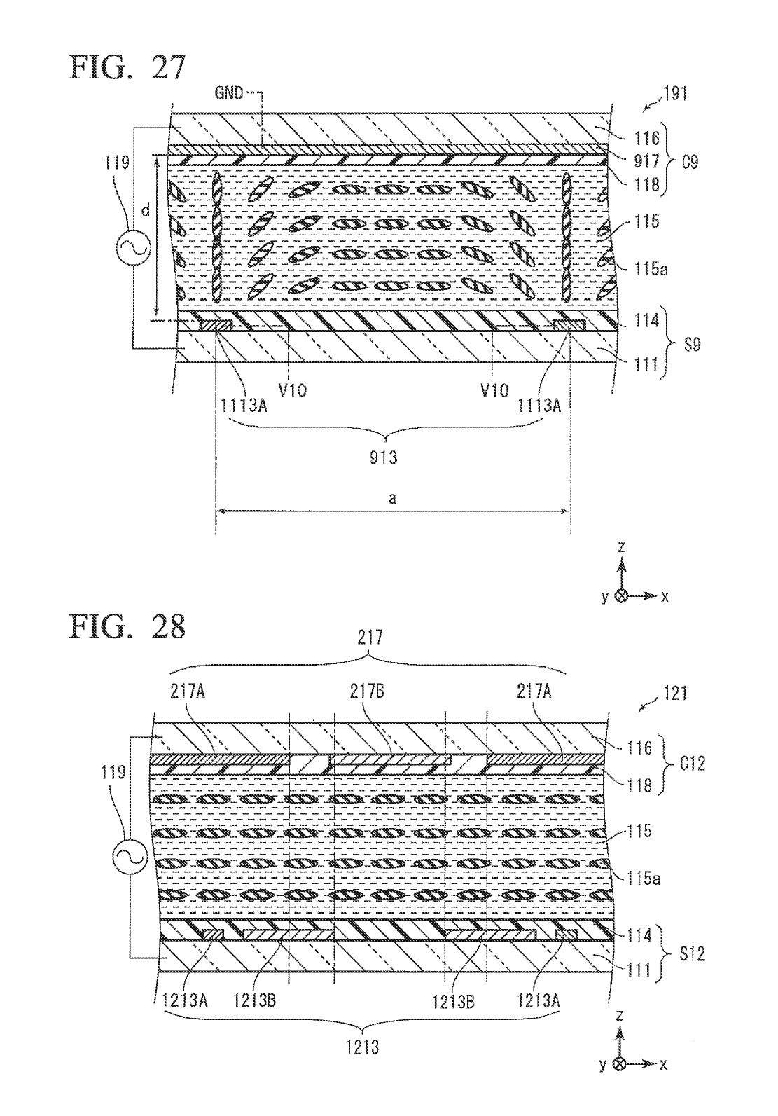

FIG. 27 is a schematic cross-sectional view showing a liquid crystal lens 191 according a hypothetical comparative example to explain the effects of the present embodiment. The liquid crystal lens 191 includes a first substrate S9 in lieu of the first substrate S11, and a second substrate C9 in lieu of the second substrate C11.

The first substrate S9 includes an electrode pattern 913, in lieu of the first electrode pattern 1113 of the first substrate S11. The electrode pattern 913 is one obtained by excluding the electrode 1113B from the configuration of the first electrode pattern 1113.

The second substrate C9 includes a common electrode 917, in lieu of the second electrode patterns 1117 of the second substrate C11. The common electrode 917 is formed on the substrate 116 as a uniform film.

In FIG. 27, the controller 119 has controlled the potentials of the electrode 1113A and the common electrode 917 to be a potential V10 and a ground potential (GND), respectively. A potential difference V10 has been generated between the electrode 1113A and the common electrode 917. Thus, the molecular long axes of the liquid crystal molecules 115a close to the electrode 1113A are oriented parallel to the z-direction.

However, in the liquid crystal lens 191, a potential gradient is not formed in an intermediate region between two adjacent electrodes 1113A. In this region, the orientation direction of the liquid crystal molecules 115a have not almost changed. For this reason, an effective refractive index distribution cannot be obtained, and therefore excellent lens characteristics cannot be obtained.

Such a problem arises when a value of an interval a between two adjacent electrodes 1113A is large in comparison with a distance d between the electrode 1113A and the common electrode 917. If the ratio a/d is approximately 7 or more, the liquid crystal lens 191 does not function as a GRIN lens.

With reference to FIG. 25 again, the effects of the present embodiment will be described. In the present embodiment, electrode patterns are formed not only on the first substrate S11, but also on the second substrate C11. This, the electric field becomes easily applied to the xy-plane.

The configuration and effect of the liquid crystal lens 11 according to the ninth embodiment have been described above. According to the present embodiment, it is possible to obtain excellent lens characteristics even when the ratio a/d is large.

In the present embodiment, the first electrode pattern 1113 includes the electrodes 1113A and 1113B. Additionally, the second electrode pattern 1117 includes the electrodes 1117A and 1117B. Then, the electrodes 1113A, 1113B, 1117A, and 1117B are independently controlled by the controller 119. However, it is optional how many types of independent electrodes each of the first electrode pattern 1113 and the second electrode pattern 1117 includes. For example, any one or both of the first electrode pattern 1113 and the second electrode pattern 1117 may be constituted by one type of electrodes. Additionally, the first electrode pattern 1113 and the second electrode pattern 1117 may include three or more types of independent electrodes.

However, as will be described later, it is preferable that the controller 119 controls, based on four or more potential levels in total, the potentials of electrodes on the first electrode substrate S11 side and the potentials of electrodes on the second electrode substrate C11 side.

In the present embodiment, the electrodes 1113A and 1117A are arranged by aligning the center positions in the x-direction thereof to one another. On the other hand, the electrodes 1113B and 1117B are arranged by shifting the center positions in the x-direction thereof from one another. However, this arrangement is illustrative. The electrodes 1113B and 1117B may be arranged by shifting the center positions in the x-direction thereof from one another. Alternatively, the electrodes 1113B and 1117B may be arranged by aligning the center positions in the x-direction thereof to one another.

However, it is possible to reduce the number of electrodes required to form an electric field in the in-plane direction by arranging the electrodes by shifting the center positions of at least one pair of electrodes from each other.

In the present embodiment, the potentials of the electrodes 1113A, 1113B, 1117A, and 1117B are controlled so as to meet the condition that V10>V20>V40>V30. However, this is illustrative. The values of V10, V20, V30, and V40, and the positions and widths of the electrodes 1113A, 1113B, 1117A, and 1117B, are adjusted in accordance with the lens characteristics. This will be described later along with specific examples.

The liquid crystal lens 11 may be configured such that, in the stereoscopic display apparatus 1 (FIG. 1), the first substrate S11 is disposed on the liquid crystal display 14 side, or the second substrate C11 is disposed on the liquid crystal display 14 side.

The alignment films 114 and 118 of the liquid crystal lens 11 has been rubbed in a direction (x-direction) substantially perpendicular to the extending direction (y direction) of the electrodes 1113A, 1113B, 1117A, and 1117B. However, the rubbing direction of the alignment film is optional. For example, the alignment films 114 and 118 may be rubbed in a direction parallel to the y-direction.

### Embodiment 10

The stereoscopic display apparatus 1 may include, in lieu of the liquid crystal lens 11, any one of liquid crystal lens 121, 131, and 141 described below.

FIG. 28 is a schematic cross-sectional view showing a schematic configuration of the liquid crystal lens 121 according to a tenth embodiment of the present invention. The liquid crystal lens 121 includes a first substrate S12 in lieu of the first substrate S11, and a second substrate C12 in lieu of the second substrate C11.

The first substrate S12 includes a first electrode pattern 1213, in lieu of the first electrode pattern 1113 on the first substrate S11. The second substrate C12 includes a second electrode pattern 217, in lieu of the second electrode pattern 1117 on the second substrate C11.

Similar to the first electrode pattern 1113 and the second electrode pattern 1117, the first electrode pattern 1213 and the second electrode patterns 217 are formed such that a conductive portion and a non-conductive portion are repeated in stripes along the x-direction. The first electrode pattern 1213 includes electrodes 1213A and electrodes 1213B. The second electrode pattern 217 includes electrodes 217A and electrodes 217B.

In the liquid crystal lens 121, the electrodes 1213A, 1213B, 217A, and 217B are formed respectively with the different widths in the x-direction.

In the liquid crystal lens 121, as indicated by one-dot chain lines shown in FIG. 28, a non-conductive portion of the first electrode pattern 1213 and a non-conductive portion of the second electrode pattern 217 are not opposed to each other. In other words, over substantially the entire display region D of the liquid crystal lens 121 (FIG. 1), a conductive portion (at least one of electrodes 1213A, 1213B, 217A, and 217B) is formed on at least one of the first substrate S12 and the second substrate C12.

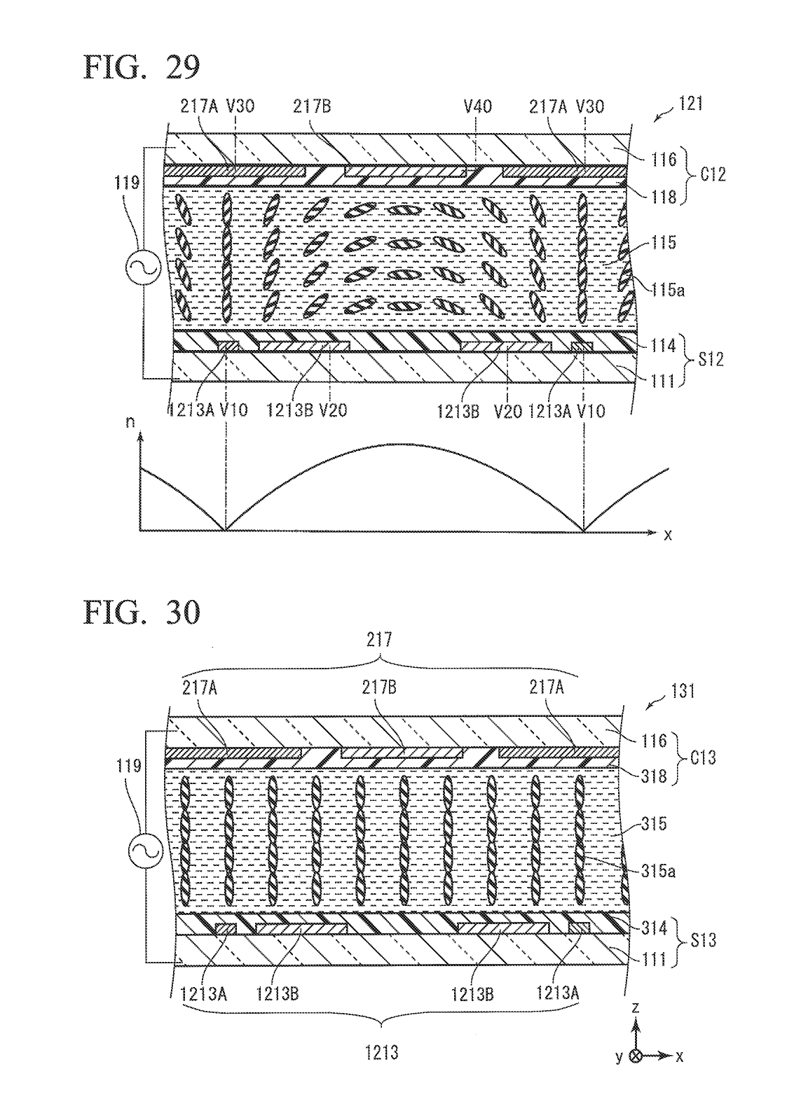

Next, the effects of the present embodiment will be described with reference to FIG. 29. FIG. 29 is a schematic cross-sectional view illustrating the effects of the liquid crystal lens 121. FIG. 29 shows a case where the potentials of the electrodes 1213A, 1213B, 217A, and 217B are controlled to be V10, V20, V30, and V40, respectively. FIG. 29 also shows a schematic refractive index of the liquid crystal layer 115 along the x-direction.

Similar to the ninth embodiment, also in the present embodiment, it is possible to switch the functions of a GRIN lens by the controller 119 controlling the potentials of the electrodes 1213A, 1213B, 217A, and 217B. Additionally, an electrode pattern is formed not only on the first substrate S12, but also on the second substrate C12. Thus, the electric field becomes easily applied to the xy-plane. Accordingly, it is possible to obtain excellent lens characteristics even when the ratio a/d is large.

In the present embodiment, the non-conductive portion of the first electrode pattern 1213 and the non-conductive portion of the second electrode pattern 217 are not opposed to each other. As a result, the electric field is more easily applied to the xy-plane. For this reason, it is possible to further reduce the number of potentials necessary to obtain an effective refractive index distribution.

A refractive index distribution of the ideal GRIN lens becomes a quadratic curve as shown in FIG. 29. For this reason, a change in refractive index of the end portion of the lens is steeper than a change in refractive index of the center of the lens. Accordingly, in order to obtain lens characteristics close to those of the ideal GRIN lens, it is preferable to make the potential gradient in the end portion of the lens be steeper than the potential gradient at the center of the lens.

For this reason, it is preferable that the width in the x-direction of the first electrode pattern 1213 or the second electrode pattern 217 is formed narrower in a portion having a relatively large potential difference between the first substrate S12 and the second substrate C12, in comparison with a portion having a relatively small potential difference between the first substrate S12 and the second substrate C12. For example, in the present embodiment, the width in the x-direction of the electrode 1213A is formed narrower in comparison with the width in the x-direction of the electrodes 1213B, 217A, and 217B.

In the present embodiment, it is optional how many types of independent electrodes each of the first electrode pattern 1213 and the second electrode pattern 217 includes. Additionally, the electrodes 1213A and the electrodes 217A may be arranged by shifting the center positions in the x-direction thereof from one another. Alternatively, the electrodes 1213B and the electrodes 217B may be arranged by aligning the center positions in the x-direction thereof to one another.

### Embodiment 11

FIG. 30 is a schematic cross-sectional view showing a schematic configuration of a liquid crystal lens 131 according to an eleventh embodiment of the present invention. The liquid crystal lens 131 includes a first substrate S13, a second substrate C13, a liquid crystal layer 315, and a controller 119.

In the present embodiment, as the liquid crystal molecules 315a constituting the liquid crystal layer 315, liquid crystal molecules with negative dielectric anisotropy are used.

The first substrate S13 is one obtained by replacing the alignment film 114 of the first substrate S12 with an alignment film 314 for vertical alignment. The second substrate C13 is one obtained by replacing the alignment film 118 of the second substrate C12 with an alignment film 318 for vertical alignment.

The liquid crystal molecules 315a are oriented by the alignment films 314 and 318 so that molecular long axes thereof become parallel to the z-axis direction when no potential difference is generated between the first substrate S13 and the second substrate C13. Since the liquid crystal molecules 315a are aligned uniformly, a refractive index of the liquid crystal layer 315 becomes uniform. Accordingly, in this case, the liquid crystal lens 131 is not functioning as a GRIN lens.

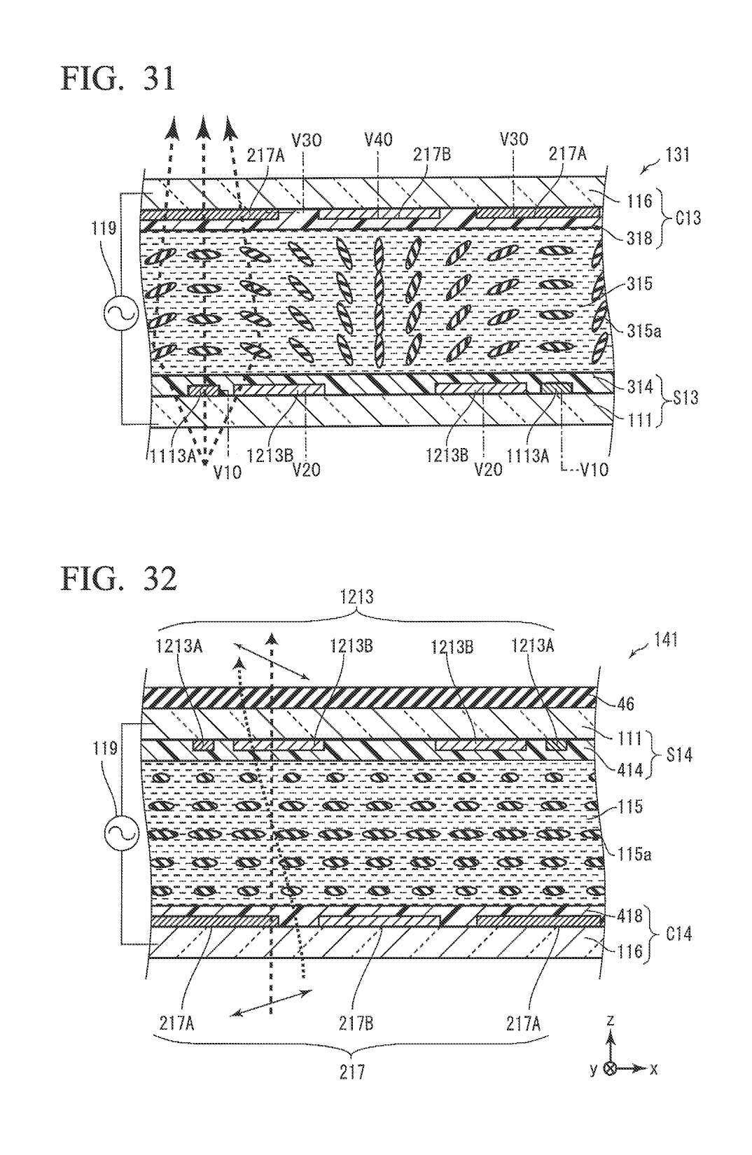

FIG. 31 is a schematic cross-sectional view illustrating operation of the liquid crystal lens 131. In FIG. 31, the controller 119 has controlled the potentials of the electrodes 1213A, 1213B, 217A, and 217B to V10, V20, V30, and V40, respectively.

The liquid crystal molecules 315a with the negative dielectric anisotropy are oriented so that the molecular long axes thereof become vertical to the electric field generated by the potential difference between the first substrate S13 and the second substrate C13. A potential difference (V10-V30) is being generated between the electrode 1213A and the electrode 217A. Thus, the molecular long axes of the liquid crystal molecules 315a close to the electrode 213A are oriented in a direction perpendicular to the z-direction.

Also in the present embodiment, the positions and widths of electrodes 1213A, 1213B, 217A, and 217B, and the potentials V10, V20, V30, and V40 thereof are adjusted so that a potential difference between the first substrate S13 and the second substrate C13 becomes smallest at a middle position between two adjacent electrodes 1213A. Thus, the orientation direction of the liquid crystal molecules 315a is continuously changing along the x-direction, from the x-direction to the z-direction.

For this reason, the liquid crystal layer 315 has a refractive index distribution in the x-direction. By this refractive index distribution, the liquid crystal layer 315 can condense the light incident on the liquid crystal layer 315, as indicated by dashed arrows shown in FIG. 31. In other words, the liquid crystal lens 131 is functioning as a GRIN lens.

Thus, similar to the liquid crystal lens 11, the liquid crystal lens 131 can switch the functions of the GRIN lens by the controller 119 controlling the potentials of electrodes 1213A, 1213B, 217A, and 217B.

Additionally, similarly to the liquid crystal lens 11, electrode patterns are formed not only on the first substrate S13, but also on the second substrate C13. Thus, the electric field becomes easily applied to the xy-plane. Accordingly, it is possible to obtain excellent lens characteristics even when the ratio a/d is large.

In the present embodiment, the alignment films 314 and 318 for vertical alignment are used. For this reason, there is no need to perform a rubbing treatment. Thus, it is possible to eliminate the influence of asymmetry due to the rubbing treatment.

### Twelfth Embodiment

FIG. 32 is a schematic cross-sectional view showing a schematic configuration of a liquid crystal lens 141 according to the twelfth embodiment of the present invention. The liquid crystal lens 141 includes a first substrate S14, a second substrate C14, a liquid crystal layer 115, a controller 119, and a polarizing plate 46.

The first substrate S14 is one obtained by replacing the alignment film 114 of the first substrate S12 with an alignment film 414. The directions of the rubbing treatments performed on the alignment film 114 and the alignment film 414 are different. Similarly, the second substrate C14 is one obtained by replacing the alignment film 118 of the second substrate C12 with an alignment film 418. The directions of the rubbing treatments performed on the alignment film 118 and the alignment film 418 are different.

The alignment film 414 has been rubbed in a direction that forms an angle of approximately 45° with the extending direction (y-direction) of the electrodes 1113A. The alignment film 418 has been rubbed in a direction substantially perpendicular to the rubbing direction of the alignment film 414.

Thus, when no potential difference is generated between the first substrate S14 and the second substrate C14, the liquid crystal molecules 115a of the liquid crystal layer 115 are oriented as follows. In other words, the liquid crystal molecules 115a are oriented along the rubbing direction of the alignment layer 414 on the first substrate S14 side. Additionally, the liquid crystal molecules 115a are oriented along the rubbing direction of the alignment layer 418 on the second substrate C14 side. Thus, the orientation direction of the liquid crystal molecules 115a is rotated by 90° between the first substrate side S14 and the second substrate C14 side. In other words, the liquid crystal layer 115 is TN (twisted nematic) liquid crystal.

The liquid crystal lens 141 further includes a polarizing plate 46. The polarizing plate 46 is disposed on a main surface of the first substrate S14 opposite to the liquid crystal layer 115. The polarization axis of the polarizing plate 46 is substantially identical to the rubbing direction of the alignment film 414.

Next, operation of the liquid crystal lens 141 will be described. First, by the phase difference plate 12 (FIG. 1), a polarization direction of light emitted from the liquid crystal display 14 is aligned to the rubbing direction of the alignment film 418. It is not necessary to provide the phase difference plate 12, depending on the polarization direction of the light emitted from the liquid crystal display 14.

When no potential difference is generated between the first substrate S14 and the second substrate C14, the orientation direction of the liquid crystal molecules 115a further rotates as the level in the z-direction increases, as described above. On the other hand, the orientation direction of the liquid crystal molecules 115a is uniform in the xy-plane.

Since the orientation direction of the liquid crystal molecules 115a is uniform in the xy-plane, a refractive index distribution thereof is also uniform in the xy-plane. Accordingly, when no potential difference is generated between the substrate S14 and the substrate C14, the liquid crystal lens 141 is not functioning as a GRIN lens.

As shown in FIG. 32, according to a change in the orientation direction of the liquid crystal molecules 115a, the polarization axis of the light incident on the liquid crystal layer 115 changes by 90°. The polarization axis of the polarizing plate 46 is substantially identical to the rubbing direction of the alignment film 414. For this reason, light passing through the liquid crystal layer 115 can pass through the polarizing plate 46.

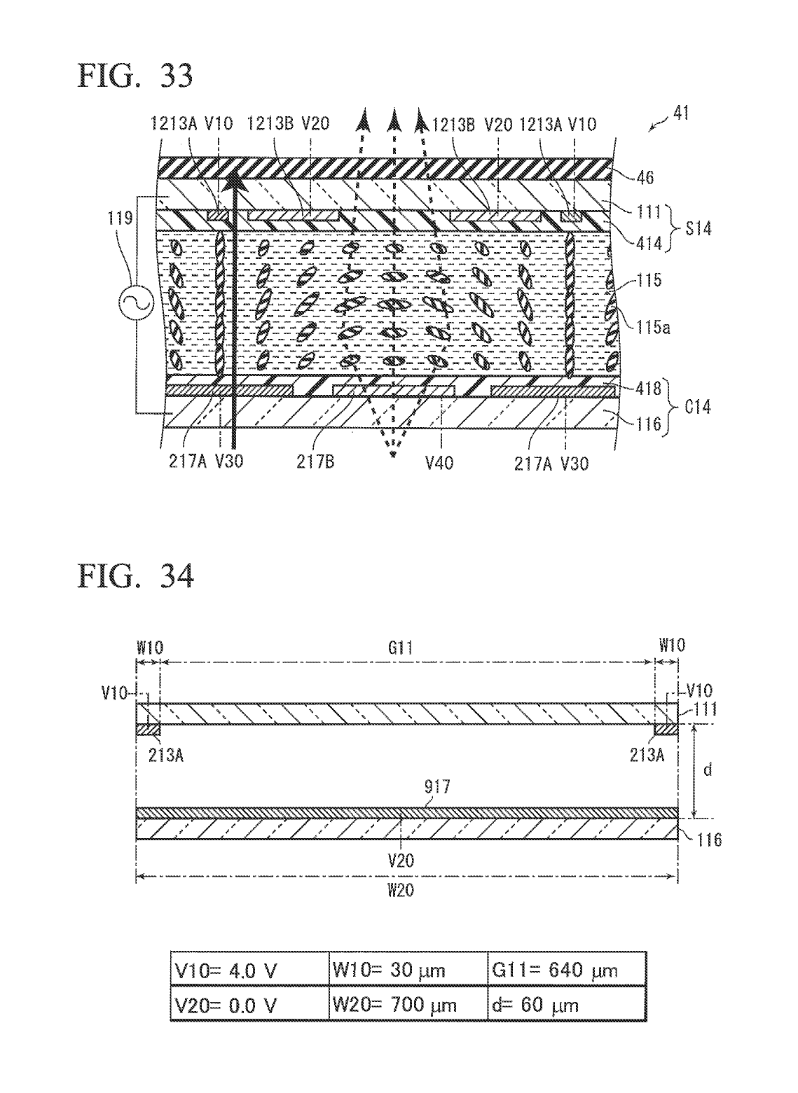

FIG. 33 is a schematic cross-sectional view illustrating operation of the liquid crystal lens 141. In FIG. 33, the controller 119 has controlled the potentials of the electrodes 1213A, 1213B, 217A, and 217B to V10, V20, V30, and V40, respectively.

A potential difference (V10-V30) is generated between the electrode 1213A and the electrode 217A. Thus, the molecular long axes of the liquid crystal molecules 115a close to the electrode 213A are oriented parallel to the z-direction.

Also in the present embodiment, the positions and widths of the electrodes 1213A, 1213B, 217A, and 217B, and the potentials V10, V20, V30, and V40 thereof are adjusted so that the potential difference between the first electrode S14 and the second substrate C14 becomes smallest at a middle position between two adjacent electrodes 1213A. Thus, the orientation direction of the liquid crystal molecules 115a is continuously changing along the x-direction, from the z-direction to the x-direction.

For this reason, the liquid crystal layer 115 has a refractive index distribution in the x-direction. By this refractive index distribution, the liquid crystal layer 115 can condense the light incident on the liquid crystal layer 115, as indicated by dashed arrows shown in FIG. 33. In other words, the liquid crystal lens 141 is functioning as a GRIN lens.

At this time, the light passing through the vicinity of the electrode 213A passes through the liquid crystal layer 115 without the polarization axis being rotated. For this reason, the light cannot pass through the polarizing plate 46, as indicated by solid arrows shown in FIG. 33. Thus, the liquid crystal lens 141 forms a virtual parallax barrier in a boundary region of the virtual lens.

According to the present embodiment, the liquid crystal lens 141 has a function as a parallax barrier, in addition to the function as a GRIN lens. Thus, it is possible to reduce crosstalk in the stereoscopic display.

Thus, the liquid crystal lens 141 can switch the functions as the GRIN lens and the parallax barrier by the controller 119 controlling the potentials of the electrodes 1213A, 1213B, 217A, and 217B.

Additionally, similarly to the liquid crystal lens 11, electrode patterns are formed not only on the first substrate S14, but also on the second substrate C14. Thus, an electric field becomes easily applied to the xy-plane. Therefore, it is possible to obtain excellent lens characteristics even when the ratio a/d is large.

In the present embodiment, the polarizing plate 46 is disposed on the first substrate S14 side. In this case, in the stereoscopic display apparatus 1 (FIG. 1), the second substrate C14 is disposed on the liquid crystal display 14 side. Here, the polarizing plate 46 may be disposed on the second substrate C14 side. In this case, in the stereoscopic display apparatus 1, the first substrate S14 is disposed on the liquid crystal display 14 side.

The alignment film 414 of the liquid crystal lens 141 has been rubbed in a direction that forms an angle of 45° with the extending direction (y-direction) of the electrodes 1113A. Additionally, the alignment film 418 has been rubbed in a direction perpendicular to the rubbing direction of the alignment film 414. However, the rubbing directions of the alignment films 414 and 418 are optional as long as the rubbing directions intersect each other.

### [Calculation Example of Lens Characteristics]

Hereinafter, a calculation example of lens characteristics will be described with reference to FIGS. 34 to 41. A simulation of the lens characteristics was performed while changing the number of potentials. FIGS. 34, 36, 38, and 40 are diagrams and charts showing the arrangement and potential of each component in the simulation. FIGS. 35, 37, 39, and 41 are graphs showing results of the simulation where a horizontal axis represents a distance (μm) from the center of the lens, and a vertical axis represents a phase difference (wave number).

FIGS. 34, 36, 38, and 40 show, by extracting, only related configurations. The calculation was performed assuming that the liquid crystal molecules of the liquid crystal layer are subjected to TN orientation when no potential difference is generated between the first substrate 111 and the second substrate 116. In any case, calculation was performed assuming that an interval between the electrodes (pitch) is 700 μm. Additionally, calculation was performed assuming that a distance d between the first substrate 111 and the second substrate 116 (approximately equal to the distance between the electrode on the first electrode substrate 111 and the electrode on the second substrate 116) is 60 μm. The ratio a/d was 11.66, thus exceeding 7.0.

In FIG. 34, the electrodes 213A were arranged on the first substrate 111, and the common electrode 917 was disposed on the second substrate 116. Then, the potentials of the electrode 213A and the common electrode 917 were respectively controlled to be two potential levels, V10 and V20, thus forming a potential gradient. Here, W10 is the half width of the electrode 213A, and G11 is an interval between two adjacent electrodes 213A. Thus, the electrode pattern including the conductive portion and the non-conductive portion which are repeated in stripes was disposed on the first substrate 111, and the uniform common electrode 917 was disposed on the second substrate 116, and then calculation was performed.

FIG. 35 is a graph showing a potential simulation result P2 in the case of two potential levels, and a theoretical curve P0. Since the ratio a/d exceeds 7.0, it can be found that an effective refractive index distribution cannot be obtained at a point close to the center between two adjacent electrodes 213A. A mean square of the difference between the simulation result P2 and the theoretical curve P0 was 1.88.

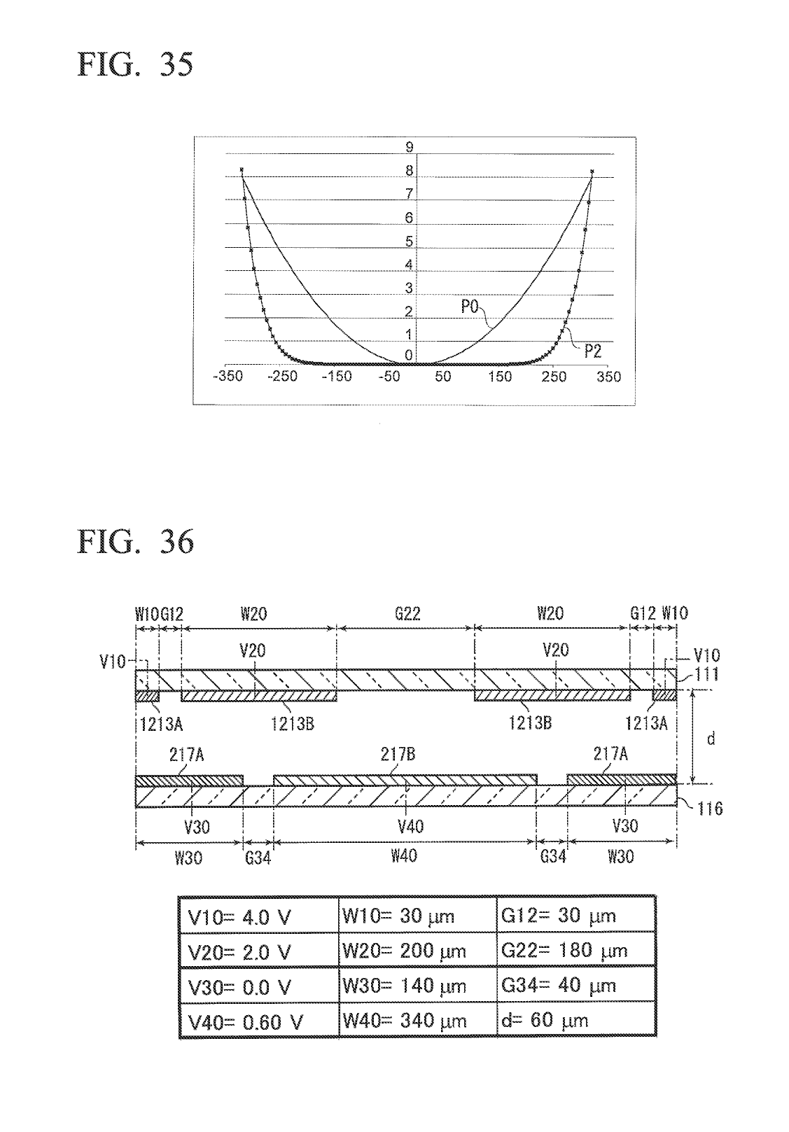

In FIG. 36, the electrodes 1213A and 1213B were arranged on the first substrate 111, and the electrodes 217A and 217B were arranged on the second substrate 116. Then, the potentials of the electrodes 1213A, 1213B, 217A, and 217B were respectively controlled to be four potential levels, V10, V20, V30, and V40, thus forming a potential gradient. Here, W10 is the half width of the electrode 1213A. W20 is the width of the electrode 1213B. W30 is the half width of the electrode 217A. W40 is the width of the electrode 217B. G12 is a distance between the electrode 1213A and the electrode 1213B. G22 is an interval between two adjacent electrodes 1213B. G34 is a distance between the electrode 217A and the electrode 217B. Thus, an electrode patterns including the conductive portion and the non-conductive portion which are repeated in stripes is disposed on both the first substrate 111 and the second substrate 116, and then calculation was performed.

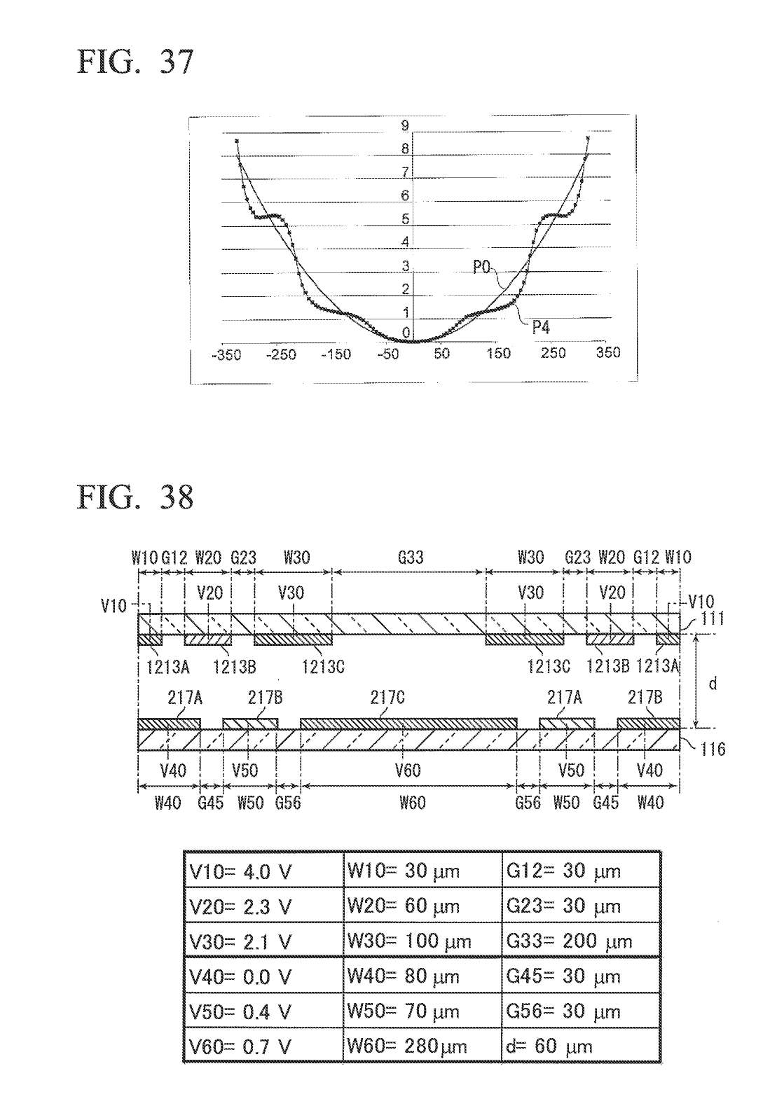

FIG. 37 is a graph showing a simulation result P4 in the case of four potential levels, and a theoretical curve P0. A mean square of the difference between the simulation result P4 and the theoretical curve P0 was 0.40.

In FIG. 38, the electrodes 1213A, 1213B, and 1213C were arranged on the first substrate 111, and the electrodes 217A, 217B, and 217C were arranged on the second substrate 116. Then, the potentials of the electrodes 1213A, 1213B, 1213C, 217A, 217B, and 217C were respectively controlled to be six potential levels, V10, V20, V30, V40, V50, and V60, thus forming a potential gradient. Here, W10 is the half width of the electrodes 1213A. W20 is the width of the electrode 1213B. W30 is the width of the electrode 1213C. W40 is the half width of the electrode 217A. W50 is the width of the electrode 217B. W60 is the width of the electrode 217C. G12 is the distance between the electrode 1213A and the electrode 1213B. G23 is the distance between the electrode 1213B and the electrode 1213C. G33 is the interval between two adjacent electrodes 1213C. G45 is the distance between the electrode 217A and the electrode 217B. G56 is the distance between the electrode 217B and the electrode 217C. Thus, the electrode pattern including the non-conductive portion and the conductive portion which are repeated in stripes was disposed on both the first substrate 111 and the second substrate 116, and then calculation was performed.

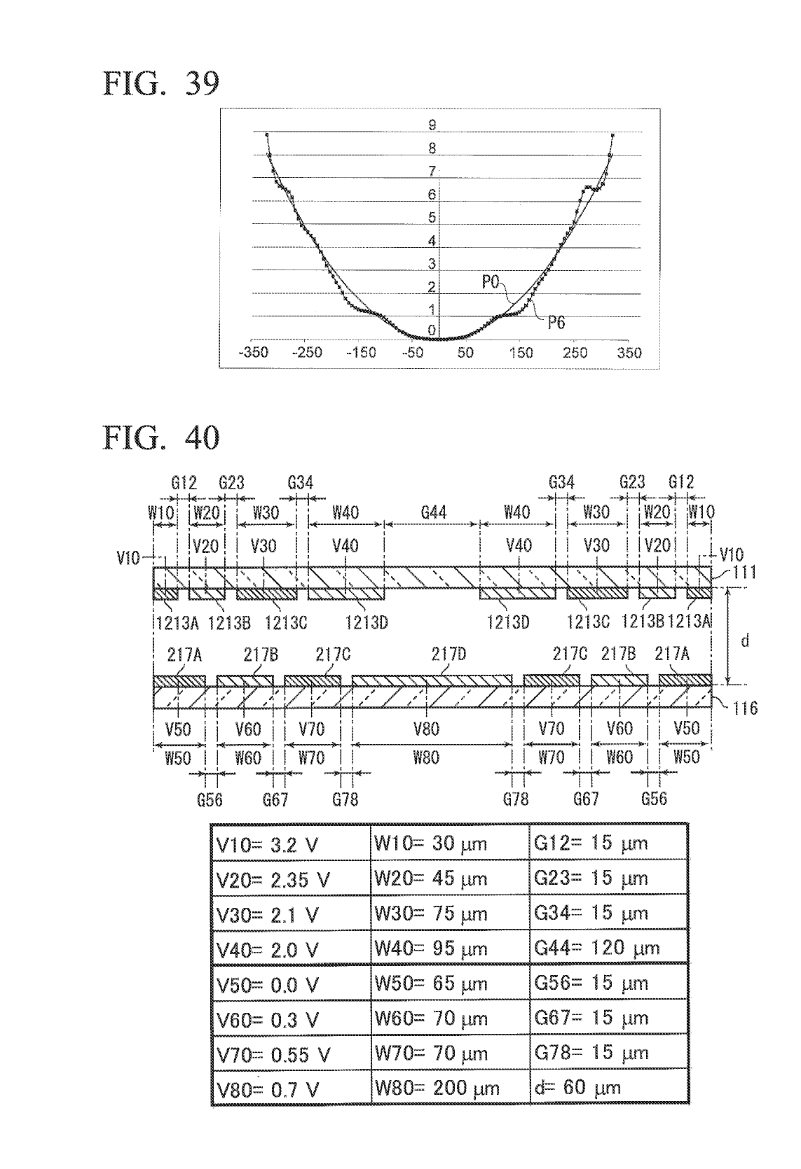

FIG. 39 is a graph showing a simulation result P6 in the case of the six potential levels, and a theoretical curve P0. A mean square of the difference between the simulation result P6 and the theoretical curve P0 was 0.21.

In FIG. 40, the electrode 1213A, 1213B, 1213C, and 1213D were on the first substrate 111, and the electrodes 217A, 217B, 217C, and 217D were arranged on the second substrate 116. Then, the potentials of the electrode 213A, 213B, 213C, 213D, 217A, 217B, 217C, and 217D were respectively controlled to be 8 potential levels, V10, V20, V30, V40, V50, V60, V70, and V8, thus forming a potential gradient. Here, W10 is the half width of the electrode 1213A. W20 is the width of the electrode 1213B. W30 is the width of the electrode 1213C. W40 is the width of the electrode 1213D. W50 is the half width of the electrode 217A. W60 is the width of the electrode 217B. W70 is the width of the electrode 217C. W80 is the width of the electrode 217D. G12 is the distance between the electrode 1213A and the electrode 1213B. G23 is the distance between the electrode 1213B and the electrode 1213C. G34 is the distance between the electrode 1213C and the electrode 1214D. G44 is the interval between two adjacent electrodes 1213D. G56 is the distance between the electrode 217A and the electrode 217B. G67 is the distance between the electrode 217B and the electrode 217C. G78 is the distance between the electrode 217C and the electrode 217D. Thus, the electrode pattern including the conductive portion and the non-conductive portion which are repeated in stripes was disposed on both the first substrate 111 and the second substrate 116, and then calculation was performed.

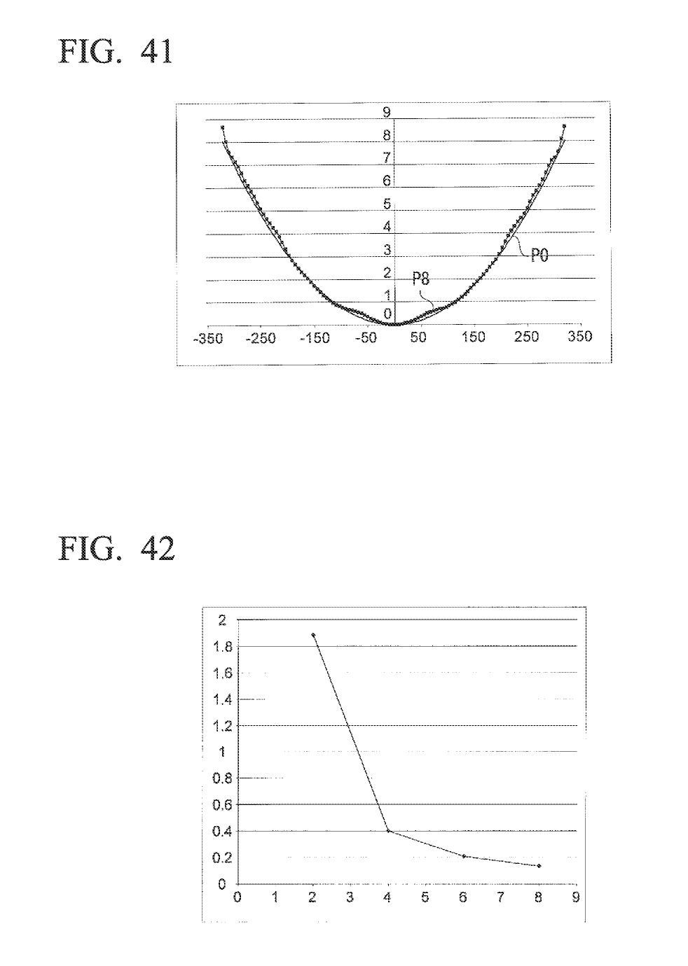

FIG. 41 is a graph showing a simulation result P8 in the case of the eight potential levels, and a theoretical curve P0. A mean square of the difference between the simulation result P8 and the theoretical curve P0 was 0.13.

FIG. 42 is a graph showing a relationship between the number of potentials on a horizontal axis and a mean square of the difference from the theoretical curve C0 on a vertical axis. As shown in FIG. 42, the difference from the theoretical curve C0 is abruptly small when the number of potential levels is four or more. Accordingly, the number of potentials is preferably four or more.

The configurations of the liquid crystal lens and the stereoscopic display apparatus according to one aspect of the present invention are described as the following notes.

### [Note 1]

A liquid crystal lens comprising:

a first insulating substrate;

a first electrode pattern on the first substrate, the first electrode pattern including a conductive portion and a non-conductive portion which are repeated in stripes along a first direction;

a second insulating substrate opposing the first substrate;

a second electrode pattern on the second substrate, the second electrode pattern including a conductive portion and a non-conductive portion which are repeated in stripes along the first direction;

a liquid crystal layer sandwiched between the first substrate and the second substrate; and

a controller configured to control potentials of the first electrode pattern and the second electrode pattern to switch between two or more modes.

### [Note 2]

The liquid crystal lens according to Note 1, wherein the non-conductive portion of the first electrode pattern and the non-conductive portion of the second electrode pattern are not opposed to each other.

### [Note 3]

The liquid crystal lens according to Note 1 or 2, wherein a width of the conductive portion of the first electrode pattern in a portion having a large potential difference between the first electrode pattern and the second electrode pattern is formed narrower in comparison with a portion having a small potential difference between the first electrode pattern and the second electrode pattern.

### [Note 4]

The liquid crystal lens according to any one of Notes 1 to 3, wherein the controller is configured to control the potentials of the first electrode pattern and the second electrode pattern to be four or more potential levels in total.

### [Note 5]

The liquid crystal lenses according to any one of Notes 1 to 4, wherein liquid crystal molecules of the liquid crystal layer are oriented substantially parallel to the first substrate, in a case that no potential difference is generated between the first substrate and the second substrate.

### [Note 6]

The liquid crystal lenses according to any one of Notes 1 to 4, wherein liquid crystal molecules of the liquid crystal layer are oriented substantially vertical to the first substrate, in a case that no potential difference is generated between the first substrate and the second substrate.

### [Note 7]

The liquid crystal lens according to Note 5, wherein in a case that no potential difference is generated between the first substrate and the second substrate, an orientation direction of the liquid crystal molecules on a side of the first substrate is substantially perpendicular to an orientation direction of the liquid crystal molecules on a side of the second substrate.

### [Note 8]

The liquid crystal lens according to Note 7, wherein the orientation direction of the liquid crystal molecules on the side of the first substrate and the second direction form approximately 45 degrees.

### [Note 9]

The liquid crystal lens according to Note 7 or 8 further comprising:

a polarizer disposed on the first substrate side, the polarizer having a polarization axis substantially parallel to the orientation direction of the liquid crystal molecules on the side of the first substrate.

### [Note 10]

The liquid crystal lens according to Note 7 or 8 further comprising:

a polarizer disposed on the second substrate side, the a polarizer having a polarization axis substantially parallel to the orientation direction of the liquid crystal molecules on the side of the second substrate.

### [Note 11]

A stereoscopic display apparatus comprising:

a display device configured to display an image; and

the liquid crystal lens according to any one of Notes 1 to 10.

### [Note 12]

The stereoscopic display apparatus according to Note 11, wherein the first substrate of the liquid crystal lens is disposed on a side of the display device.

### [Note 13]

The stereoscopic display apparatus according to Note 11, wherein the second substrate of the liquid crystal lens is disposed on a side of the display device.

### [Configuration According to Another Aspect of the Present Invention]

Hereinafter, a configuration according to another aspect of the present invention will be described. Specifically, Japanese Unexamined Patent Application, First Publication No. 2010-282090 described above discloses a configuration in which a variable lens array element based on the liquid crystal lens system switches between two dimensional display and three-dimensional display. This configuration includes a first electrode in a planar shape and a plurality of second electrodes provided for the arrangement position of each sub-pixel, the first and second electrodes sandwiching a liquid crystal layer of the variable lens array element. The second electrode is provided for each sub-pixel. With this configuration, the voltages applied to the second electrodes are independently controlled in accordance with the viewpoint of an observer, thus solving the problem of crosstalk such that a parallax image for the right or left eye of the observer in the 3-dimensional display includes a parallax image of the other eye.

However, in the configuration disclosed in Japanese Unexamined Patent Application, First Publication No. 2010-282090, at least the second electrode is required for each sub-pixel, and a plurality of voltages to be applied to the respective second electrodes are also required. For this reason, there is a problem that a wiring process becomes complicated, and the manufacturing cost increases. In another aspect of the present invention, embodiments disclosed below provide technique of reducing crosstalk in three-dimensional display without increasing the number of electrodes in a liquid crystal lens.

For this reason, a liquid crystal lens disclosed below includes: an electrode pattern unit configured to transmit light and including a first electrode, the first electrode including a conductive portion and a non-conductive portion which are repeated at predetermined intervals; a common electrode unit configured to transmit light and including a common electrode at a position opposing the first electrode; a controller configured to control potentials of the first electrode and the common electrode and to cause a potential difference to be generated between the electrode pattern unit and the common electrode unit; a light controller including a liquid crystal layer formed between the common electrode unit and the electrode pattern unit, the liquid crystal layer having a refractive index distribution of light that is variably controlled by an electric field according to the potential difference; and a non-conductive layer formed between the common electrode unit and the electrode pattern unit, the non-conductive layer being formed of a light-transmissive medium. A ratio a/d is greater than 3.0 and is less than 8.5 where a is a distance between two adjacent conductive portions on the first electrode, and d is a distance between the common electrode unit and the electrode pattern unit.

According to the above configuration, it is possible to reduce crosstalk in three-dimensional display without increasing the number of electrodes.

Hereinafter, specific embodiments will be described. A liquid crystal lens disclosed below includes: an electrode pattern unit configured to transmit light and including a first electrode, the first electrode including a conductive portion and a non-conductive portion which are repeated at predetermined intervals; a common electrode unit configured to transmit light and including a common electrode at a position opposing the first electrode; a controller configured to control potentials of the first electrode and the common electrode and to cause a potential difference to be generated between the electrode pattern unit and the common electrode unit; a light controller including a liquid crystal layer formed between the common electrode unit and the electrode pattern unit, the liquid crystal layer having a refractive index distribution of light that is variably controlled by an electric field according to the potential difference; and a non-conductive layer formed between the common electrode unit and the electrode pattern unit, the non-conductive layer being formed of a light-transmissive medium. A ratio a/d is greater than 3.0 and is less than 8.5 where a is a distance between two adjacent conductive portions on the first electrode, and d is a distance between the common electrode unit and the electrode pattern unit (the eleventh configuration of the liquid crystal lens). According to this configuration, by the provision of the non-conductive layer, the electric field becomes easily applied also to the non-conductive portion of the liquid crystal layer. As a result, it is possible to reduce crosstalk in three-dimensional display without increasing the number of electrodes.

Additionally, in the above eleventh configuration of the liquid crystal lens, the electrode pattern unit further includes a second electrode including a conductive portion and a non-conductive portion which are repeated at predetermined intervals. The controller may be configured to control the potentials of the electrode pattern unit and the common electrode unit so that the potential difference between the first electrode and the common electrode differs from the potential difference between the second electrode and the common electrode (twelfth configuration of the liquid crystal lens). According to the twelfth configuration, it is possible to more precisely control a change in orientation of the liquid crystal molecules included in the liquid crystal layer, compared to the case where the present configuration is not provided.

Further, in the above eleventh or twelfth configuration of the liquid crystal lens, the liquid crystal molecules in the liquid crystal layer may be oriented substantially parallel to one direction of the display region when no potential difference is generated between the electrode pattern unit and the common electrode portion (thirteenth configuration). According to the thirteenth configuration, in addition to the above effects of the eleventh and twelfth configurations, liquid crystal materials of the positive type can be used. Thus, a thickness of the liquid crystal layer can be reduced in comparison with the case of vertical orientation where liquid crystal materials of the negative type are used, thus enabling enhancement of the response speed.

Moreover, in the above eleventh or twelfth configuration, when no potential difference is generated between the electrode pattern unit and the common electrode unit, an orientation direction of the liquid crystal molecules included in the liquid crystal layer on a side of the common electrode unit may be substantially perpendicular to that on a side of the electrode pattern unit (fourteenth configuration of the liquid crystal lens). Additionally, in the fourteenth configuration, the orientation direction and a direction substantially perpendicular to the arrangement direction of the first electrode may form an angle of approximately 45 degrees (fifteenth configuration of the liquid crystal lens).

According to the fourteenth or fifteenth configuration, it is possible in addition to reduce the manufacturing cost of the liquid crystal lens, in addition to the effects of the eleventh and twelfth configurations.

Further, in the above fourteenth or fifteenth configuration of the liquid crystal lens, the liquid crystal lens includes a polarizing plate on a light emitting side of the light controller. A polarization axis of the polarizing plate may be substantially parallel to the orientation direction of the liquid crystal molecules on the side of the electrode pattern unit or the common electrode portion (sixteenth configuration of the liquid crystal lens). According to the sixteenth configuration, it is possible to further reduce crosstalk in comparison with a case where the present configuration is not included.

Moreover, in the above eleventh or twelfth configuration of the liquid crystal lens, when no potential difference is generated between the electrode pattern unit and the common electrode portion, the liquid crystal molecules included in the liquid crystal layer may be oriented substantially parallel to a thickness direction of the liquid crystal layer (seventeenth configuration of the liquid crystal lens). According to the seventeenth configuration, in addition to the effects of the eleventh and twelfth configurations, it is possible to simplify the manufacturing process because an orientation treatment is not required in comparison with the case where the present configuration is not included.

A stereoscopic display apparatus according to one embodiment of the present invention may be configured to include the liquid crystal lens having the above eleventh to seventeenth configuration, and a display panel configured to display an image. According to the stereoscopic display apparatus, by providing the non-conductive layer in the liquid crystal lens, an electric field becomes easily applied also to the non-conductive portion of the liquid crystal layer. As a result, it is possible to reduce crosstalk in three-dimensional display without increasing the number of electrodes in the liquid crystal lens.

### Thirteenth Embodiment

Hereinafter, embodiments will be described in detail with reference to the drawings. The same symbols will be appended to the same or corresponding portions, and description thereof will not be repeated. In order to simplify the description, in the drawings referenced in the following, a configuration has been schematically simplified or, some components have been omitted. The dimensional ratios between components shown in each drawing do not necessarily indicate the actual dimension ratios.

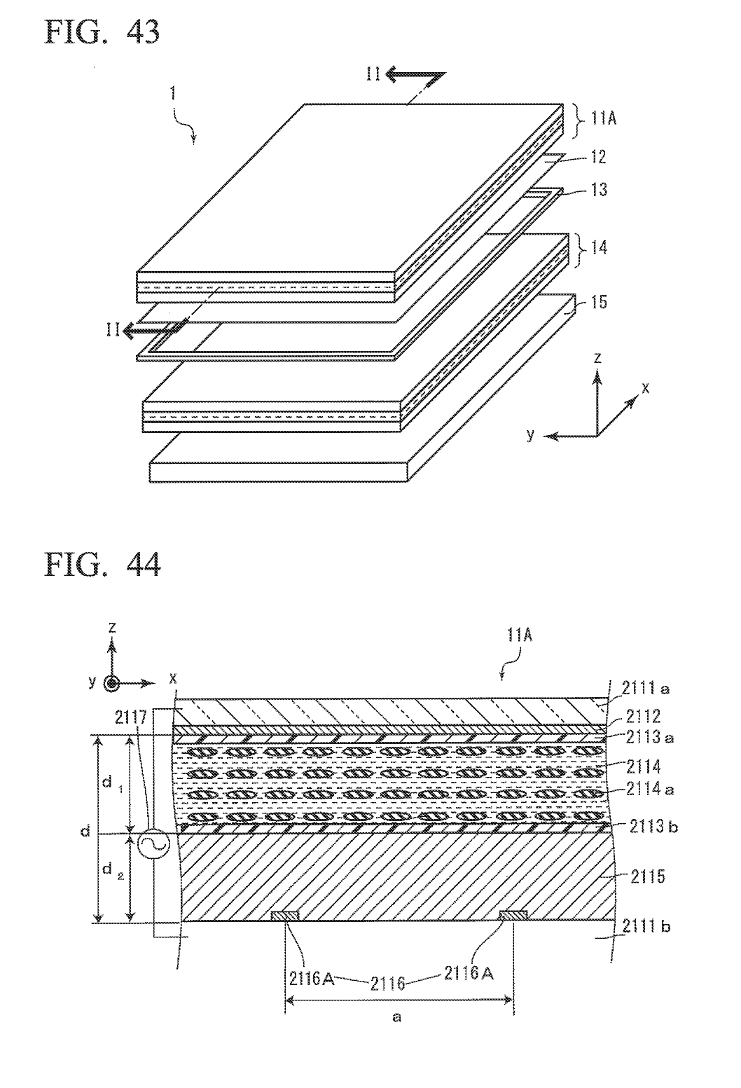

FIG. 43 is an exploded perspective view showing a schematic configuration of a stereoscopic display apparatus 1 according to one embodiment of the present invention. The stereoscopic display apparatus 1 includes a liquid crystal lens 11A, a phase difference plate 12, a spacer 13, a liquid crystal display 14 (an example of a display panel), and a backlight 15.

In this drawing, the upper direction of the liquid crystal lens 11A (the positive direction side of a z-axis) becomes the position where an image to be displayed on the liquid crystal display 14 is viewed. The stereoscopic display apparatus 1 transmits light emitted from the backlight 15 through the liquid crystal display 14, the phase difference plate 12, and the liquid crystal lens 11A, in this order, thus switches an image to be displayed on the liquid crystal display 14 to a plane image or a stereoscopic image, and displays the image at the predetermined viewing position.

The liquid crystal lens 11A and the liquid crystal display 14 are formed so as to have planes in a substantially-rectangular plate-like shape when viewed from the z-axis direction and in substantially equal size.

The liquid crystal lens 11A includes a pair of substrates and a liquid crystal layer sandwiched therebetween. The liquid crystal lens 11A changes orientation of liquid crystal molecules included in the liquid crystal layer, thereby changing behavior (gradient index) of light passing through the liquid crystal layer. The detailed configuration of the liquid crystal lens 11A will be described later.

The phase difference plate 12 is disposed on the back side of the liquid crystal lens 11A (the negative direction side of the z-axis), that is, the side where light emitted from the liquid crystal display 14 is incident on the liquid crystal lens 11A. The phase difference plate 12 adjusts the polarization direction of the light emitted from the liquid crystal display 14, thus aligning the polarization direction to the changing orientation direction of the liquid crystal molecules of the liquid crystal lens 11A.

The liquid crystal display 14 is disposed on the back side of the phase difference plate 12 (the negative direction side of the z-axis) through a spacer 13. The liquid crystal display 14 includes an active matrix substrate, a color filter substrate disposed opposite thereto, and a liquid crystal layer sandwiched between both the substrates.

TFTs (thin film transistors) and pixel electrodes are formed in a matrix on the active matrix substrate. The liquid crystal display 14 controls the TFTs, thereby changing the orientation of the liquid crystal molecules included in the liquid crystal layer above any pixel electrode. Light emitted from the backlight 15 provided on the rear surface of the liquid crystal display 14 (the negative direction side of the z-axis) passes through the liquid crystal layer, and thus any image is displayed on the display surface of the liquid crystal display 14.

The backlight 15 includes a light source, such as a cold cathode tube or an LED (light emitting diode), and emits light from the rear surface of the liquid crystal display 14 (the negative direction side of the z-axis).

The stereoscopic display apparatus 1 conjunctively controls the liquid crystal lens 11A and the liquid crystal display 14, thereby switching the display modes of an image. The display modes include two modes, a two-dimensional display mode and a three-dimensional display mode. In the case of the two-dimensional display mode, the liquid crystal molecules included in the liquid crystal layer of the liquid crystal lens 11A are in a state of being oriented uniformly, and most of the light emitted from the liquid crystal display 14 and incident on the liquid crystal layer passes without being refracted. As a result, a plane image projected by the liquid crystal display 14 is displayed.

In the three-dimensional display mode, the liquid crystal display 14 regularly arranges and displays images captured from multiple directions. Correspondingly with this, the liquid crystal lens 11A regularly changes orientation of the liquid crystal molecules included in the liquid crystal layer. Thus, the light emitted from the liquid crystal display 14 and incident on the liquid crystal layer transmits while being refracted according to the refractive index distribution of the liquid crystal layer. When the stereoscopic display apparatus 1 is observed in the optimal viewing position, different images reach the left and right eyes. In other words, the stereoscopic display apparatus 1 in the three-dimensional display mode performs three-dimensional display using a so-called parallax method.

Next, a configuration of the liquid crystal lens 11A according to the thirteenth embodiment will be described in detail.

FIG. 44 shows a schematic cross-sectional view of the liquid crystal lens 11A, which is taken along a line II-II shown in FIG. 43. The liquid crystal lens 11A includes, between an opposing substrate 2111a and a control substrate 2111b, a common electrode 2112, alignment films 2113a and 2113b, a liquid crystal layer 2114, a dielectric layer 2115, and an electrode pattern 2116. The liquid crystal lens 11A further includes a controller 2117 that controls the voltage to be applied between the opposing substrate 2111a and the control substrate 2111b. Here, the alignment films 2113a and 2113b, and the liquid crystal layer 2114 are examples of an optical controller. Additionally, the common electrode 2112 is an example of a common electrode unit. Further, the electrode pattern 2116 is an example of an electrode pattern unit. Moreover, the dielectric layer 2115 is an example of a non-conductive layer.

The control substrate 2111b is formed of a light-transmissive glass. An electrode pattern 2116 that is a transparent electrode, such as ITO (Indium-tin-oxide), is formed on a surface of the dielectric layer 2115 side of the control substrate 2111b.

The electrode pattern 2116 includes a plurality of electrodes (first electrodes) 2116A. Each electrode 2116A is formed elongated along the y-direction. The electrodes 2116A are arranged at a constant pitch a that corresponds to the pitch of lenses so as to be parallel to one another along the x-direction.

The dielectric layer 2115 with a thickness d₂ (the height in the z-axis direction) is formed over the electrode pattern 2116. The dielectric layer 2115 is formed of an insulating dielectric material. In the present embodiment, the dielectric layer 2115 is formed of, for example, acrylic resin, polyimide resin, or the like.

The liquid crystal layer 2114 with a thickness d₁ (the height in the z-axis direction) is formed over the dielectric layer 2115 through an alignment film 2113b. In the present embodiment, as liquid crystal molecules 2114a constituting the liquid crystal layer 2114, liquid crystal molecules with positive dielectric anisotropy are used. The liquid crystal molecules 2114a have the anisotropy of the refractive index such that a refractive index nₑ with respect to light vibrating parallel to the optical axis is different from a refractive index nₒ with respect to light vibrating perpendicular to the optical axis. The liquid crystal molecules 2114a having a large value of Δn=nₑ−nₒ is preferred.

Alignment layers 2113a and 2113b are formed on the upper and lower surfaces of the liquid crystal layer 2114. In the present embodiment, the alignment films 2113a and 2113b have a plurality of grooves formed in parallel to the x-direction by a rubbing treatment. In a state where no voltage is applied to the liquid crystal layer 2114, the liquid crystal molecules 2114a are oriented by the alignment films 2113a and 2113b so that long axes thereof become parallel to the x-direction (horizontal orientation).

The common electrode 2112 is a transparent electrode, such as ITO, which is formed on the entire surface of the opposing substrate 2111b. The controller 2117 applies different potentials to the common electrode 2112 and the electrode pattern 2116, to cause a potential difference to be generated between the common electrode 2112 and the electrode pattern 2116.

Here, a state of the liquid crystal lens 11A in accordance with the potential difference between the common electrode 2112 and the electrode pattern 2116 will be described.

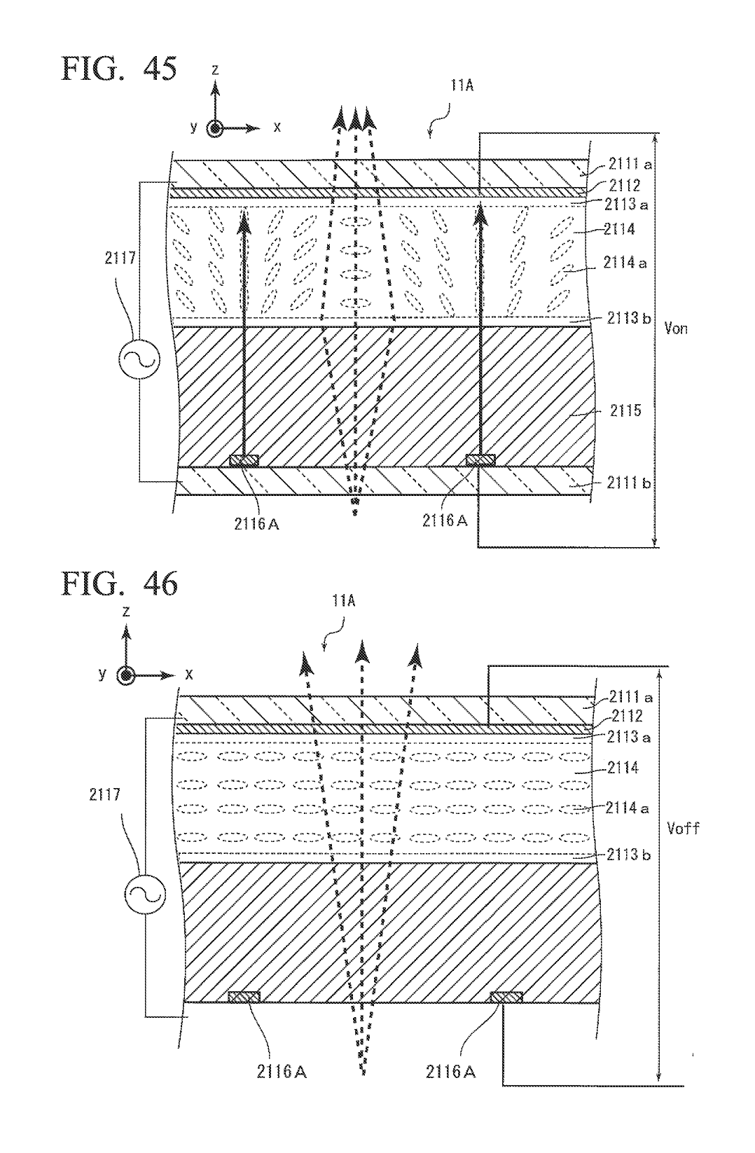

FIG. 45 is a schematic diagram showing a state of the liquid crystal lens 11A in a case where a voltage is applied by the controller 2117, and thus a predetermined potential difference is generated between the common electrode 2112 and the electrode pattern 2116. In this drawing, a broken line represents part of light emitted from the liquid crystal display 14. The liquid crystal molecules 2114a are oriented so that the molecular long axes thereof become parallel to the electric field generated by the voltage. The molecular long axes of the liquid crystal molecules 2114a close to the electrodes 2116A are oriented parallel to the z-axis direction. However, the electric field decreases as the distance from the electrode 2116A increases. Therefore, the orientation direction of the liquid crystal molecules 2114a will tilt from the z-axis direction to the x-axis direction. A refractive index of the liquid crystal layer 2114 changes according to the change in orientation direction of the liquid crystal molecules 2114a. Thus, the liquid crystal layer 2114 has a refractive index distribution in the x-axis direction.

When light emitted from the liquid crystal display 14 transmits through the control substrate 2111b and enters the dielectric layer 2115, the light transmits through the dielectric layer 2115 and the alignment film 2113b and enters the liquid crystal layer 2114. The light incident on the liquid crystal layer 2114 is refracted according to the refractive index distribution of the liquid crystal layer 2114, transmits through the alignment film 2113a, the common electrode 2112, and the opposing substrate 2111a, and is condensed at the viewing position, as indicated by the dashed arrow. In other words, the liquid crystal lens 11A functions as a gradient index lens (GRIN lens). The state of the liquid crystal layer 2114 shown in FIG. 45 corresponds to the three-dimensional display mode.

On the other hand, FIG. 46 is a schematic diagram showing a state of the liquid crystal lens 11A in a case where no voltage is applied by the controller 2117, and no predetermined potential difference is generated between the common electrode 2112 and the electrode pattern 2116. In this state, an electric field is not generated in the liquid crystal layer 2114, and the liquid crystal molecules 2114a are oriented by the alignment films 2113a and 2113b so that the molecular long axes thereof become parallel to the x-direction. Since the liquid crystal molecules 2114a are oriented uniformly, a refractive index distribution of the liquid crystal layer 2114 also becomes uniform. For this reason, as indicated by broken lines, light incident on the liquid crystal layer 2114 is refracted slightly due to the refractive index difference from the adjacent medium, most of the light proceeds as it is. In other words, in the state where no voltage is applied, the liquid crystal lens 11A does not function as a GRIN lens, and a two-dimensional image displayed on the liquid crystal display 14 is displayed at the viewing position. The state of the liquid crystal layer 2114 shown in FIG. 46 corresponds to the two-dimensional display mode.

The present inventors paid attention to a point that as the distance between the electrodes 2116A becomes larger in comparison with the distance between the common electrode 2112 and the electrode pattern 2116, an electric field is hardly applied between the electrodes 2116A, in comparison with the vicinity of the electrode 2116A, and crosstalk occurs in the three-dimensional display mode. Then, the distance between the common electrode 2112 and the electrode pattern 2116 was adjusted by providing the dielectric layer 2115. Here, the crosstalk is a ratio L2/L1 (%) where a position that is a predetermined distance away from the liquid crystal lens 11 is defined as the center (reference position) of the left and right eyes of the observer, L1 represents a luminance value at the reference position, and L2 represents a luminance value with respect to the horizontal distance (for example, approximately 65 mm) or angle from the reference position corresponding to the positions of the left and right eyes of the observer.

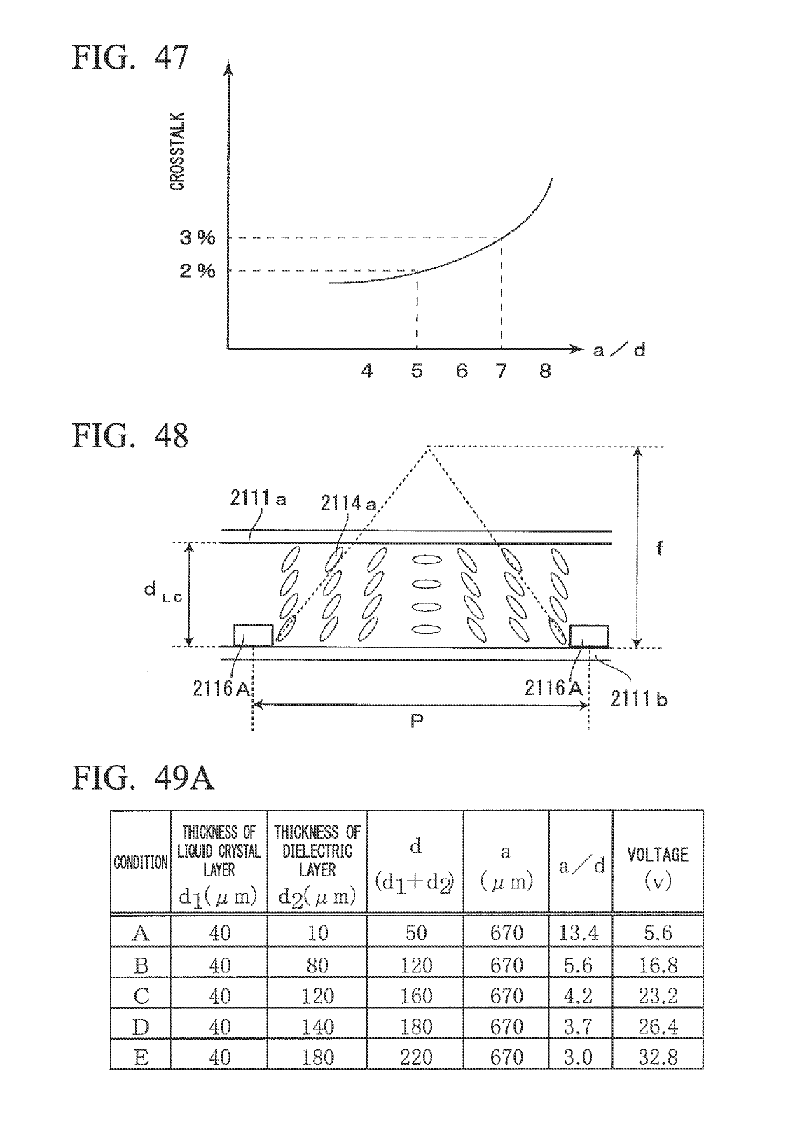

FIG. 47 shows a relationship between crosstalk and a ratio (a/d) where d (d=d₁+d₂) represents the distance between the common electrode 2112 and the electrode pattern 2116, and a represents a pitch of the electrodes 2116A. Generally, it is preferable that crosstalk is 3% or less. Additionally, as shown in FIG. 48, lens characteristics of an ideal liquid crystal lens that can achieve crosstalk that is 3% or less meet the following relation, where f represents the focal length of the lens, P represents the width of the lens, n_{c} represents the maximum effective refractive index, n_{b} represents the minimum effective refractive index of the liquid crystal, and d_{Lc} represents a thickness of the liquid crystal.

f=P²/8(n_{c}−n_{b})d_{Lc}

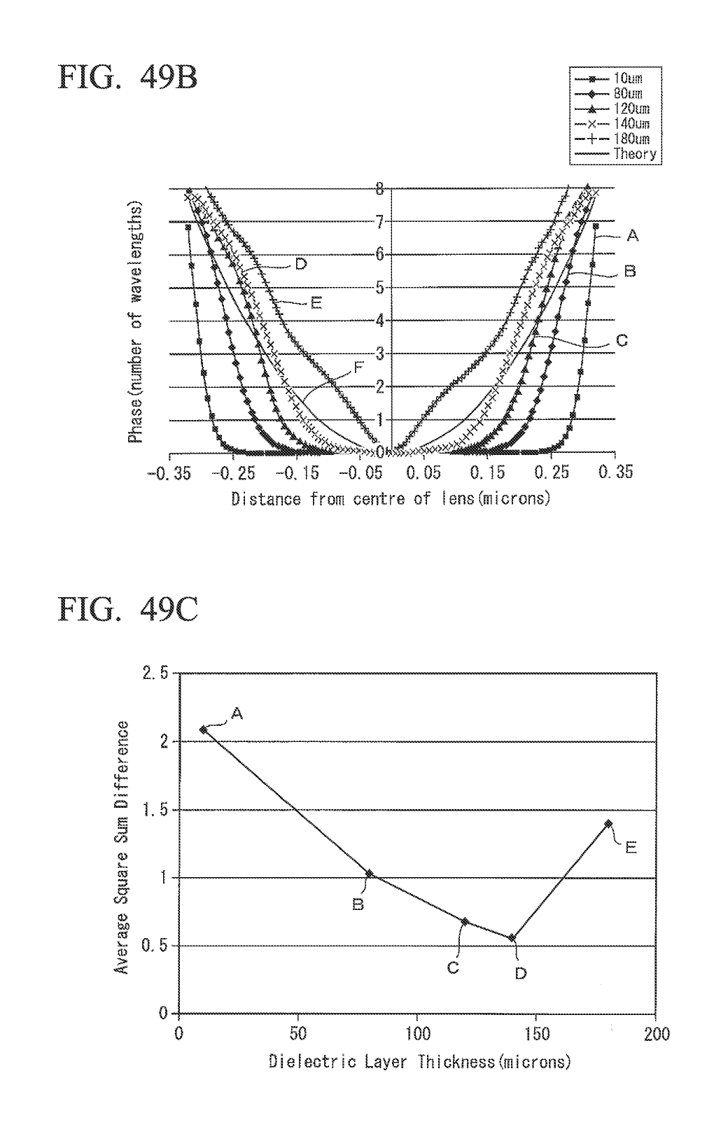

Accordingly, in order to adjust the distance between the common electrode 2112 and the electrode pattern 2116 of the liquid crystal lens 11A to achieve the ideal lens characteristics described above, the present inventors have conducted a simulation under the following condition. The condition was that the width of the electrode 2116A: 15 μm, a pitch a of the electrodes 2116A: 670 μm, a thickness d₁ of the liquid crystal layer 2114 including the alignment layers 2113a and 2113b: 40 μm, a dielectric constant of the dielectric layer 2114: 5%, and the voltage of the common electrode 2112: 0V. FIGS. 49B and 49C show results of the simulation of the lens characteristics performed under this precondition with respect to the thickness d₂ of the dielectric layer 2115 indicated by conditions A to E shown in FIG. 49A.

It was assumed in this simulation that a distance d which combined the thickness d₁ of the liquid crystal layer 2114 including the alignment films 2113a and 2113b and the thickness d₂ of the dielectric layer 2115 is the distance between the common electrode 2112 and the electrode pattern 2116. FIG. 49B shows a theoretical curve and results of the simulation performed under the respective conditions (A to E) shown in FIG. 49A. Additionally, FIG. 49C shows a root-mean-square value (deviation from the theoretical curve) of the theoretical curve shown in FIG. 49B and the results of the simulation performed under the respective conditions.

As shown in FIGS. 49B and 49C, it was the condition D (a/d=3.7) that achieved the smallest deviation from the theoretical curve F. Additionally, it was the condition A (a/d=13.4) that achieved the greatest deviation from the theoretical curve F. From FIG. 47 and the above results of the simulation, a/d that makes crosstalk approximately 3% is preferably 3.0<a/d<8.5 where a root mean square value with the theoretical value is less than 1.5, and more preferably, 3.5<a/d<5.5 where a mean square value with the theoretical value is less than 1.0.

In the embodiment described above, the dielectric layer 2115 is provided in contact with the electrode pattern 2116 to adjust the distance between the common electrode 2112 and the electrode pattern 2116, thereby reducing crosstalk. By such a configuration, the cost for manufacturing the liquid crystal lens 11A can be suppressed at low cost, compared to a case where the thickness of the liquid crystal layer 2114 including the alignment films 2113a and 2113b is increased in order to adjust the distance between the common electrode 2112 and the electrode pattern 2116. Additionally, in the above-described embodiment, the dielectric layer 2115 is disposed on the electrode pattern 2116 side. An electric field is hardly applied to the portion of the dielectric layer 2115. For this reason, compared to a case where the dielectric layer 2115 is provided on the common electrode 2112 side, the liquid crystal layer 2114 is less likely to be affected by a lateral electric field between the electrode patterns 2116, and becomes likely to be affected by a vertical electric field between the common electrode 2112 and the electrode pattern 2116. As a result, the lens characteristics of the liquid crystal lens 11A are likely to approach the theoretical curve f.

### Fourteenth Embodiment

The description has been given in the above thirteenth embodiment with respect to the case where one potential is applied to the electrode pattern 2116. In the present embodiment, description will be given with respect to a case where two potentials are applied to the electrode pattern 2116.

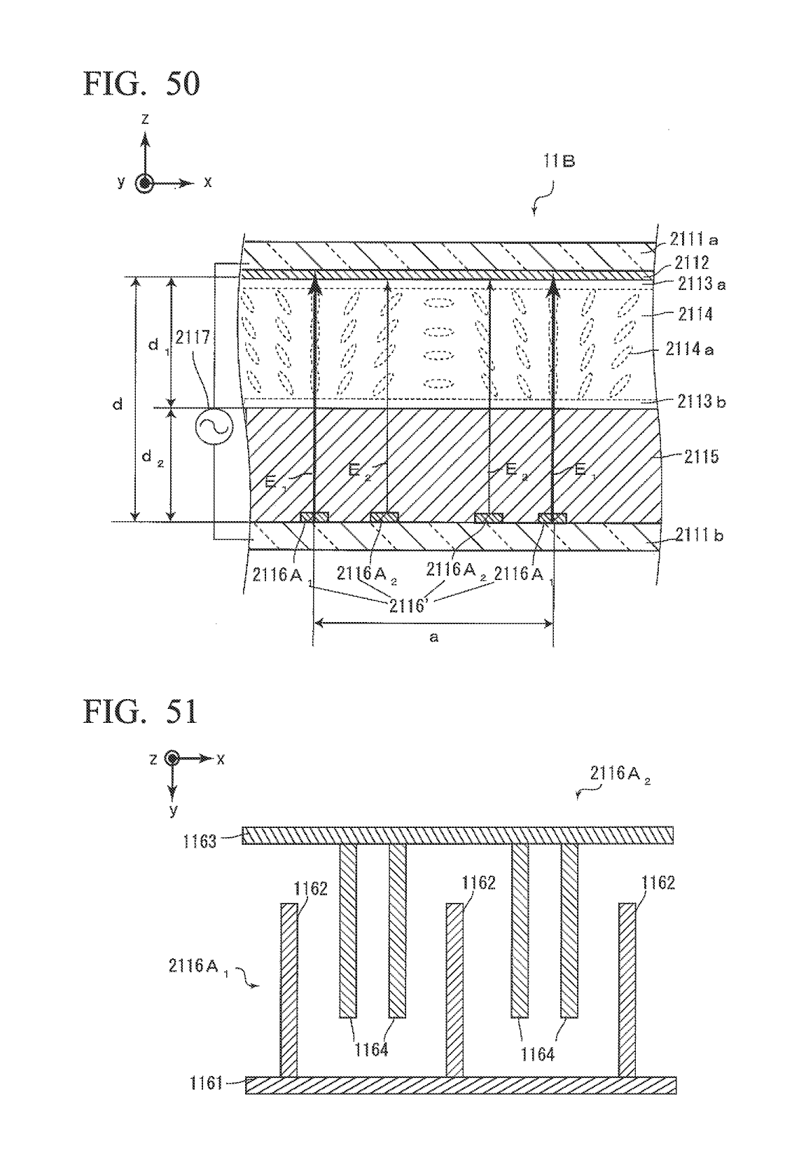

FIG. 50 is a schematic view showing a cross section of a liquid crystal lens 11B according to the present embodiment. The same reference symbols are appended to the same configuration as that of the thirteenth embodiment described above. Hereinafter, a configuration different from that of the thirteenth embodiment will be described.

An electrode pattern 2116′ (electrode pattern unit) includes electrodes 2116A₁ (first electrodes) and electrodes 2116A₂ (second electrodes). FIG. 51 is a schematic diagram showing the electrodes 2116A₁ and the electrodes 2116A₂ shown in FIG. 50, which are viewed from the positive direction of the z-axis. As shown in FIG. 51, the electrode 2116A₁ includes an elongated electrode portion 1161 extending in the x-axis direction and an elongated electrode portion 1162 extending from the electrode portion 1161 in the negative direction of the y-axis. The electrode 2116A₁ is formed by connecting the electrode portion 1161 and the electrode portions 1162 so that the electrode portions 1162 are arranged at regular intervals along the x-axis direction.

The electrode 2116A₂ includes an elongated electrode portion 1163 extending in the x-axis direction, and an elongated electrode portion 1164 extending from the electrode portion 1163 in the positive direction of the y-axis. The electrode 2116A₂ is formed by connecting the electrode portion 1164 and the electrode portion 1163 so that two electrode portions 1164 are arranged at regular intervals between two adjacent electrodes portions 1162 of the electrode 2116A₁. In other words, in the present embodiment, the two adjacent electrodes 2116A₁ and the electrode 2116A₂ disposed therebetween correspond to one GRIN lens. Additionally, the electrode 2116A₁ and the electrode 2116A₂ are symmetrically disposed in one GRIN lens.

Referring back to FIG. 50, the controller 2117 applies a voltage so that the potential of the electrode 2116A₁ differs from the potential of the electrode 2116A₂. In the present embodiment, for example, a thickness d₁ of the liquid crystal layer 2114 including the alignment films 2113a and 2113b is set to be 50 μm. A thickness d₂ of the dielectric layer 2115 is set to be 60 μm. A pitch (lens pitch) of the electrodes 2116A₁ is set to be 670 μm (a/d=670/110=6.1). In this case, the controller 2117 applies 12V and 4.5V respectively to the electrode 2116A₁ and the electrode 2116A₂ while regarding the potential of the common electrode 2112 as 0V (ground potential). When the voltages are applied, an electric field E1 is generated between the electrode 2116A₁ and the common electrode 2112, and an electric field E2 is generated between the electrode 2116A₂ and the common electrode 2112 (E2<E1). The thickness of the dielectric layer 2115 is different between the present embodiment and the thirteenth embodiment. As described in the thirteenth embodiment, the electric field applied to the liquid crystal layer 2114 between the electrodes at one potential is controlled, thereby making it easier to approach the theoretical curve F. In the present embodiment, since the two potentials are applied to the electrode pattern 2116, it is possible to approach the theoretical curve F even if the dielectric layer is made thinner in comparison with the case of the thirteenth embodiment.

The orientation of liquid crystal molecules 2114a close to the electrode 2116A₁ changes by the electric field E1 so that the molecular long axes thereof become parallel to the z-axis direction. The closer to the electrode 2116A₂ from the electrode 2116A₁, the molecular long axes of the liquid crystal molecules 2114a further tilts in the x-axis direction due to the influence of the electric fields E1 and E2. Then, since the liquid crystal molecules 2114a are hardly affected by the electric fields E1 and E2 between the electrodes 2116A₂ and 2116A₂, the molecular long axes of the liquid crystal molecules 2114a are oriented parallel to the x-axis direction.

In the fourteenth embodiment described above, two potentials are applied to the electrode pattern 2116. For this reason, compared to the case of the thirteenth embodiment, it is possible to more precisely control the electric field applied to the liquid crystal layer 2114, and improve the accuracy of controlling the optical path of the light transmitting through the liquid crystal layer 2114.

### Embodiment 15

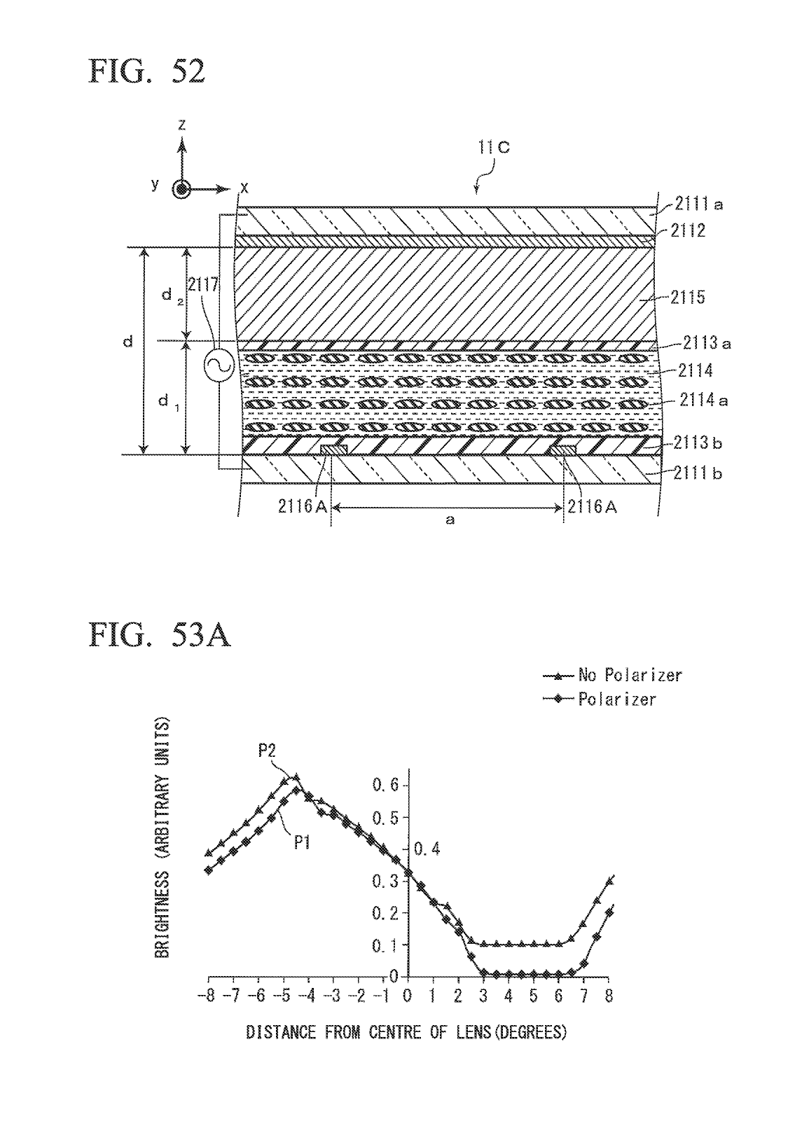

The description has been given in the above thirteenth embodiment with respect to the case where the dielectric layer 2115 is provided at a position in contact with the electrode pattern 2116. However, as shown in FIG. 52, the dielectric layer 2115 may be replaced with a liquid crystal lens 11C provided at a position in contact with the common electrode 2112. In this configuration, a considerable example of the configuration may be such that a thickness of the liquid crystal layer 2114 including the alignment films 2113a and 2113b is 40 μm, a thickness of the dielectric layer 2115 is 140 μm, a pitch of the electrodes 2116A is 670 μm (a/d=3.7). In this configuration example, when the mode is switched to the three-dimensional display mode, the voltage 26v is applied to the electrode 2116A by the controller 2117, and thus a three-dimensional image is displayed at the viewing position.

### Modified Example

Although the thirteenth to fifteenth embodiments have been described above, the above embodiments are merely examples for implementing the present invention. Thus, the present invention is not limited to the above embodiments, and the above embodiments can be appropriately modified and practiced without departing from the scope thereof. For example, regarding the thirteenth to fifteenth embodiments, the following modifications can be considered.

(1) The example taken in the above thirteenth and fourteenth embodiments is the example of the configuration that the electrodes 2116A, 2116A₁, and 2116A₂ of the electrode pattern 2116 are substantially perpendicular to the orientation direction of the liquid crystal molecules 2114a. However, the configuration may be as follows. The alignment films 2113a and 2113b may be configured to have a plurality of grooves parallel to the y-axis direction, which are formed by a rubbing treatment, so that the electrodes 2116A, 2116A₁, and 2116A₂ of the electrode pattern 2116 become substantially parallel to the orientation direction of the liquid crystal molecules 2114a. Additionally, in the above-described embodiments, the electrodes 2116A, 2116A₁, and 2116A₂ of the electrode pattern 2116 may be arranged at regular intervals along the y-axis direction. In this case, the electrodes 2116A, 2116A₁, and 2116A₂ of the electrode pattern 2116 become substantially parallel to the orientation direction of the liquid crystal molecules 2114a.
(2) The description has been given in the above thirteenth embodiment with respect to the configuration that the liquid crystal molecules 2114a of the liquid crystal layer 2114 are oriented in the x-axis direction when no voltage is applied. In the present modified example, a configuration may be such that when no voltage is not applied to the liquid crystal layer 2114, the liquid crystal molecules 2114a are oriented so as to be twisted by approximately 90° in the liquid crystal layer 2114 (TN orientation (twisted nematic type)). In this case, the alignment films 2113a and 2113b have a plurality of grooves formed by a rubbing process so as to intersect each other at the angle of 90°. Alternatively, a configuration may be such that each rubbing direction and the longitudinal direction of the electrode patterns 2116A (y-direction), that is, a direction substantially perpendicular to the arrangement direction of the electrode patterns 2116A (x-direction), forms an angle of substantially 45°.

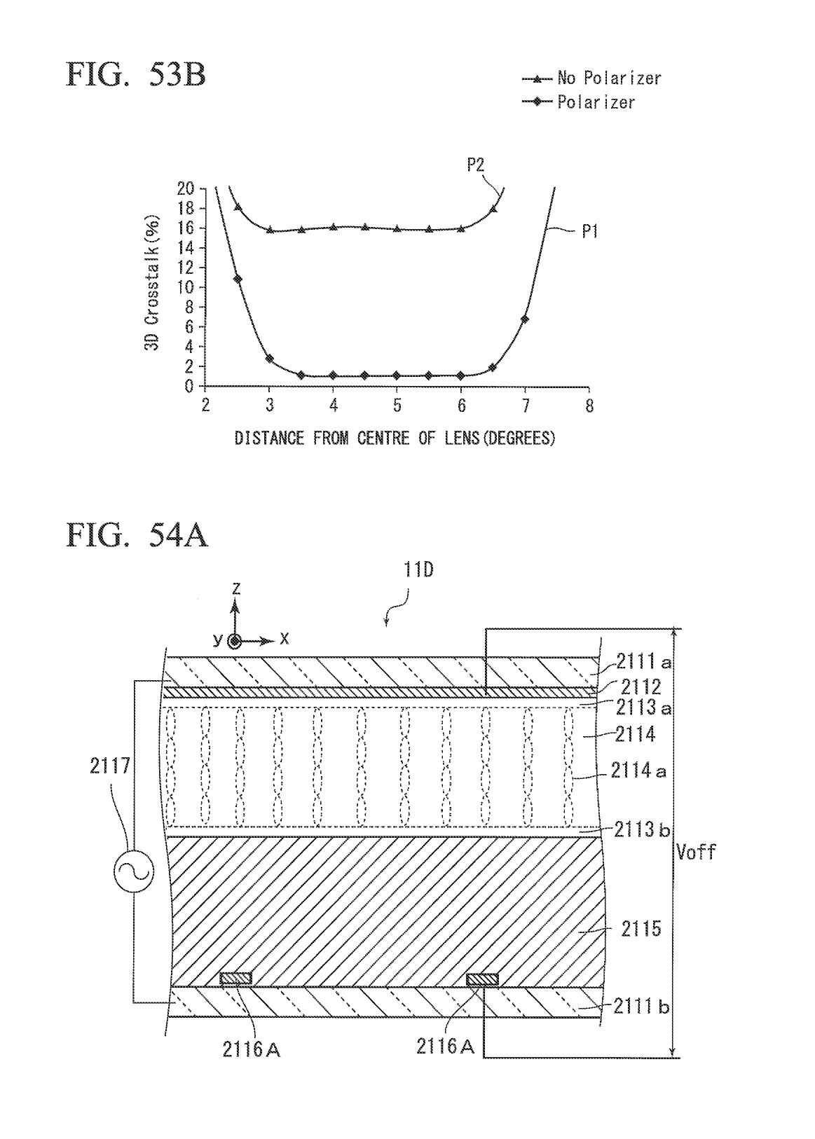

Further, in this case, a configuration may be such that a polarizing plate is provided on a surface of the opposing substrate 2111a (the viewing position side). The polarization axis of the polarizing plate is configured to be the same direction as the rubbing direction of the alignment layer 2113a. FIG. 53A shows the angle from the center position of the lens and a change in brightness in cases where a polarizing plate is provided and where the polarizing plate is not provided. In this drawing, P1 represents a change in brightness in the case where the polarizing plate is provided. P2 represents a change in brightness in the case where the polarizing plate is not provided. As shown in the drawing, a peak brightness is between −4° and −5° in both the cases where the polarizing plate is provided and where the polarizing plate is not provided. The brightness is larger in the case where the polarizing plate is not provided than in the case where the polarizing plate is provided.

Additionally, FIG. 53B shows the crosstalk at the angles shown in FIG. 53A, in the cases where the polarizing plate is provided and where the polarizing plate is not provided. In this drawing, P1 represents the crosstalk at each angle in the case where the polarizing plate is provided. P2 represents the crosstalk at each angle in the case where the polarizing plate is not provided. As shown in this drawing, it can be understood that between 3° and 6.5°, the crosstalk is reduced in the case where the polarizing plate is provided, in comparison with the case where the polarizing plate is not provided. Accordingly, it is possible to further reduce the crosstalk in the three-dimensional display by providing a polarizing plate in the liquid crystal lens 11.

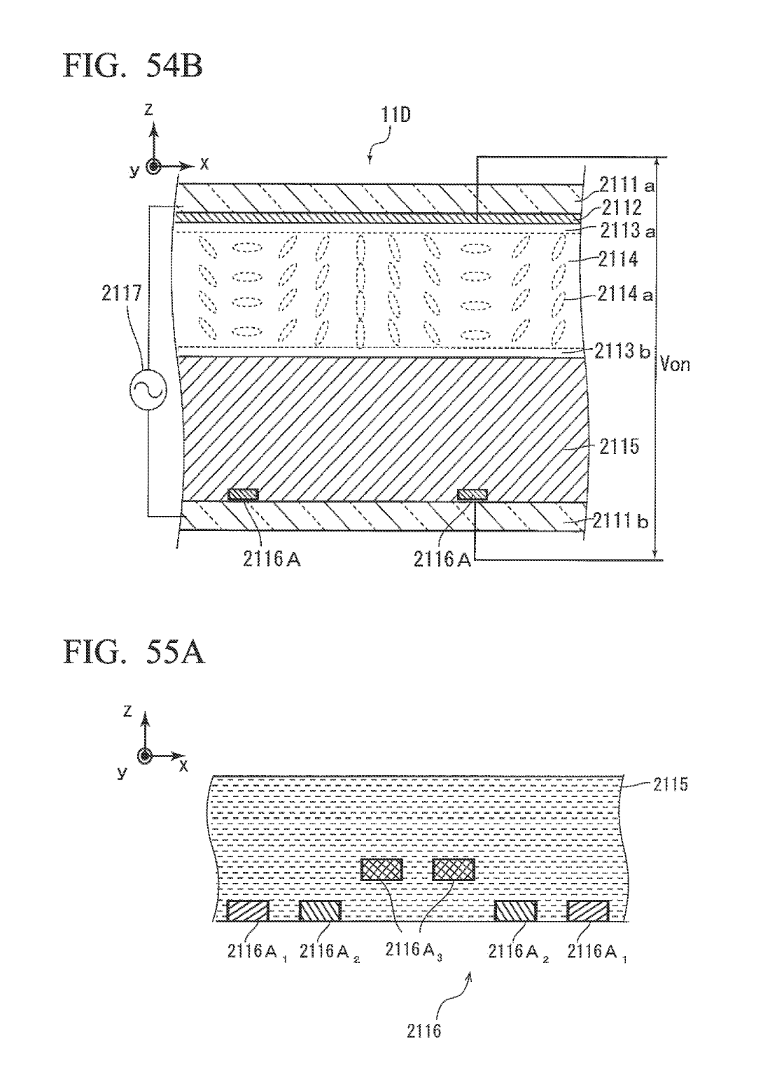

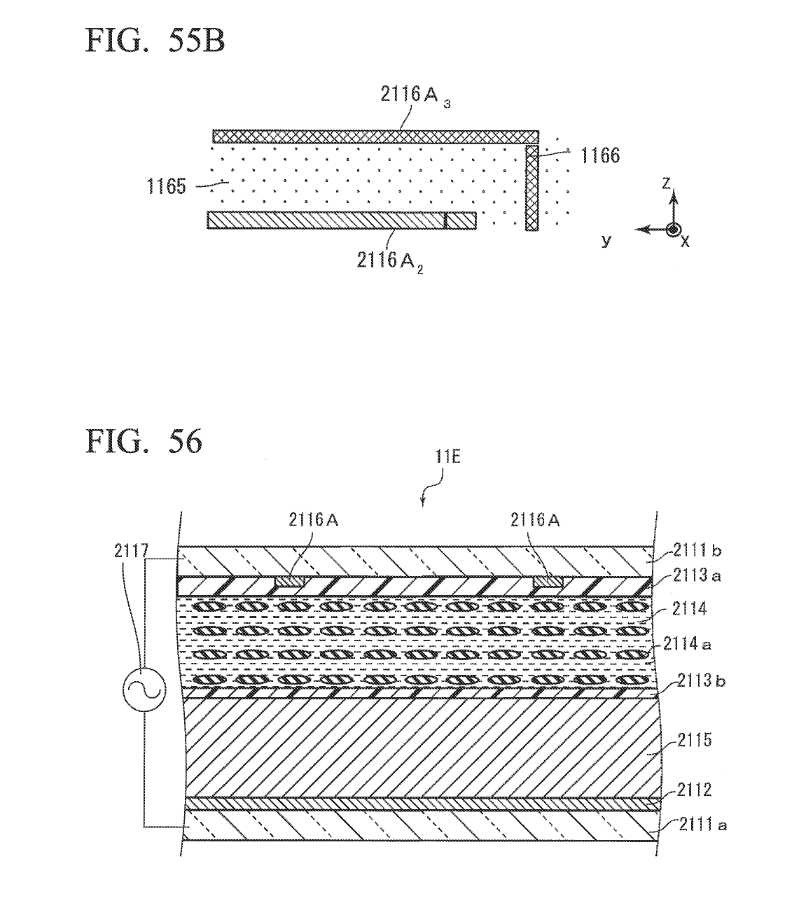

(3) The description has been given in the above thirteenth embodiment with respect to the example of the horizontal orientation such that the liquid crystal molecules 2114a are oriented parallel to the x-axis direction. However, as shown in FIG. 54A, vertical orientation may be employed such that when no voltage is applied, the liquid crystal molecules 2114a are oriented substantially parallel to the z-axis direction (the direction substantially vertical to the display surface of the liquid crystal display 14). In this case, negative type nematic liquid crystal with negative dielectric anisotropy is used, and a vertical alignment film is used as the alignment film 2113a and 2113b. The voltage is applied by the controller 2117, and thereby the orientation of the liquid crystal molecules 2114a changes in a direction vertical to the electric field, in accordance with the potential difference between the common electrode 2112 and the electrode pattern 2116. Accordingly, in the case of vertical orientation, as shown in FIG. 54B, the electric field close to the electrodes 2116A of the electrode pattern 2116 becomes larger than the other positions, the molecular long axes of the liquid crystal molecules 2114a between the electrode 2116A and the electrode 2116A are oriented parallel to the z-axis direction, and the molecular long axes of the liquid crystal molecules 2114a close to the electrode 2116A are oriented parallel to the x-axis direction.
(4) The description has been given in the above fourteenth embodiment with respect to the case where two potentials are applied to the electrode pattern 2116. However, three or more potentials may be applied to the electrode pattern 2116. As an example, a configuration of the electrode pattern 2116 in the case where three potentials are applied to the electrode pattern 2116 is shown below. FIG. 55A is a schematic view showing a cross section of the dielectric layer 2115 and the electrode pattern 2116 of a liquid crystal lens according to the present modified example. As shown in FIG. 55A, the electrode pattern 2116 includes electrodes 2116A₃, in addition to electrodes 2116A₁ and 2116A₂ which are similar to those of the fourteenth embodiment. For example, the electrodes 2116A₁ and 2116A₂ are formed on the same layer, and the electrodes 2116A₃ are formed on a higher layer above the electrodes 2116A₁ and 2116A₂. FIG. 55B is a diagram showing the electrodes 2116A₂ and 2116A₃ when FIG. 55A is viewed from the x-axis direction. As shown in the drawing, a configuration may be such that an interlayer insulating film 1165 is formed between the layer on which the electrodes 2116A₂ are provided and the layer on which the electrodes 2116A₃ are provided, and a contact hole 1166 is formed in the interlayer insulating film 1165, and an electrode 2116A₃ is connected with wires.
(5) The description has been given in the above thirteenth embodiment with respect to the example where the electrode pattern 2116 is disposed on the liquid crystal display 14 side, and the common electrode 2112 is provided on the viewing position side (on the side where light is emitted from the liquid crystal lens). However, a configuration may be made as shown in FIG. 56. In other words, as shown in this figure, a configuration may be such that the electrode pattern 2116 is provided on the viewing position side.
(6) The description has been given in the above thirteenth embodiment using the liquid crystal display as an example of display panels. However, a display device, such as a PDP (plasma display panel) or an organic EL display (organic electroluminescence display), may be used.
(7) The example taken in the above thirteenth embodiment is the example where the phase difference plate 12 is used. However, it is not necessary to provide the phase difference plate 12, depending on the polarization direction of light emitted from the liquid crystal display 14.

Here, configurations of the liquid crystal lens and the stereoscopic display apparatus according to another aspect of the present invention will be disclosed as the following Notes.

### [Note 14]

A liquid crystal lens comprising:

an electrode pattern unit configured to transmit light and including a first electrode, the first electrode including a conductive portion and a non-conductive portion which are repeated at predetermined intervals;

a common electrode unit configured to transmit light and including a common electrode at a position opposing the first electrode;

a controller configured to control potentials of the first electrode and the common electrode and to cause a potential difference to be generated between the electrode pattern unit and the common electrode unit;

a light controller including a liquid crystal layer formed between the common electrode unit and the electrode pattern unit, the liquid crystal layer having a refractive index distribution of light that is variably controlled by an electric field according to the potential difference; and

a non-conductive layer formed between the common electrode unit and the electrode pattern unit, the non-conductive layer being formed of a light-transmissive medium,

wherein a ratio a/d is greater than 3.0 and is less than 8.5 where a is a distance between two adjacent conductive portions on the first electrode, and d is a distance between the common electrode unit and the electrode pattern unit.

### [Note 15]

The liquid crystal lens according to Note 14, wherein the electrode pattern unit further includes a second electrode, the second electrode including a conductive portion and a non-conductive portion which are repeated at predetermined intervals, and

the controller is configured to control the potentials of the electrode pattern unit and the common electrode unit so that the potential difference between the first electrode and the common electrode differs from the potential difference between the second electrode and the common electrode.

### [Note 16]

The liquid crystal lens according to Note 14 or 15, wherein liquid crystal molecules in the liquid crystal layer are oriented substantially parallel to one direction of the display region when no potential difference is generated between the electrode pattern unit and the common electrode portion.

### [Note 17]

The liquid crystal lens according to Note 14 or 15, wherein when no potential difference is generated between the electrode pattern unit and the common electrode unit, an orientation direction of the liquid crystal molecules included in the liquid crystal layer on a side of the common electrode unit is substantially perpendicular to that on a side of the electrode pattern unit.

### [Note 18]

The liquid crystal lens according to Note 17, wherein the orientation direction and a direction substantially perpendicular to an arrangement direction of the first electrode form an angle of approximately 45 degrees.

### [Note 19]

The liquid crystal lens according to Note 17 or 18, further comprising:

a polarizing plate on a light emitting side of the light controller,

wherein a polarization axis of the polarizing plate is substantially parallel to the orientation direction of the liquid crystal molecules on the side of the electrode pattern unit or the common electrode portion.

### [Note 20]

The liquid crystal lens according to Note 14 or 15, wherein when no potential difference is generated between the electrode pattern unit and the common electrode portion, the liquid crystal molecules included in the liquid crystal layer are oriented substantially parallel to a thickness direction of the liquid crystal layer.

### [Note 21]

A stereoscopic display apparatus comprising:

the liquid crystal lens according to any one of Notes 14 to 20; and

a display panel configured to display an image.

### Other Embodiment

Although the embodiments of the present invention have been described above, the present invention is not limited to the above-described embodiments, and various modifications or combinations can be made within the scope of the invention.

### INDUSTRIAL APPLICABILITY

The present invention is industrially applicable as a liquid crystal lens or a stereoscopic display apparatus.

1. A three-dimensional display apparatus comprising:
a display device capable of displaying an image; and
a liquid crystal lens disposed so as to overlap the display device,
wherein the liquid crystal lens comprises:
an insulating substrate;
a first electrode formed on the substrate and extending in a first direction;
a second electrode formed on the substrate and being substantially parallel to the first electrode;
a high resistance portion formed on the substrate and electrically connecting the first electrode and the second electrode;
an opposing substrate disposed opposing the substrate;
a common electrode formed on the opposing substrate;
a liquid crystal layer sandwiched between the substrate and the opposing substrate; and
a controller configured to control potentials of the first electrode, the second electrode, and the common electrode, and switch two or more modes,
wherein the sheet resistance of the high resistance portion is in 100 GΩ/sq or less, and
the controller is configured to, in one of the modes, control the first electrode and the second electrode to be at different potentials.

2. The three-dimensional display apparatus according to claim 1, wherein the high resistance portion is formed to cover a region between the first electrode and the second electrode, and
the sheet resistance is 100 kΩ/sq or more.

3. The stereoscopic display apparatus according to claim 1, further comprising:
an auxiliary electrode formed substantially parallel to the first electrode and the second electrode, the auxiliary electrode being electrically connected to the high resistance portion.

4. The stereoscopic display apparatus according to claim 3, wherein a resistance per unit length of the high resistance portion is 10⁻⁴ to 2 MΩ/μm.

5. The stereoscopic display apparatus according to claim 4, wherein the high resistance portion is formed close to one end of the first electrode.

6. The stereoscopic display apparatus according to claim 4, wherein the resistance per unit length of the high resistance portion changes along a direction perpendicular to the first direction.

7. The stereoscopic display apparatus according to claim 1, wherein the controller is configured to control two or less types of potentials of electrodes on a side of the substrate.

8. The three-dimensional display device according to claim 1, wherein in a case that no potential difference is generated between the substrate and the opposing substrate, liquid crystal molecules of the liquid crystal layer are oriented in a direction substantially parallel to the substrate.

9. The three-dimensional display device according to claim 1, wherein in a case that no potential difference is generated between the substrate and the opposing substrate, liquid crystal molecules of the liquid crystal layer are oriented in a direction substantially vertical to the substrate.

10. The three-dimensional display device according to claim 8, wherein in the case that no potential difference is generated between the substrate and the opposing substrate, an orientation direction of the liquid crystal molecules on a side of the substrate is substantially perpendicular to an orientation direction of the liquid crystal molecules on a side of the opposing substrate.

11. The stereoscopic display apparatus according to claim 10, wherein the orientation direction of the liquid crystal molecules on the side of the substrate and the first direction form an angle of approximately 45 degrees.

12. The stereoscopic display apparatus according to claim 10, further comprising:
a polarizer disposed on the side of the substrate and having a polarization axis that is substantially parallel to the orientation direction of the liquid crystal molecules on the side of the substrate.

13. The stereoscopic display apparatus according to claim 10, further comprising:
a polarizer disposed on the side of the opposing substrate and having a polarization axis that is substantially parallel to the orientation direction of the liquid crystal molecules on the side of the opposing substrate.

14. The stereoscopic display apparatus according to claim 1, wherein the substrate is disposed on a side of the display device.

15. The stereoscopic display apparatus according to claim 1, wherein the opposing substrate is disposed on a side of the display device.

16. The stereoscopic display apparatus according to claim 5, wherein the resistance per unit length of the high resistance portion changes along a direction perpendicular to the first direction.

17. The stereoscopic display apparatus according to claim 11, further comprising:
a polarizer disposed on the side of the substrate and having a polarization axis that is substantially parallel to the orientation direction of the liquid crystal molecules on the side of the substrate.

18. The stereoscopic display apparatus according to claim 11, further comprising:
a polarizer disposed on the side of the opposing substrate and having a polarization axis that is substantially parallel to the orientation direction of the liquid crystal molecules on the side of the opposing substrate.
